(19) United States
(12) Patent Application Publication
(10) Pub. No.: US 2015/0071744 A1
(43) Pub. Date: Mar. 12, 2015

(54) LIBRARY APPARATUS AND ARTICLE TRANSPORTING APPARATUS

(71) Applicant: FUJITSU LIMITED, Kawasaki-shi (JP)

(72) Inventors: Ryuichi Miyaguchi, Inagi (JP); Koujiro Hashimoto, Yokohama (JP)

(73) Assignee: Fujitsu Limited, Kawasaki-shi (JP)

(21) Appl. No.: 14/456,379

(22) Filed: Aug. 11, 2014

(30) Foreign Application Priority Data
Sep. 6, 2013 (JP) 2013-185445

(51) Int. Cl. G11B 17/22

(52) U.S. Cl. CPC G11B 17/225
USPC 414/277

(57) ABSTRACT

A library apparatus includes a storing unit configured to store a plurality of recording media and a transporting unit configured to shift in a first direction and in a second direction that intersect each other and to transport the recording media. The transporting unit includes an accommodating unit configured to be able to accommodate a plurality of the recording media and a transferring unit configured to transfer the recording media one by one between the storing unit and the accommodating unit.

### CROSS-REFERENCE TO RELATED APPLICATIONS

This application is based upon and claims the benefit of priority of the prior Japanese Patent Application No. 2013-185445, filed on Sep. 6, 2013, the entire contents of which are incorporated herein by reference.

### FIELD

The embodiments discussed herein are related to a library apparatus and an article transporting apparatus that are equipped with a transporting unit.

### BACKGROUND

Along with the increase in the amount of data in recent years, library apparatuses equipped with a rack that stores a large amount of recording media such as, for example, several thousands of magnetic tape media and with, for example, several tens of tape drives that perform reading and writing of data from and to the recording media have been proposed.

Among such library apparatuses, a library apparatus that includes a loading and ejecting mechanism (for example a mail slot) that is capable of loading and ejecting a large amount of recording media at one time has been known. The library apparatus transports the recording media, for example, by jobs from a plurality of servers or by loading and ejection of the recording media in the loading and ejecting mechanism.

Conventionally, an information storage system equipped with a magazine rack that accommodates a magazine loaded with a plurality of portable recording media and with a magazine transporting mechanism that transports the magazine has been known (for example, see Patent document 1).

An automatic changer equipped with a magazine that stores recording media in units of a plurality of recording media and with a transporting mechanism that transports the magazine has been known (for example, see Patent document 2).

A magnetic tape apparatus equipped with two or more pairs of cell blocks that store a plurality of cartridge magnetic tapes with an opening part of the cell blocks positioned opposite to that of each other, configured to perform taking-out or storing of a cartridge magnetic tape in the cell blocks on the both sides of a hand unit, has been known (for example, see Patent document 3).

Patent document 1: Japanese Laid-open Patent Publication No. 2008-165895

Patent document 2: Japanese Laid-open Patent Publication No. 08-138355

Patent document 3: Japanese Laid-open Patent Publication No. 06-111439

### SUMMARY

According to an aspect, a library apparatus includes a storing unit configured to store a plurality of recording media, and a transporting unit configured to shift in a first direction and in a second direction that intersect each other and to transport the recording media. The transporting unit includes an accommodating unit configured to be able to accommodate a plurality of the recording media, and a transferring unit configured to transfer the recording media one by one between the storing unit and the accommodating unit.

According to an aspect, an article transporting apparatus includes a transporting unit. The transporting unit is configured to shift in a first direction and in a second direction that intersect each other and to transport an article. The transporting unit includes an accommodating unit configured to be able to accommodate a plurality of articles, and a transferring unit configured to transfer the articles one by one between the accommodating unit and a storing unit configured to store a plurality of the articles.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a perspective view illustrating a library apparatus;

FIG. 2A is a back perspective view illustrating a recording medium transporting apparatus;

FIG. 2B is a front perspective view illustrating a recording medium transporting apparatus;

FIG. 3A is a perspective view (1) illustrating a transporting unit;

FIG. 3B is a perspective view (2) illustrating a transporting unit;

FIG. 4 is a perspective view illustrating a transferring unit;

FIG. 5A is a top perspective view illustrating a first conveyer mechanism;

FIG. 5B is a bottom perspective view illustrating a first conveyer mechanism;

FIG. 5C is a plan view illustrating a first conveyer mechanism;

FIG. 6 is a sectional view for VI-VI in FIG. 5C;

FIG. 7A is an exploded perspective view illustrating a hand unit from which a first conveyer mechanism and a second conveyer mechanism are removed;

FIG. 7B is a perspective view illustrating a hand unit;

FIG. 8A is an exploded perspective view illustrating a hand unit from which a first driving source and a first driving mechanism are removed;

FIG. 8B illustrates a view from the direction of arrow A in FIG. 8A;

FIG. 9A is a perspective view illustrating a hand unit in which a first conveyer mechanism and a second conveyer mechanism have approached each other;

FIG. 9B is a perspective view illustrating a hand unit in which a first conveyer mechanism and a second conveyer mechanism are apart from each other;

FIG. 10A is an exploded bottom perspective view illustrating a hand unit from which hand unit arms are removed;

FIG. 10B is a bottom perspective view illustrating a hand unit;

FIGS. 11A-11E are bottom plan views for explaining the movement of hand unit arms;

FIG. 12A is an exploded perspective view illustrating a tray from which stopper arms are removed;

FIG. 12B is a perspective view illustrating a tray;

FIG. 13A is an exploded perspective view illustrating a transferring unit from which a hand unit is removed;

FIG. 13B is a perspective view illustrating a transferring unit;

FIG. 14A is a perspective view (1) for explaining the shifting of a hand unit in a third direction;

FIG. 14B is a perspective view (2) for explaining the shifting of a hand unit in a third direction;

FIG. 15 is a perspective view illustrating a transferring unit in which a hand unit is in an initial state;

FIG. 16A is a perspective view (1) for explaining the movement of a hand unit;

FIG. 16B is a perspective view (2) for explaining the movement of a hand unit;

FIG. 16C is a perspective view (3) for explaining the movement of a hand unit;

FIG. 16D is a perspective view (4) for explaining the movement of a hand unit;

FIG. 16E is a perspective view (5) for explaining the movement of a hand unit;

FIG. 16F is a perspective view (6) for explaining the movement of a hand unit;

FIG. 16G is a perspective view (7) for explaining the movement of a hand unit;

FIG. 16H is a perspective view (8) for explaining the movement of a hand unit;

FIG. 16I is a perspective view (9) for explaining the movement of a hand unit;

FIG. 17A is a perspective view (1) for illustrating the movement in a portion B (a hand unit arm and a guide pin) in FIG. 15;

FIG. 17B is a perspective view (2) for illustrating the movement in a portion B in FIG. 15;

FIG. 17C is a perspective view (3) for illustrating the movement in a portion B in FIG. 15;

FIG. 17D is a perspective view (4) for illustrating the movement in a portion B in FIG. 15;

FIG. 17E is a perspective view (5) for illustrating the movement in a portion B in FIG. 15;

FIG. 17F is a perspective view (6) for illustrating the movement in a portion B in FIG. 15;

FIG. 17G is a perspective view (7) for illustrating the movement in a portion B in FIG. 15;

FIG. 17H is a perspective view (8) for illustrating the movement in a portion B in FIG. 15;

FIG. 17I is a perspective view (9) for illustrating the movement in a portion B in FIG. 15;

FIG. 18A is an explanatory diagram (1) for explaining the flexibility of a stopper arm;

FIG. 18B is an explanatory diagram (2) for explaining the flexibility of a stopper arm;

FIG. 19A is an explanatory diagram (1) for explaining the transfer of a recording medium from a storing unit to an accommodating unit;

FIG. 19B is an explanatory diagram (2) for explaining the transfer of a recording medium from a storing unit to an accommodating unit;

FIG. 19C is an explanatory diagram (3) for explaining the transfer of a recording medium from a storing unit to an accommodating unit;

FIG. 19D is an explanatory diagram (4) for explaining the transfer of a recording medium from a storing unit to an accommodating unit;

FIG. 19E is an explanatory diagram (5) for explaining the transfer of a recording medium from a storing unit to an accommodating unit;

FIG. 19F is an explanatory diagram (6) for explaining the transfer of a recording medium from a storing unit to an accommodating unit;

FIG. 19G is an explanatory diagram (7) for explaining the transfer of a recording medium from a storing unit to an accommodating unit;

FIG. 19H is an explanatory diagram (8) for explaining the transfer of a recording medium from a storing unit to an accommodating unit;

FIG. 19I is an explanatory diagram (9) for explaining the transfer of a recording medium from a storing unit to an accommodating unit;

FIG. 19J is an explanatory diagram (10) for explaining the transfer of a recording medium from a storing unit to an accommodating unit;

FIG. 20A is an explanatory diagram (1) for explaining the transfer of a recording medium from an accommodating unit to a storing unit;

FIG. 20B is an explanatory diagram (2) for explaining the transfer of a recording medium from an accommodating unit to a storing unit;

FIG. 20C is an explanatory diagram (3) for explaining the transfer of a recording medium from an accommodating unit to a storing unit;

FIG. 20D is an explanatory diagram (4) for explaining the transfer of a recording medium from an accommodating unit to a storing unit;

FIG. 20E is an explanatory diagram (5) for explaining the transfer of a recording medium from an accommodating unit to a storing unit;

FIG. 20F is an explanatory diagram (6) for explaining the transfer of a recording medium from an accommodating unit to a storing unit;

FIG. 21A is an explanatory diagram (1) for explaining the transportation of only one recording medium;

FIG. 21B is an explanatory diagram (2) for explaining the transportation of only one recording medium;

FIG. 21C is an explanatory diagram (3) for explaining the transportation of only one recording medium;

FIG. 21D is an explanatory diagram (4) for explaining the transportation of only one recording medium;

FIG. 22A is a perspective view illustrating a transporting unit;

FIG. 22B is an exploded perspective view illustrating a transporting unit from which an accommodating unit is removed;

FIG. 23A is a front perspective view illustrating an accommodating unit;

FIG. 23B is a back perspective view illustrating an accommodating unit;

FIG. 23C is a bottom perspective illustrating an accommodating unit;

FIG. 24A is an exploded perspective view illustrating an accommodating unit from which a top cover is removed;

FIG. 24B is an enlarged view of a portion C in FIG. 24A;

FIG. 24C is an exploded perspective view illustrating a portion C in FIG. 24A;

FIG. 25A is an exploded perspective view illustrating an accommodating unit from which a bottom cover is removed;

FIG. 25B is an enlarged view of a portion D in FIG. 25A.

FIG. 25C is an exploded perspective view illustrating a portion D in FIG. 25A;

FIG. 26A is an explanatory diagram (1) for explaining the shifting of a handle;

FIG. 26B is an explanatory diagram (2) for explaining the shifting of a handle;

FIG. 26C is an explanatory diagram (3) for explaining the shifting of a handle;

FIG. 27A is an explanatory diagram (1) for explaining the locking of a handle;

FIG. 27B is an explanatory diagram (2) for explaining the locking of a handle;

FIG. 28A is an explanatory diagram (1) for explaining the elastic deformation of a leaf spring;

FIG. 28B is an explanatory diagram (2) for explaining the elastic deformation of a leaf spring;

FIG. 29A is a top perspective view illustrating the portion of a transporting unit excluding an accommodating unit;

FIG. 29B is a bottom perspective view illustrating the portion of a transporting unit excluding an accommodating unit;

FIG. 30A is an explanatory diagram (1) for explaining the attachment and detachment of an accommodating unit;

FIG. 30B is an explanatory diagram (2) for explaining the attachment and detachment of an accommodating unit;

FIG. 30C is an explanatory diagram (3) for explaining the attachment and detachment of an accommodating unit;

FIG. 30D is an explanatory diagram (4) for explaining the attachment and detachment of an accommodating unit;

FIG. 30E is an explanatory diagram (5) for explaining the attachment and detachment of an accommodating unit;

FIG. 30F is an explanatory diagram (6) for explaining the attachment and detachment of an accommodating unit;

FIG. 31A is an explanatory diagram (1) for explaining the shifting of a handle at the time of the attachment and at the time of the detachment of an accommodating unit;

FIG. 31B is an explanatory diagram (2) for explaining the shifting of a handle at the time of the attachment and at the time of the detachment of an accommodating unit;

FIG. 31C is an explanatory diagram (3) for explaining the shifting of a handle at the time of the attachment and at the time of the detachment of an accommodating unit;

FIG. 31D is an explanatory diagram (4) for explaining the shifting of a handle at the time of the attachment and at the time of the detachment of an accommodating unit;

FIG. 31E is an explanatory diagram (5) for explaining the shifting of a handle at the time of the attachment and at the time of the detachment of an accommodating unit;

FIG. 31F is an explanatory diagram (6) for explaining the shifting of a handle at the time of the attachment and at the time of the detachment of an accommodating unit;

FIG. 32A is an explanatory diagram (1) for explaining the position of an accommodating unit in a transporting unit;

FIG. 32B is an explanatory diagram (2) for explaining the position of an accommodating unit in a transporting unit;

FIG. 33 is a perspective view illustrating a transporting route of a plurality of recording media from a storing unit to a drive;

FIG. 34A is a perspective view (1) for explaining the transportation of a plurality of recording media from a storing unit to a drive;

FIG. 34B is a perspective view (2) for explaining the transportation of a plurality of recording media from a storing unit to a drive;

FIG. 34C is a perspective view (3) for explaining the transportation of a plurality of recording media from a storing unit to a drive;

FIG. 34D is a perspective view (4) for explaining the transportation of a plurality of recording media from a storing unit to a drive;

FIG. 34E is a perspective view (5) for explaining the transportation of a plurality of recording media from a storing unit to a drive;

FIG. 35A is a side view (1) for explaining the transportation of a plurality of recording media from a storing unit to a drive;

FIG. 35B is a side view (2) for explaining the transportation of a plurality of recording media from a storing unit to a drive;

FIG. 35C is a side view (3) for explaining the transportation of a plurality of recording media from a storing unit to a drive;

FIG. 35D is a side view (4) for explaining the transportation of a plurality of recording media from a storing unit to a drive;

FIG. 35E is a side view (5) for explaining the transportation of a plurality of recording media from a storing unit to a drive;

FIG. 36A is an explanatory diagram (1) for explaining the loading and ejection of an accommodating unit into and from a library apparatus;

FIG. 36B is an explanatory diagram (2) for explaining the loading and ejection of an accommodating unit into and from a library apparatus;

FIG. 36C is an explanatory diagram (3) for explaining the loading and ejection of an accommodating unit into and from a library apparatus;

FIG. 36D is an explanatory diagram (4) for explaining the loading and ejection of an accommodating unit into and from a library apparatus;

FIG. 36E is an explanatory diagram (5) for explaining the loading and ejection of an accommodating unit into and from a library apparatus;

FIG. 37A is an enlarged view of a portion E in FIG. 36B;

FIG. 37B is an enlarged view (1) of a portion F in FIG. 36D;

FIG. 37C is an enlarged view (2) of a portion F in FIG. 36D;

FIG. 38 is a side view illustrating a transferring unit in a comparison example;

FIG. 39A is a plan view (1) for explaining the transfer by a transferring unit in a comparison example;

FIG. 39B is a plan view (2) for explaining the transfer by a transferring unit in a comparison example;

FIG. 39C is a plan view (3) for explaining the transfer by a transferring unit in a comparison example;

FIG. 39D is a plan view (4) for explaining the transfer by a transferring unit in a comparison example;

FIG. 40A is a plan view (1) for explaining the contact condition at the time of the shifting of a transferring unit in a comparison example;

FIG. 40B is a plan view (2) for explaining the contact condition at the time of the shifting of a transferring unit in a comparison example; and

FIG. 41 is a perspective view illustrating a library apparatus according to a related art.

### DESCRIPTION OF EMBODIMENTS

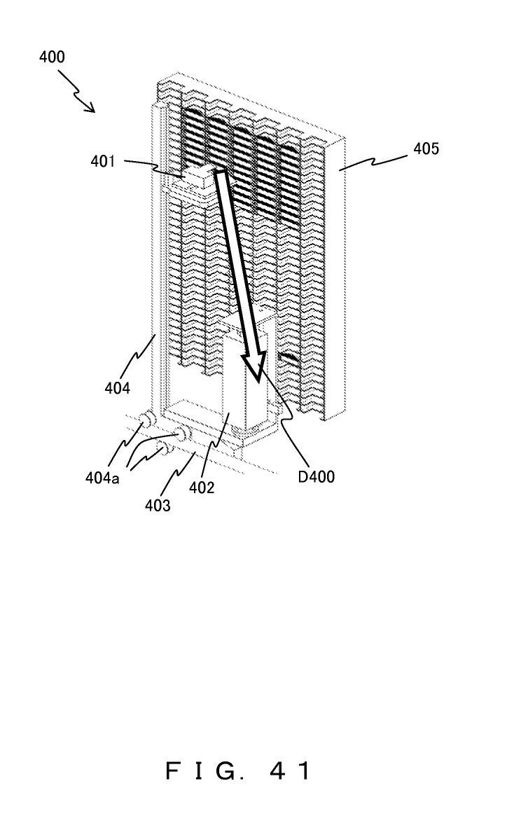

FIG. 41 is a perspective view illustrating a library apparatus 400 according to a related art.

A transferring unit 401 is placed to be able to access any medium storage position in a storing unit 405. The transferring unit 401 transfers recording media between an accommodating unit 402 and the storing unit 405. The transferring unit 401 shifts in the height direction along a height-direction guide 404.

The height-direction guide 404 is shifted in the lateral direction along a lateral-direction guide 403 by three rollers 404a.

The accommodating unit 402 is capable of accommodating a plurality of recording media. The accommodating unit 402 is provided in the height-direction guide 404.

As described above, while the transferring unit 401 shifts in the lateral direction and in the height direction, the accommodating unit 402 shifts only in the lateral direction. Therefore, the transfer of the recording media by the transferring unit 401 to the accommodating unit 402 involves a shift in the height direction (arrow D400).

Meanwhile, as described above, in a case in which recording media are transported in units of a magazine, the transporting apparatus becomes larger compared with that in a case in which recording media are transported one by one. Furthermore, when a plurality of recording media to be transported are respectively stored in different magazines, the transportation takes time, since the magazines are to be transported a plurality of times.

In addition, as illustrated in FIG. 41, in a case in which a recording medium M is to be transported after a recording medium is transported by the transferring unit 401 from the storing unit 405 to the accommodating unit 402, the action for the transferring unit 401 to shift to the accommodating unit 402 takes time.

According to an aspect, an objective of the present invention is to provide a library apparatus and an article transporting apparatus with which efficiency in transportation may be enhanced.

Hereinafter, a library apparatus 1 and a recording medium transporting apparatus 5 that is an example of an article transporting apparatus according an embodiment are explained.

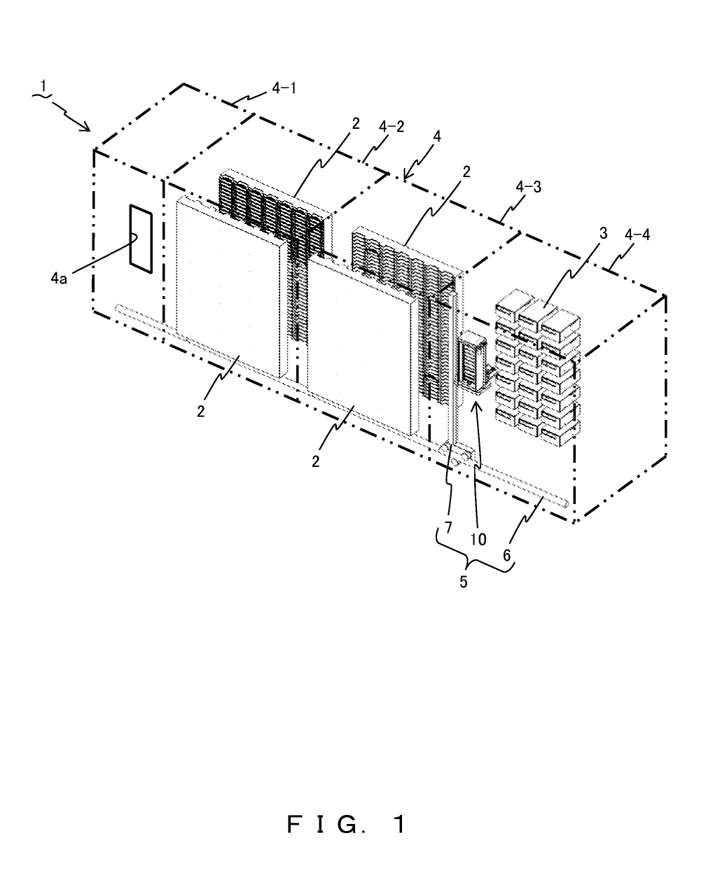

FIG. 1 is a perspective view illustrating the library apparatus 1.

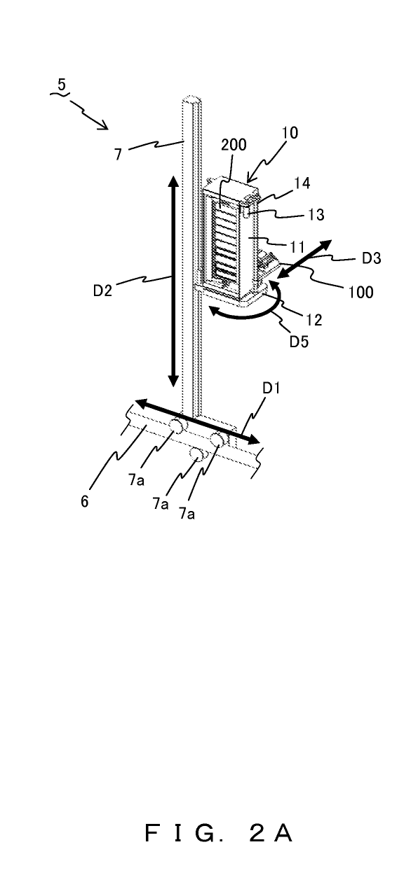

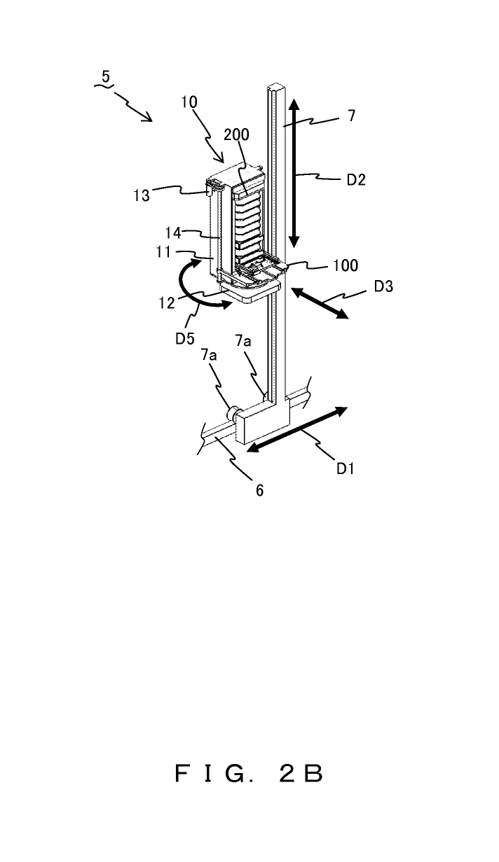

FIG. 2A and FIG. 2B are a back perspective view and a front perspective view illustrating the recording medium transporting apparatus 5.

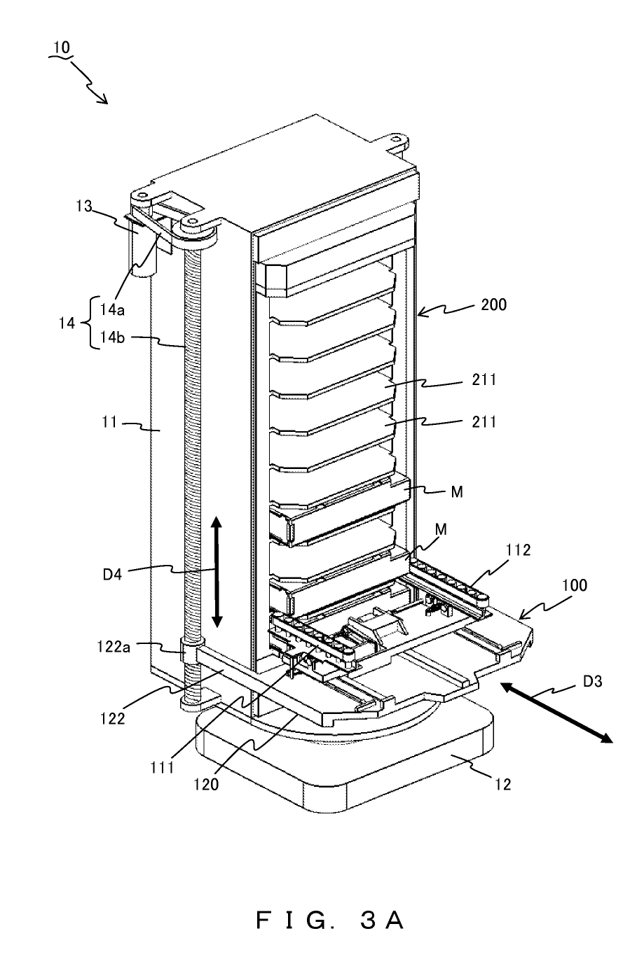

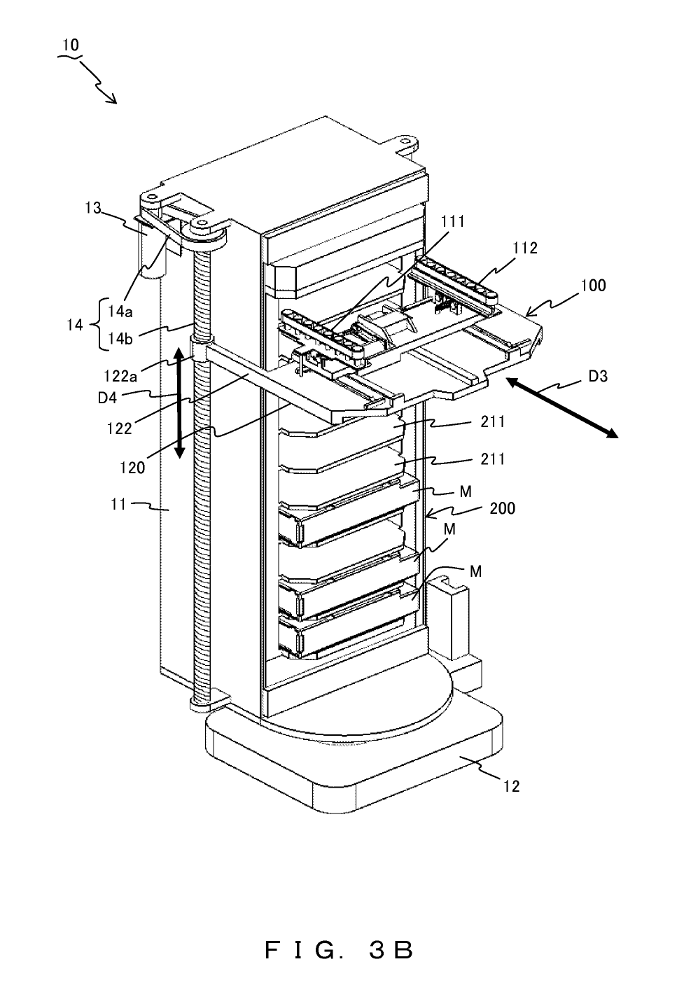

FIG. 3A and FIG. 3B are perspective views illustrating a transporting unit 10.

The library apparatus 1 illustrated in FIG. 1 includes storing units 2, drives 3, a casing 4, and the recording medium transporting apparatus 5.

The storing unit 2 stores a plurality of recording media M. The storing unit 2 is, for example, a rack. The recording medium M is an example of an article. The recording medium M is, for example, a magnetic tape, an optical disk, or the like. In article transporting apparatuses used for purposes other than for the library apparatus 1, the article may be anything that is transported, and it does not have to be the recording medium M. Two storing units 2 are placed in each of a second portion 4-2 and a third portion 4-3 of the casing 4 described later, in a way in which the recording media M oppose each other. The number of the storing unit(s) 2 to be placed may be 1 or greater.

The drive 3 performs reading and writing of data from and to the recording medium M. A plurality of drives 3 are placed in a fourth portion 4-4 of the casing 4.

The storing units 2, the drives 3, the recording medium transporting apparatus 5 are placed inside the casing 4. The casing 4 includes the second through fourth portions 4-2, 4-3, and 4-4 described above, and a first portion 4-1. A loading and ejecting opening 4a through which an accommodating unit 200 illustrated in FIG. 2A is loaded and ejected is formed in the first portion 4-1 of the casing 4. The respective portions 4-1, 4-2, 4-3, and 4-4 described above are given merely as an example, and they may be either partitioned or not partitioned from each other.

The recording medium transporting apparatus 5 includes a first-direction guide 6, a second-direction guide 7, and the transporting unit 10.

As illustrated in FIG. 2A and FIG. 2B, the first-direction guide 6 guides the second-direction guide 7 in a first direction (arrow D1) that is for example a horizontal direction. The first-direction guide 6 is placed across the respective portions 4-1, 4-2, 4-3, and 4-4 of the casing 4.

The second-direction guide 7 guides the transporting unit 10 in a second direction (arrow D2) that intersects the first direction (arrow D1) that is for example a vertical direction. The second-direction guide 7 includes for example three rollers 7a. The second-direction guide 7 is shifted along the first-direction guide 6 by the shifting of the rollers 7a along the first-direction guide 6.

The transporting unit 10 shifts in the second direction (arrow D2) along the second-direction guide 7. The transporting unit 10 is also shifted in the first direction (arrow D1) by the shifting of the second-direction guide 7 in the first direction (arrow D1) along the first-direction guide 6. The transporting unit 10 shifts to a plurality of positions including those of the storing unit 2, the drives 3, and the loading and ejecting opening 4a.

As illustrated in FIG. 3A and FIG. 3B, the transporting unit 10 includes a frame 11, a base part 12, a second driving source 13, and a third driving mechanism 14. While the transporting unit 10 further includes a transferring unit 100 and an accommodating unit 200, they are described later. In addition, descriptions about a first driving source 115, a first driving mechanism 116, and a second driving mechanism 117 are also given later.

The portion of the transporting unit 10 that is placed on the base part 12 rotates for example by 180 degrees in a fifth direction (arrow D5) on the base part 12, as illustrated in FIG. 2A and FIG. 2B. The portion of the transporting unit 10 that is placed on the base part 12 includes, for example, the frame 11, the second driving source 13, the third driving mechanism 14, the transferring unit 100, and the accommodating unit 200. For example, the fifth direction (arrow D5) is a rotation direction whose center of rotation is a vertical direction. Accordingly, the transporting unit 10 is able to face both of the storing units 2 illustrated in FIG. 1 that oppose each other.

The frame 11 illustrated in FIG. 3A and FIG. 3B assumes a quadrangular shape in a front view (a back view) that for example has openings on the front face side (see FIG. 2B) and on the back face side (see FIG. 2A). The accommodating unit 200 is detachably placed into the frame 11 from its back face side. Thus, the accommodating unit 200 is detachable with respect to the transporting unit 10.

The accommodating unit 200 is capable of accommodating a plurality of recording media M. For example, the accommodating unit 200 accommodates the recording media M so that the recording media M are arranged in a fourth direction (arrow D4) that is a vertical direction. The recording medium M is placed for example on a partition plate 211.

The fourth direction (arrow D4) is orthogonal to a third direction (arrow D3) that is a transporting direction of the recording medium M by first and second conveyer mechanisms 111 and 112 described later. The third direction (arrow D3) is a direction that intersects, that is, for example, a direction that is orthogonal to, a plane defined by the first direction (arrow D1) and the second direction (arrow D2). It is preferable that the fourth direction (arrow D4) is a direction that is different from the third direction (arrow D3).

The third driving mechanism 14 makes the transferring unit 100 shift in the fourth direction (arrow D4). For example, the third driving mechanism 14 includes a drive transmission belt 14a and a ball screw 14b.

A drive transmission belt 14a makes the ball screw 14b rotate by a power transmitted from the second driving source 13. A nut part 122a of a tray arm 122 is placed on the ball screw 14b. The first tray arm 122 is provided in a tray 120 of the transferring unit 100.

As illustrated in FIG. 3A and FIG. 3B, the nut part 122a is moved upward and downward by the rotation of the ball screw 14b. That is, the transferring unit 100 shifts upward and downward. The direction in which the second driving source 13 makes the transferring unit 100 shift is the fourth direction (arrow D4) that is the direction in which the recording media M are arranged in the accommodating unit 200. It is preferable that a ball screw that rotates in a manner that is similar to the manner in which the ball screw 14b rotates is placed as well on the side opposite to the ball screw 14b across the frame 11.

The position of the transferring unit 100 is detected by a position detecting means such as a tachometer provided in the second driving source 13. Accordingly, the transferring unit 100 may be shifted to any position. The position of a hand unit 110 described later may also be detected by providing a position detecting means in the first driving source 115 for example.

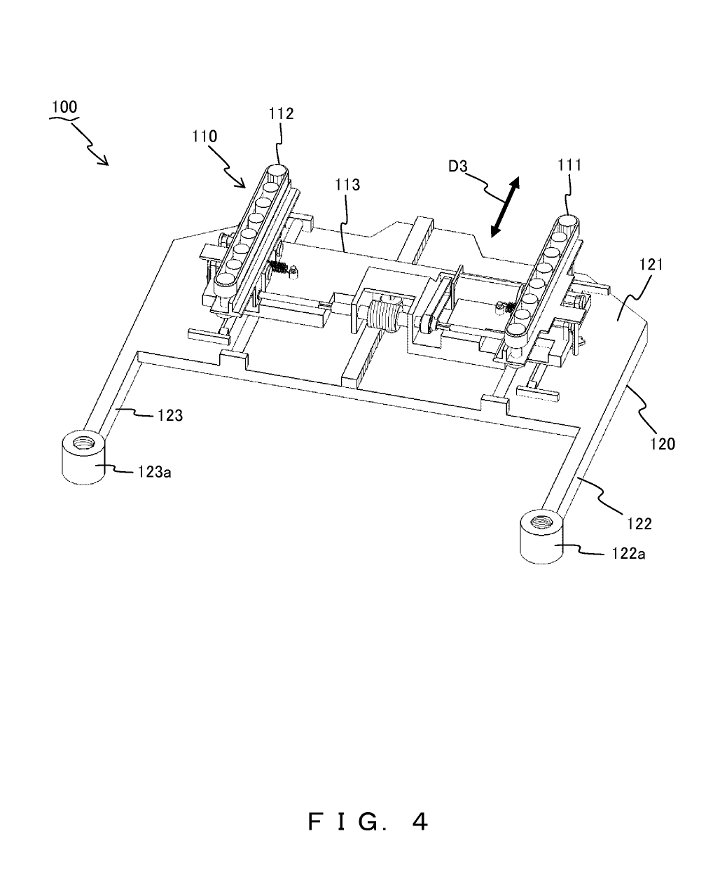

FIG. 4 is a perspective view illustrating the transferring unit 100.

The transferring unit 100 transfers the recording media M one by one between the storing unit 2 and the accommodating unit 200.

The transferring unit 100 includes a hand unit 110 and a tray 120.

The hand unit 110 includes a pair of a first conveyer mechanism 111 and a second conveyer mechanism 112, and a hand unit base 113.

The first conveyer mechanism 111 and the second conveyer mechanism 112 are an example of a carrying unit that carries the recording medium M in the third direction (arrow D3). The first and the second conveyer mechanisms 111 and 112 oppose each other and hold the recording media M therebetween. For example, the carrying unit may also be one in which a slider on which the recording medium M is placed or a slider that holds the recording medium M by the magnetic power or the like shifts. In addition, the conveyer mechanism may be a single one on which the recording medium M is placed.

The first conveyer mechanism 111 and the second conveyer mechanism 112 include a carrying means such as a belt or a roller (for example carrying belts 111e and 112e), and they carry one recording medium M continuously in the third direction (arrow D3). While each of the first conveyer mechanism 111 and the second conveyer mechanism 112 assumes an endless-belt form, the form does not have to be endless, and does not have to be a belt form.

While details are described later, the first conveyer mechanism 111 and the second conveyer mechanism 112 themselves also shift in the third direction (arrow D3) while carrying the recording medium M in the third direction (arrow D3).

The tray 120 includes a tray main body 121, a first tray arm 122, and a second tray arm 123.

The hand unit 110 is placed on the tray main body 121.

The first tray arm 122 and the second tray arm 123 are arranged for example to protrude horizontally from the tray main body 121, and they extend in parallel to each other. The first tray arm 122 and the second tray arm 123 include nut parts 122a and 123a that are penetrated by the above-mentioned ball screw 14b illustrated in FIG. 3A and FIG. 3B.

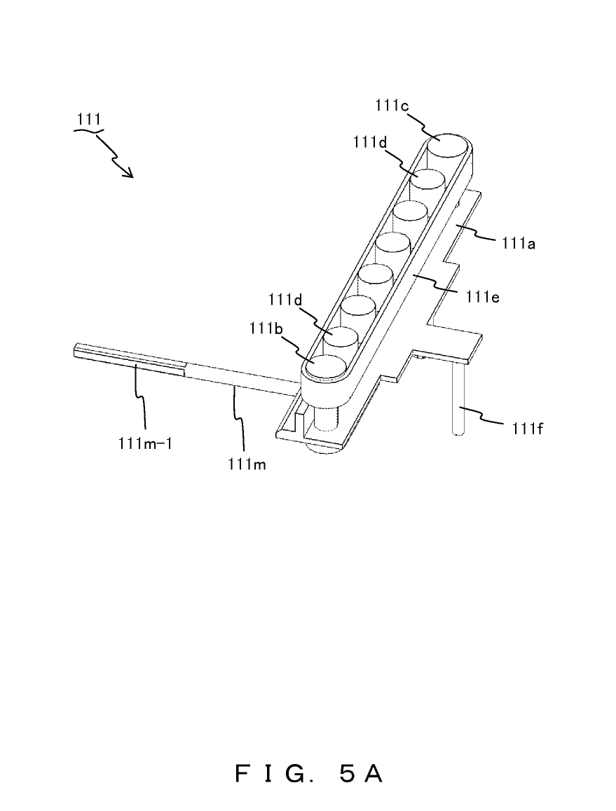

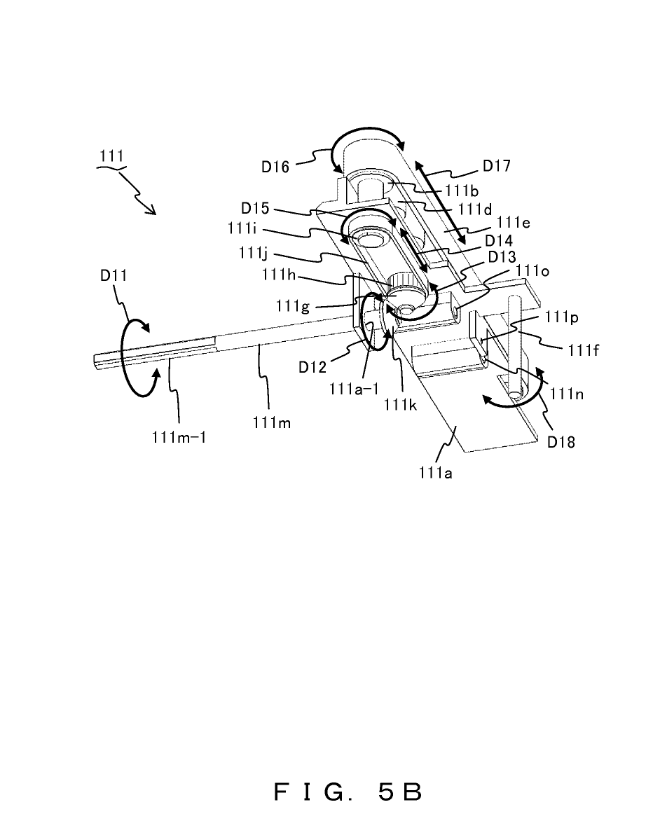

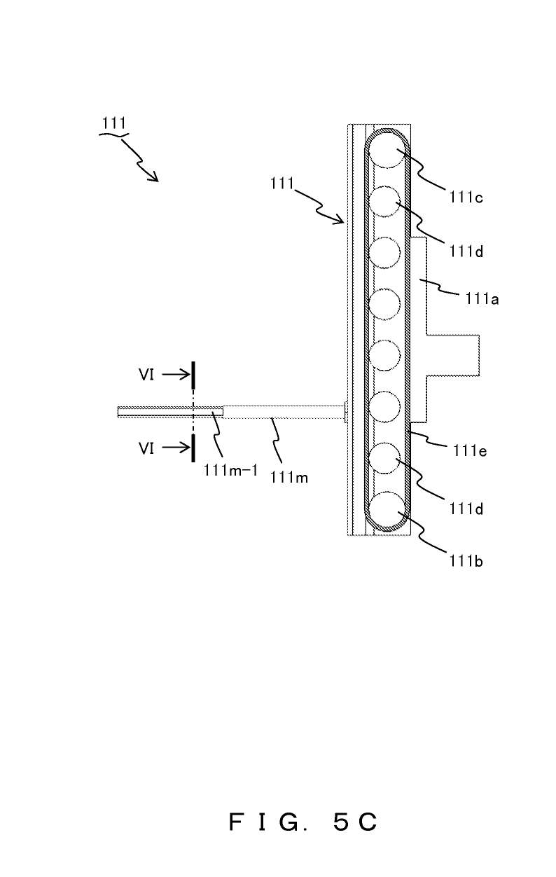

FIG. 5A and FIG. 5B are a top perspective view and a bottom perspective view illustrating the first conveyer mechanism 111.

FIG. 5C is a plan view illustrating the first conveyer mechanism 111.

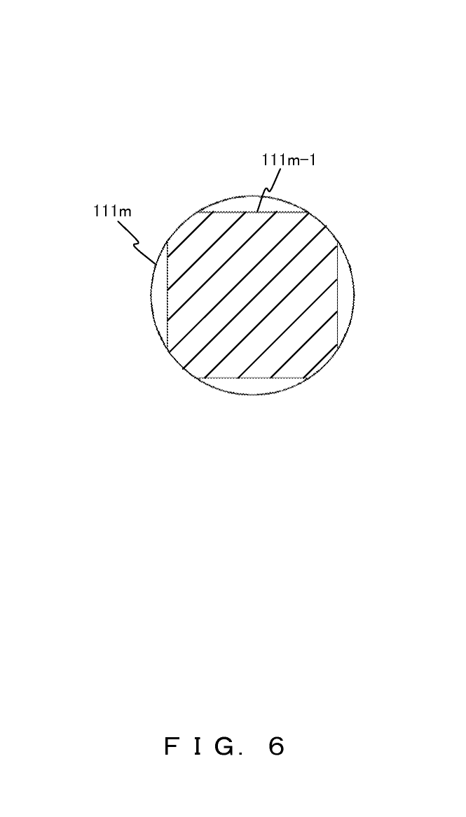

FIG. 6 is a sectional view for VI-VI in FIG. 5C.

Meanwhile, while the first conveyer mechanism 111 is illustrated in FIG. 5A through FIG. 6, the second conveyer mechanism 112 assumes for example a shape that is laterally symmetrical to that of the first conveyer mechanism 111.

As illustrated in FIG. 5A and FIG. 5C, the first conveyer mechanism 111 includes a conveyer base 111a, a driving pulley 111b, a driven pulley 111c, driven rollers 111d, a carrying belt 111e, a guide pin 111f, and a drive transmission shaft 111m.

As illustrated in FIG. 5B, the first conveyer mechanism 111 further includes bevel gears 111g and 111k, drive transmission pulleys 111h and 111i, a drive transmission belt 111j, slide shaft through-holes 111n and 111o, and a tension spring hook part 111p.

The conveyer base 111a assumes for example a plate form that extends in a horizontal direction.

The driving pulley 111b is placed coaxially with the drive transmission pulley 111i placed on a lower portion of the conveyer base 111a. The driving pulley 111b is placed on a top part of the conveyer base 111a.

The driven pulley 111c is placed on the side opposite to the driving pulley 111b, with the six driven rollers 111d between the driven pulley 111c and the driving pulley 111b.

The carrying belt 111e is placed across the driving pulley 111b and the driven pulley 111c. As illustrated in FIG. 5B, the carrying belt 111e is rotated (arrow D17) by the rotation of the driving pulley 111b (arrow D16). Accordingly, the carrying belt 111e abuts on the recording medium M and carries the recording medium in the third direction (arrow D3) illustrated in FIG. 4. Meanwhile, the driven pulley 111c also rotates (arrow D18) together with the carrying belt 111e.

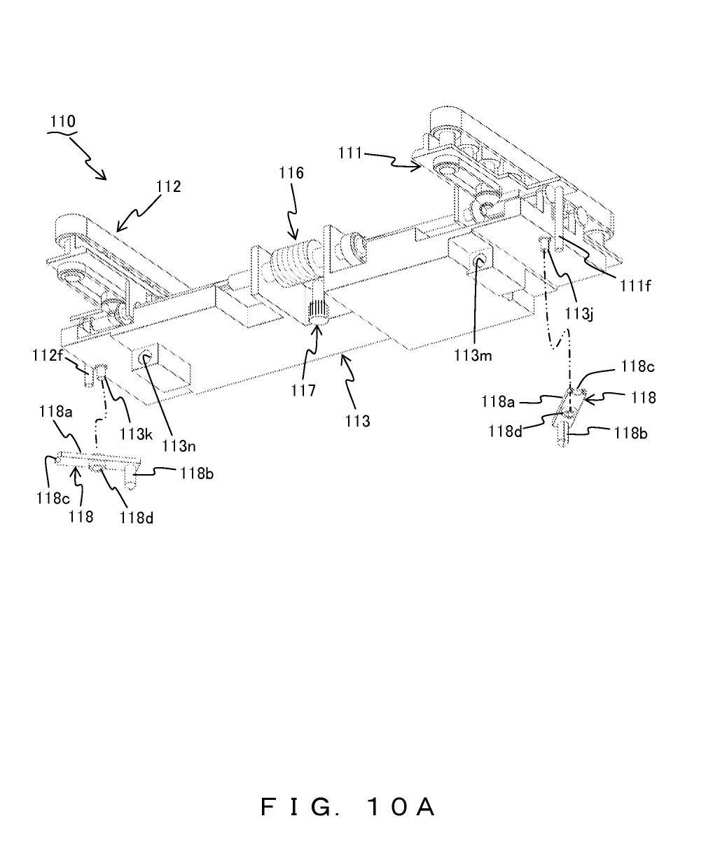

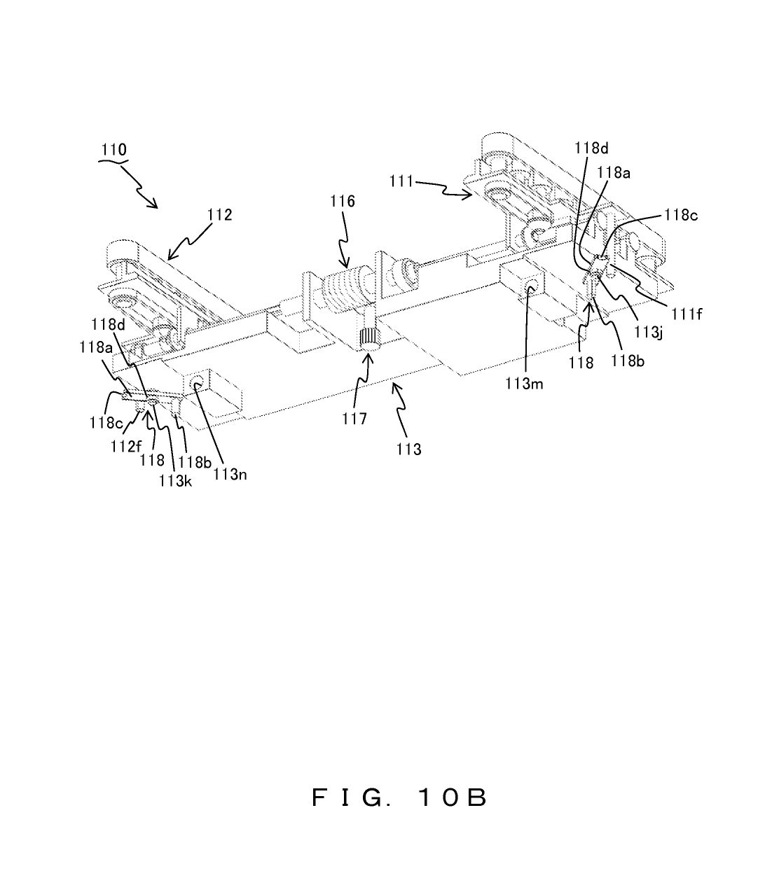

The guide pin 111f is arranged to extend downward from the conveyer base 111a. While details are described later, the guide pin 111f is inserted into a recessed part 118c of a hand unit arm 118 illustrated in FIG. 10A.

The bevel gear 111g is provided at the lower end of the drive transmission pulley 111h. The drive transmission pulley 111h is provided on the lower portion of the conveyer base 111a. The bevel gear 111g meshes with the bevel gear 111k provided at an end of the drive transmission shaft 111m, so as to convert a rotating motion (arrows D11, D12) around a horizontal axis transmitted from the drive transmission shaft 111m into a rotating motion (arrow D13) around a vertical axis.

The drive transmission pulley 111h rotates together with the bevel gear 111g. The drive transmission belt 111j placed across the drive transmission pulley 111h and the drive transmission pulley 111i is rotated (arrow D14) by the rotation of the drive transmission pulley 111h (arrow D13). Accordingly, the drive transmission pulley 111i rotates (arrow D15), and the driving pulley 111b placed coaxially with the drive transmission pulley 111i rotates (arrow D16). Accordingly, the carrying belt 111e rotates as well (arrow D17).

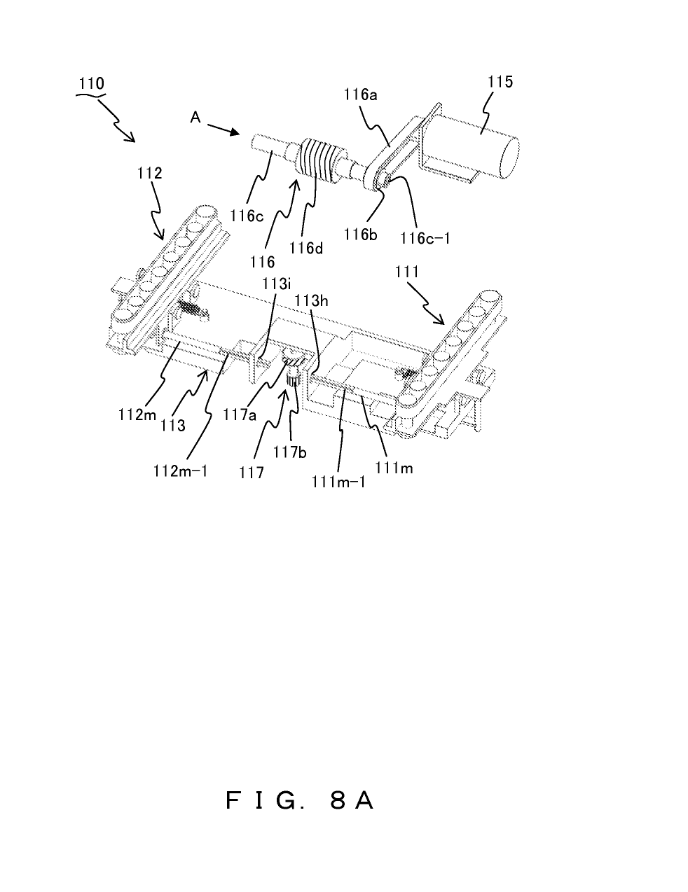

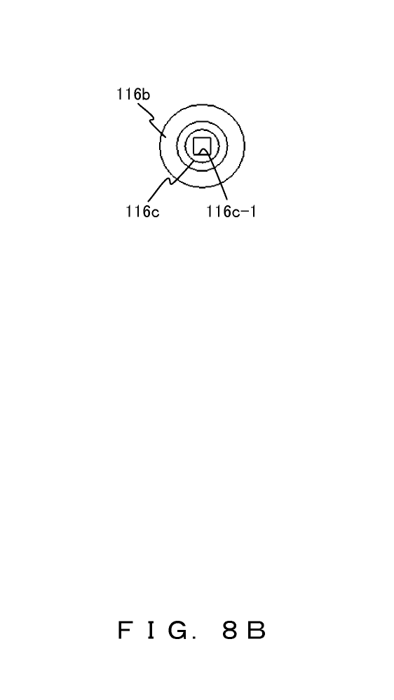

The drive transmission shaft 111m is connected to a connecting shaft 116c of a first driving mechanism 116 illustrated in FIG. 8A described later. The drive transmission shaft 111m receives the transmission of the rotating motion (arrow D11) around a horizontal axis mentioned above from the first driving mechanism 116.

The connecting shaft insertion part 111m−1 provided at an end part that is opposite to the bevel gear 111k in the drive transmission shaft 111m assumes a quadrangular shape whose top, bottom, left, and right sides are cut into a flat surface and whose corners are rounded, as illustrated in FIG. 6 (the sectional view for VI-VI in FIG. 5C).

The slide shaft through-holes 111n and 1110 are penetrated by slide shafts 113b and 113c described later.

An end of a tension spring 114 described later is hooked on the tension spring hook part 111p.

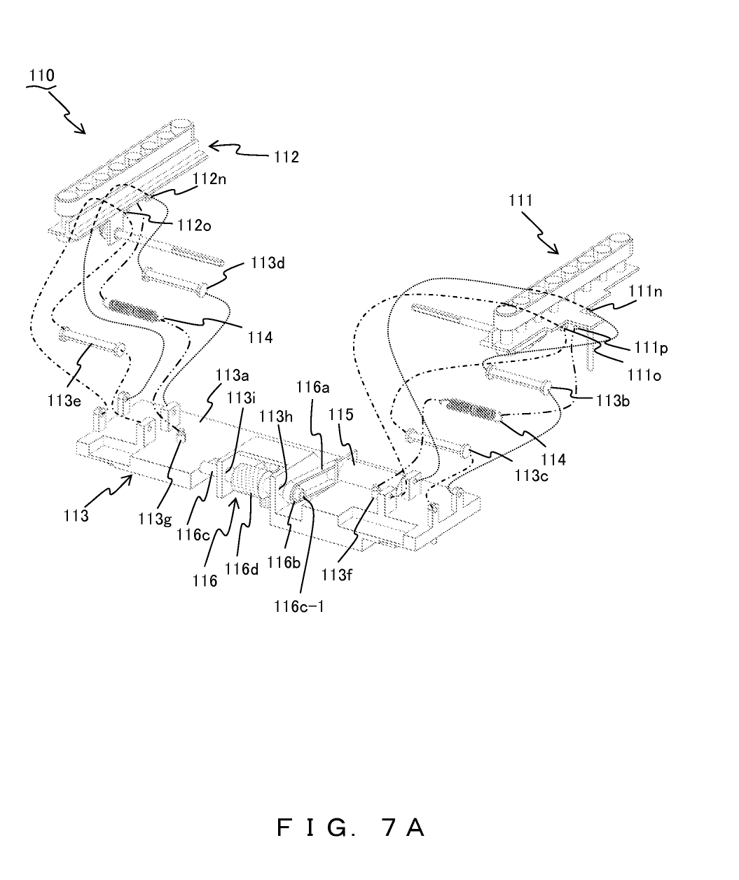

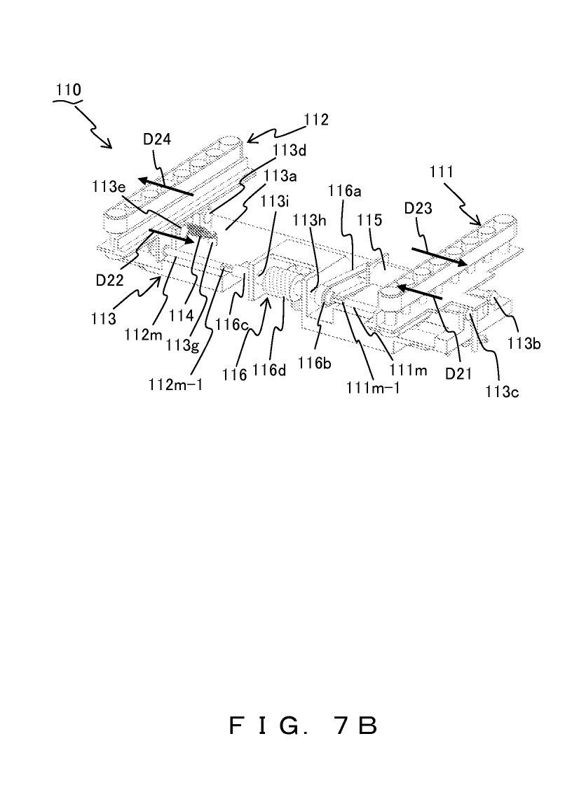

FIG. 7A is an exploded perspective view illustrating the hand unit 110 from which the first conveyer mechanism 111 and the second conveyer mechanism 112 are removed.

FIG. 7B is a perspective view illustrating the hand unit 110.

As illustrated in FIG. 7A and FIG. 7B, the hand unit 110 further includes the two tension springs 114, the first driving source 115, and the first driving mechanism 116. While the hand unit 110 further includes a second driving mechanism 117 and hand unit arms 118, they are described later.

The hand unit base 113 includes a base main body 113a, four slide shafts 113b, 113c, 113d, and 113e, tension spring hook parts 113f and 113g, and connecting shaft through-holes 113h and 113i. While the hand unit base 113 further includes two guide rail through-holes 113m and 113n, they are described later.

On the base main body 113a, the first and the second conveyer mechanisms 111 and 112 are respectively placed at the both ends of its longitudinal direction.

The slide shafts 113b and 113c penetrate slide shaft through-holes 111n and 1110 of the first conveyer mechanism 111, and the both ends of them are supported on the base main body 113a.

The slide shafts 113d and 113e penetrate slide shaft through-holes 112n and 112o of the second conveyer mechanism 112, and the both ends of them are supported on the base main body 113a.

The four slide shafts 113b, 113c, 113d, and 113e in total guide the sliding shifts of the first and the second conveyer mechanisms 111 and 112 in a direction in which they approach each other and in a direction in which they move apart from each other.

The two tension spring hook parts 113f and 113g are provided on the base main body 113a.

The tension spring hook part 113f on one side catches the other end of the tension spring 114 that is opposite to one end supported by the tension spring hook part 111p of the first conveyer mechanism 111.

The tension spring hook part 113g on the other side catches the other end of the tension spring 114 that is opposite to one end supported by a tension spring hook part of the second conveyer mechanism 112 that is not illustrated in the drawing.

The tension springs 114 pull the tension spring hook parts 111p of the first and the second conveyer mechanisms 111 and 112 toward the tension spring hook parts 113f and 113g sides. Accordingly, the first and the second conveyer mechanisms 111 and 112 are energized by the two tension springs 114 in the direction in which they approach each other (arrows D21, D22 illustrated in FIG. 7B). Thus, the tension springs 114 function as an example of a conveyer energizing mechanism that energizes the first and the second conveyer mechanisms 111 and 112 in the direction in which they approach each other.

In addition, while this is described later, by the pressing of the guide pin 111f by the hand unit arm 118, the first and the second conveyer mechanisms 111 and 112 are shifted not only in the direction in which they approach each other but also in the direction in which they move apart from each other. Thus, the first and the second conveyer mechanisms 111 and 112 shift in the direction in which they approach each other and in the direction in which they move apart from each other (arrows D23, D24 illustrated in FIG. 7B).

FIG. 8A is an exploded perspective view illustrating the hand unit 110 from which the first driving source 115 and the first driving mechanism 116 are removed.

FIG. 8B illustrates a view from the direction of arrow A in FIG. 8A.

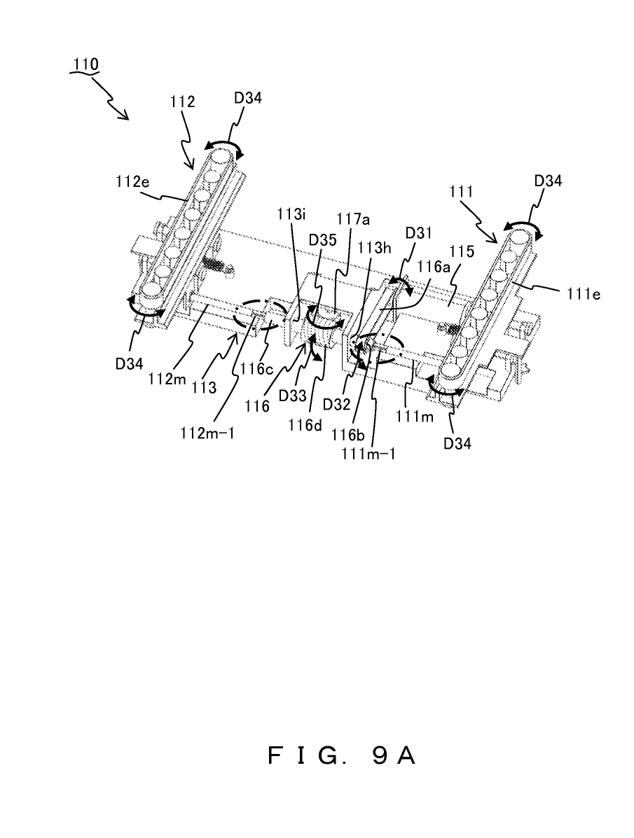

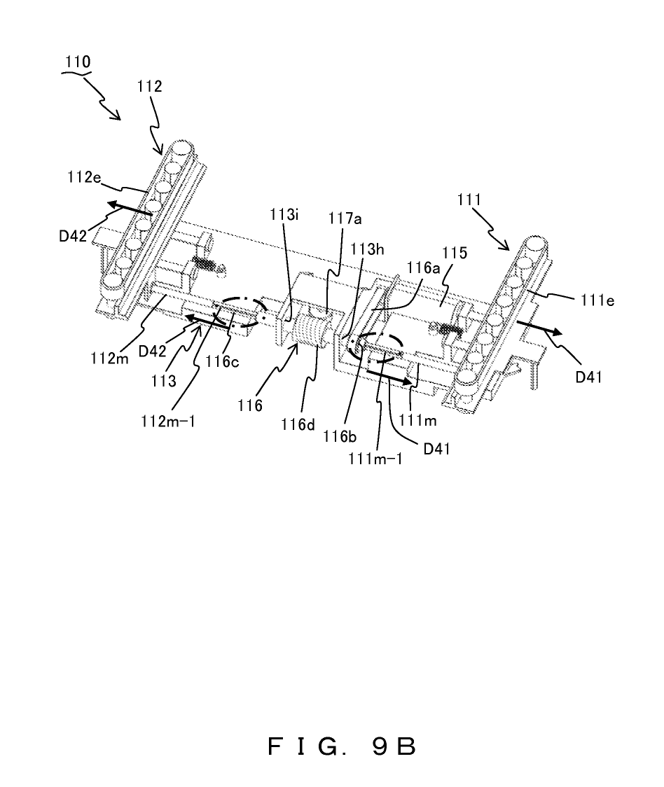

FIG. 9A is a perspective view illustrating the hand unit 110 in which the first conveyer mechanism 111 and the second conveyer mechanism 112 have approached each other.

FIG. 9B is a perspective view illustrating the hand unit 110 in which the first conveyer mechanism 111 and the second conveyer mechanism 112 are apart from each other.

The first driving source 115 is placed on the base main body 113a. The first driving source 115 is a single driving source that generates both the driving power for the first driving mechanism 116 and the driving power for the second driving mechanism 117.

The first driving mechanism 116 actuates the first and the second conveyer mechanisms 111 and 112. That is, the first driving mechanism 116 makes the carrying belts 111e and 112e of the first and the second conveyer mechanisms 111 and 112 rotate. Accordingly, the recording medium M is carried in the third direction (arrow D3 illustrated in FIG. 4).

The first driving mechanism 116 includes a drive transmission belt 116a, a drive transmission pulley 116b, a connecting shaft 116c, and a worm 116d.

As illustrated in FIG. 8A, the drive transmission belt 116a is placed across the first driving source 115 and the drive transmission pulley 116b. As illustrated in FIG. 9A, the drive transmission belt 116a is rotated (arrow D31) by the driving by the drive transmission belt 116a, and it makes the drive transmission pulley 116b rotate (arrow D32).

As illustrated in FIG. 8A, the drive transmission pulley 116b is provided on the connecting shaft 116c. The connecting shaft 116c is rotated by the rotation of the drive transmission pulley 116b. Accordingly, the driving power is transmitted to the first conveyer mechanism 111 through the drive transmission shaft 111m that is inserted in to a square hole 116c−1 of the connecting shaft 116c illustrated in FIG. 8B. Then, as illustrated in FIG. 9A, the carrying belt 111e of the first conveyer mechanism 111 rotates (arrow D34).

In a similar manner, the driving power is transmitted to the second conveyer mechanism 112 through a square hole that is not illustrated in the drawing provided on the side opposite to the side of the square hole 116c−1 in the connecting shaft 116c. Then, the carrying belt 112e of the second conveyer mechanism 112 rotates (arrow D34).

Meanwhile, a prescribed length of the connecting shaft insertion part 111m−1 of the drive transmission shaft 111m is inserted into the square hole 116c−1. For this reason, as illustrated in FIG. 9B, the drive transmission shaft 111m is still inserted in the square hole 116c−1, even when the first and the second conveyer mechanisms 111 and 112 shift in the direction in which they move apart from each other (arrows D41, 42).

The worm 116d is placed on the connecting shaft 116c, and it transmits a power to a worm wheel 117a of the second driving mechanism 117 described later.

The structure of the first driving mechanism 116 described above is given merely as an example, and it may be appropriately modified as long as a carrying unit (the first and the second conveyer mechanisms 111 and 112) is driven so as to transport the recording medium M in the third direction (arrow D3). For example, an appropriate modification such as to change the drive transmission belt 116a to a gear may be made.

The second driving mechanism 117 illustrated in FIG. 8A makes the first and the second conveyer mechanisms 111 and 112 with the entirety of the hand unit 110 shift in the third direction (arrow D3 illustrated in FIG. 4). For example, the second driving mechanism 117 includes a worm wheel 117a and a gear 117b.

The worm wheel 117a meshes with the worm 116d that makes a rotating motion around a horizontal axis, and it rotates around a vertical axis.

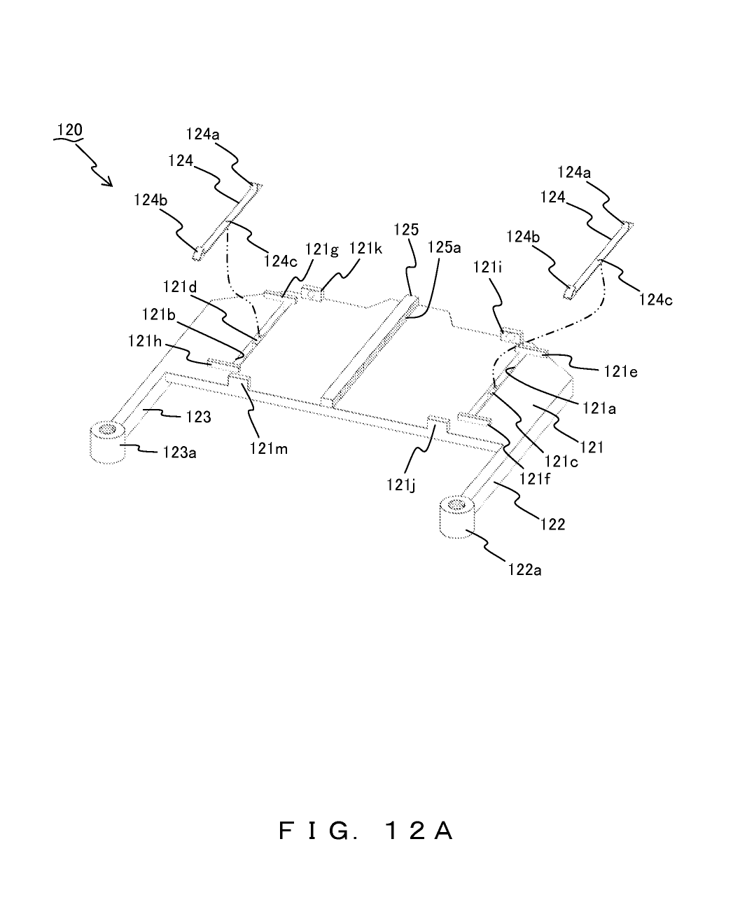

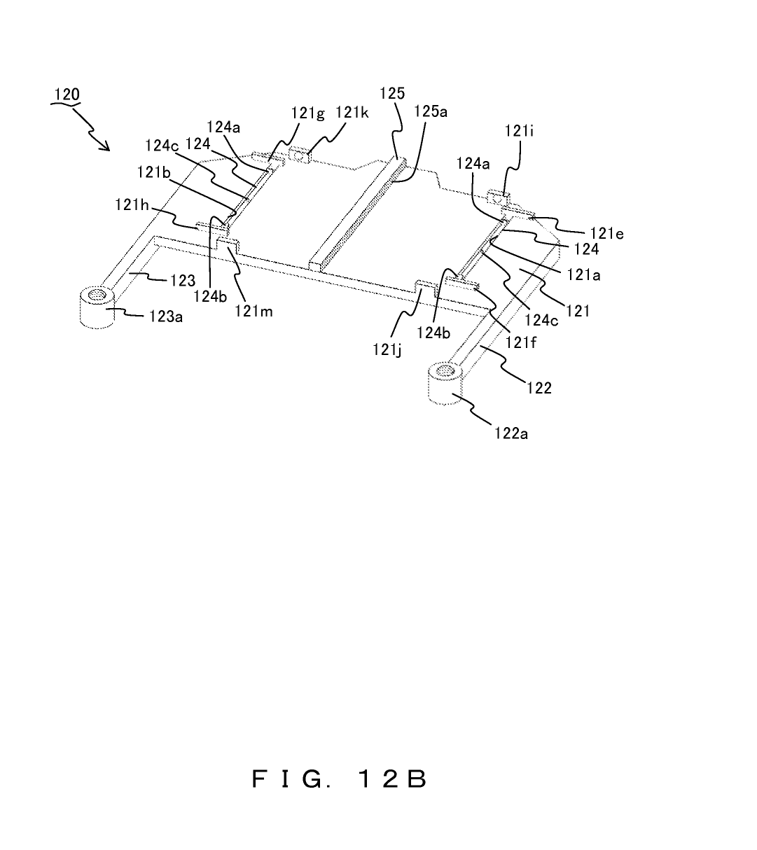

The gear 117b is provided coaxially with the worm wheel 117a, and it rotates around a vertical axis in a manner similar to the manner in which the worm wheel 117a rotates. While details are described later, the gear 117b meshes with a rack tooth 125a of a rack rail 125 illustrated in FIG. 12A, so as to make the first and the second conveyer mechanisms 111 and 112 shift in third direction (arrow D3 illustrated in FIG. 4).

The structure of the second driving mechanism 117 described above is given merely as an example, and it may be appropriately modified as long as it makes a carrying unit (the first and the second conveyer mechanisms 111 and 112) shift in the third direction (arrow D3).

Meanwhile, a case in which the carrying unit is not the first and the second conveyer mechanisms 111 and 112 but a carrying unit in which a slider on which the recording medium M is placed or a slider that holds the recording medium M by the magnetic power or the like shifts is considered. In this case, the second driving mechanism 117 may be configured so that a slider that makes the first and the second conveyer mechanisms 111 shift and a base on which the slider is placed are shifted by the second driving mechanism 117.

FIG. 10A is an exploded bottom perspective view illustrating the hand unit 110 from which the hand unit arms 18 are removed.

FIG. 10B is a bottom perspective view illustrating the hand unit 110.

The hand unit arm 118 is provided with an arm base 118a, an arm pin 118b, and a recessed part 118c. The hand unit arm 118 is placed in each of a lower portion of the first conveyer mechanism 111 and a lower portion of the second conveyer mechanism 112.

The arm base 118a assumes, for example, a rectangular plate form that extends in a horizontal direction.

The arm pin 118b protrudes downward from the arm base 118a at one end of the longitudinal direction of the arm base 118a.

The recessed part 118c assumes a shape hollowed out in a semicircle shape in a plan view, at the other end of the longitudinal direction of the arm base 118a.

An attachment hole 118d is formed so as to penetrate the arm base 118a in a vertical direction at the center of the arm base 118a. Arm attachment shafts 113j and 113k provided so as to protrude downward on the both ends of the longitudinal direction of the hand unit base 113 are inserted into the attachment hole 118d.

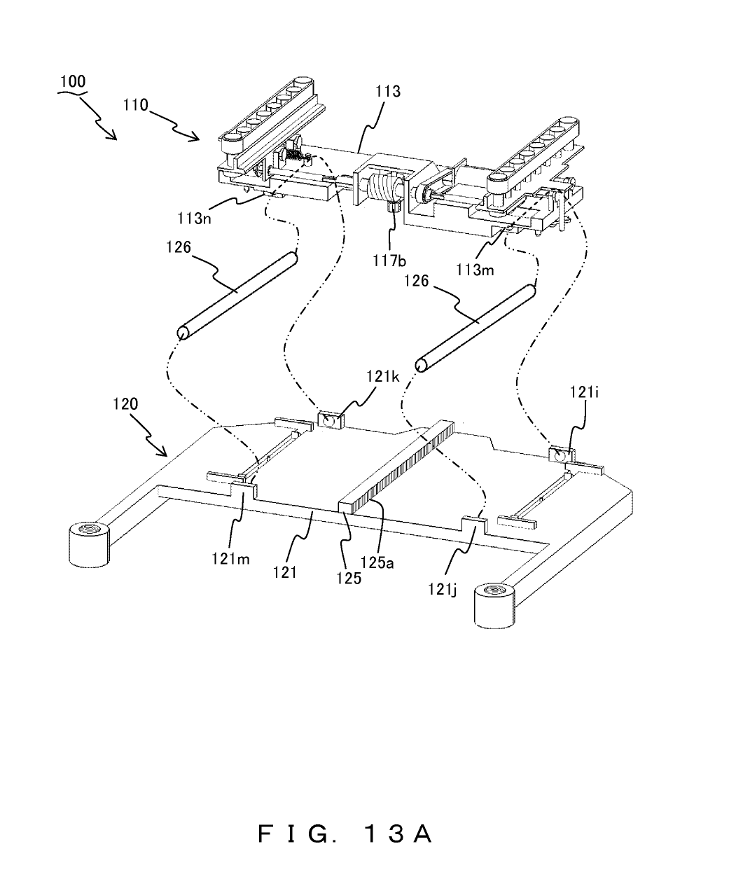

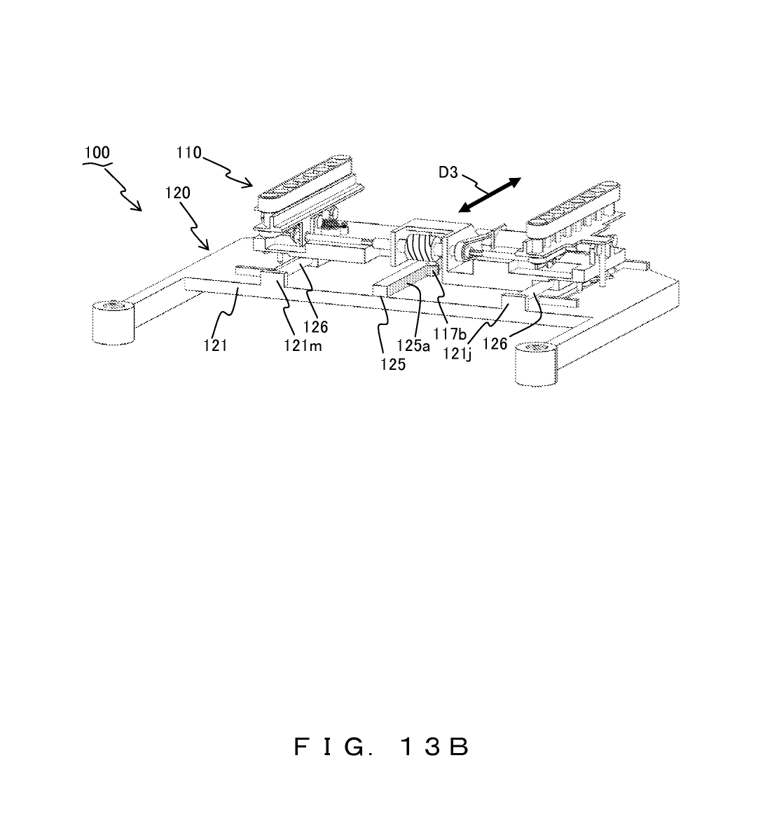

Two guide rail through-holes 113m and 113n of the hand unit base 113 are provided on the bottom face of the base main body 113a. A guide rail 126 illustrated in FIG. 13A described later is inserted into each of the two guide rail through-holes 113m and 113n. The guide rail 126 guides the hand unit 110 when the hand unit 110 shifts in the third direction (arrow D3 illustrated in FIG. 4) that is a carrying direction of the recording medium M.

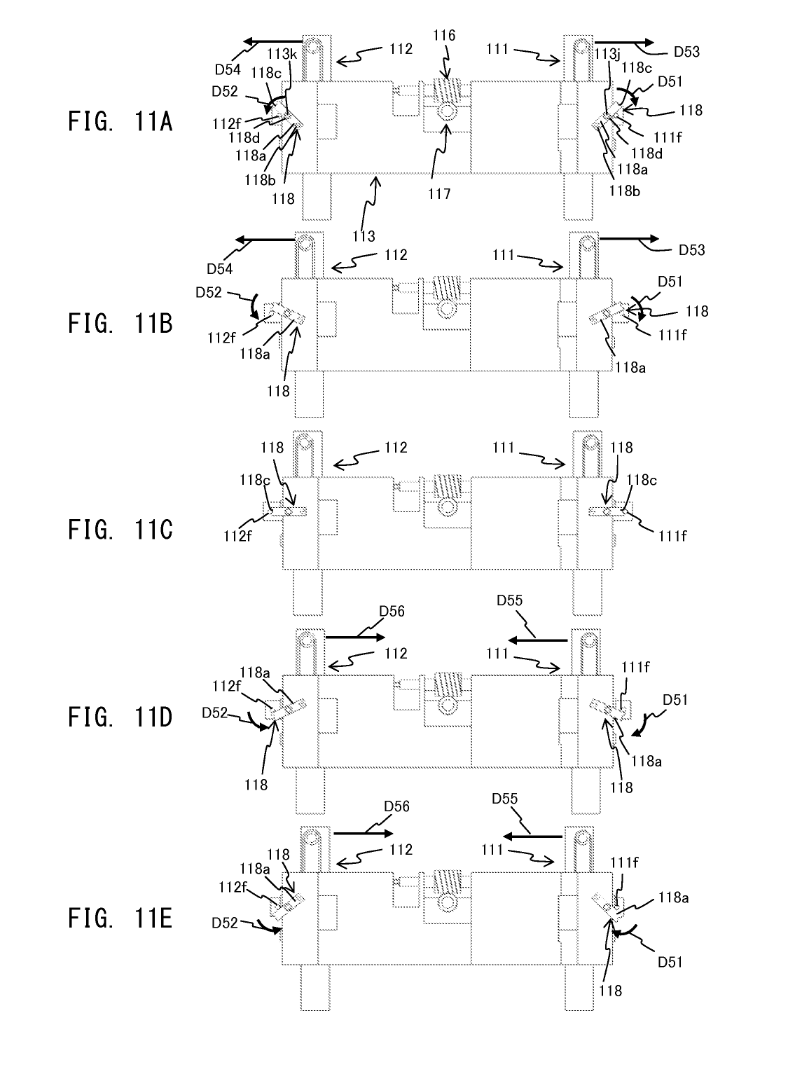

FIGS. 11A-11E are bottom plan views for explaining the movement of the hand unit arms 118.

The shifting of the hand unit 110 in the third direction (arrow D3 illustrated in FIG. 4, which is the upward and downward directions in FIGS. 11A-11E) is described later. The movements in which the first conveyer mechanism 111 and the second conveyer mechanism 112 shift in the direction in which they approach each other and in the direction in which they move apart from each other are explained here.

First, the hand unit arms 118 are rotated by the pressing of the arm pins 118b. While this is described later, the hand unit 110 shifts in the third direction to shift to each of the accommodating unit 200 side and the side opposite to it (for example, the storing unit 2 side or the drive 3 side). When the hand unit 110 reaches the accommodating unit 200 side and the side opposite to it, the arm pins 118b are pressed by protruding parts 124a and 124b of stopper arms 124 or by tray stoppers 121e, 121f, 121g, and 121h illustrated in FIG. 12A.

Accordingly, as illustrated in FIGS. 11A and 11B, the hand unit arm 118 on the first conveyer mechanism 111 side rotates in a clockwise direction in FIGS. 11A-11B (arrow D51). Meanwhile, the hand unit arm 118 on the second conveyer mechanism 112 side rotates in an anticlockwise direction in FIGS. 11A-11E (arrow D52).

Accordingly, as illustrated in FIGS. 11A and 11B, the arm bases 118a press the guide pins 111f and 112f in the direction in which the first conveyer mechanism 111 and the second conveyer mechanism 112 move apart from each other (arrows D53, D54).

By the pressing of the guide pins 111f and 112f by the arm bases 118a, the guide pins 111f and 112f are inserted into the recessed parts 118c, as illustrated in FIG. 11C. Accordingly, the relative positions of the first conveyer mechanism 111 and the second conveyer mechanism 112 are regulated against the energizing force given by the tension springs 114 to the first conveyer mechanism 111 and the second conveyer mechanism 112. Thus, the hand unit arms 118 function as an example of a regulating unit that regulates the relative positions of the first and the second conveyer mechanisms 111 and 112 against the energizing force given by the tension springs 114 (an example of the conveyer energizing mechanism) to the first and the second conveyer mechanisms 111 and 112.

As illustrated in FIGS. 11D and 11E, the hand unit arm 118 on the first conveyer mechanism 111 and the hand unit arm 118 on the second conveyer mechanism 112 further rotate (arrows D51, D52). Then, the regulation of the relative positions of the first and the second conveyer mechanisms 111 and 112 by the hand unit arms 118 are canceled. Then, the first conveyer mechanism 111 and the second conveyer mechanism 112 are energized in the direction in which they approach each other (arrows D55, D56) by the tension springs 114. An example of a canceling unit that cancels the regulation of the relative positions by the hand unit arms 118 (an example of the regulating unit) is the protruding parts 124a and 124b of the stopper arms 124, and the tray stoppers 121e, 121f, 121g, and 121h of the tray main body 121 illustrated in FIG. 12A.

FIG. 12A is an exploded perspective view illustrating a tray 120 from which the stopper arm 124 is removed.

FIG. 12B is a perspective view illustrating the tray 120.

FIG. 13A is a perspective view illustrating the transferring unit 100 from which the hand unit 110 is removed.

FIG. 13B is a perspective view illustrating the transferring unit 100.

As illustrated in FIG. 12A and FIG. 12B, the tray 120 includes a tray main body 121, a first tray arm 122, a second tray arm 123, stopper arms 124, a rack rail 125, and guide rails 126 illustrated in FIG. 13A and FIG. 13B.

They tray main body 121 assumes, for example, a rectangular plate form that extends in a horizontal direction. The tray main body 121 includes two grooves 121a and 121b, two supporting members 121c and 121d, four tray stoppers 121e, 121f, 121g, and 121h, and four guide rail supporting protrusions 121i, 121j, 121k, and 121m.

The grooves 121a and 121b extend in parallel to the third direction (arrow D3) illustrated in FIG. 13B. The grooves 121a and 121b are formed in a lower portion of the first conveyer mechanism 111 and the second conveyer mechanism 112 described above, so as to have an opening on an upper face of the tray main body 121, and they are two in number.

The supporting members 121c and 121d illustrated in FIG. 12A support the stopper arms 124 in middle through-holes 124c from the lower side. The supporting members 121c and 121d are accommodated at the center of the grooves 121a and 121b.

The four tray stoppers 121e, 121f, 121g, and 121h in total are provided on the both ends of the two grooves 121a and 121b, with one for each end. The tray stoppers 121e, 121f, 121g, and 121h press the arm pins 118b illustrated in FIG. 10A and function as an example of the canceling unit that cancels the regulation of the relative positions of the first and the second conveyer mechanisms 111 and 112, as described above.

As illustrated in FIG. 13A, the four guide rail supporting protrusions 121i, 121j, 121k, and 121m in total are provided on the both ends of the two guide rails 126, with one for each end. The guide rail supporting protrusions 121i, 121j, 121k, and 121m support the both ends of the guide rails 126.

As described above, the first and the second tray arms 122 and 123 illustrated in FIG. 12A and FIG. 12B extend so as to protrude from the tray main body 121. The first tray arm 122 and the second tray arm 123 include nut parts 122a and 123a that are penetrated by the ball screw 14b.

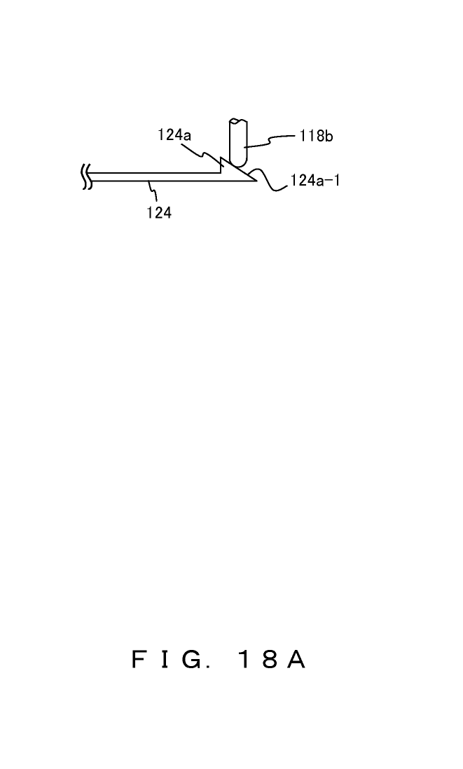

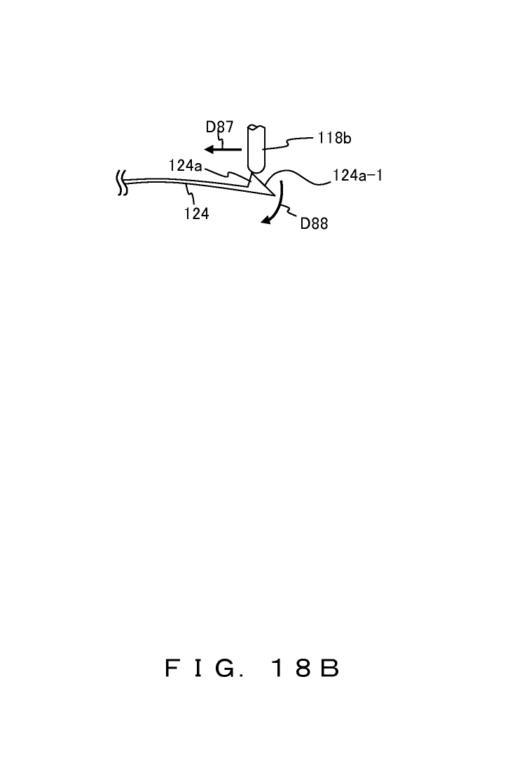

The two stopper arms 124 are placed along the grooves 121a and 121b, respectively. The longitudinal direction of the stopper arm 124 is parallel to the third direction (arrow D3). The protruding parts 124a and 124b that protrude upward are formed on the both ends of the stopper arm 124. These protruding parts 124a and 124b also function as an example of the canceling unit, as well as the tray stoppers 121e, 121f, 121g, and 121h. The stopper arm 124 bends with the middle through-hole 124c as a fulcrum, so that the protruding parts 124a and 124b move downward (arrow D88) as illustrated in FIG. 18A and FIG. 18B descried later.

As illustrated in FIG. 13A and FIG. 13B, the rack rail 125 is provided over the third direction (arrow D3) illustrated in FIG. 13B at the center of the tray main body 121. A rack tooth 125a is formed on one of the lateral sides of the rack rail 125. As mentioned above, the rack tooth 125a mesh with the gear 117b illustrated in FIG. 8A. Accordingly, the hand unit 110 shifts in the third direction (arrow D3) with respect to the tray 120.

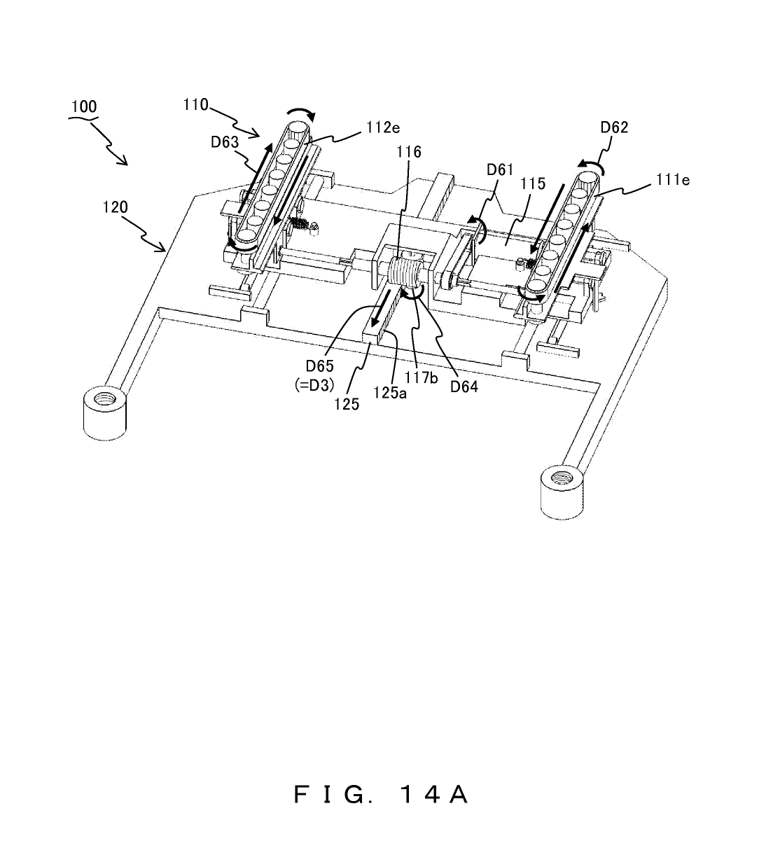

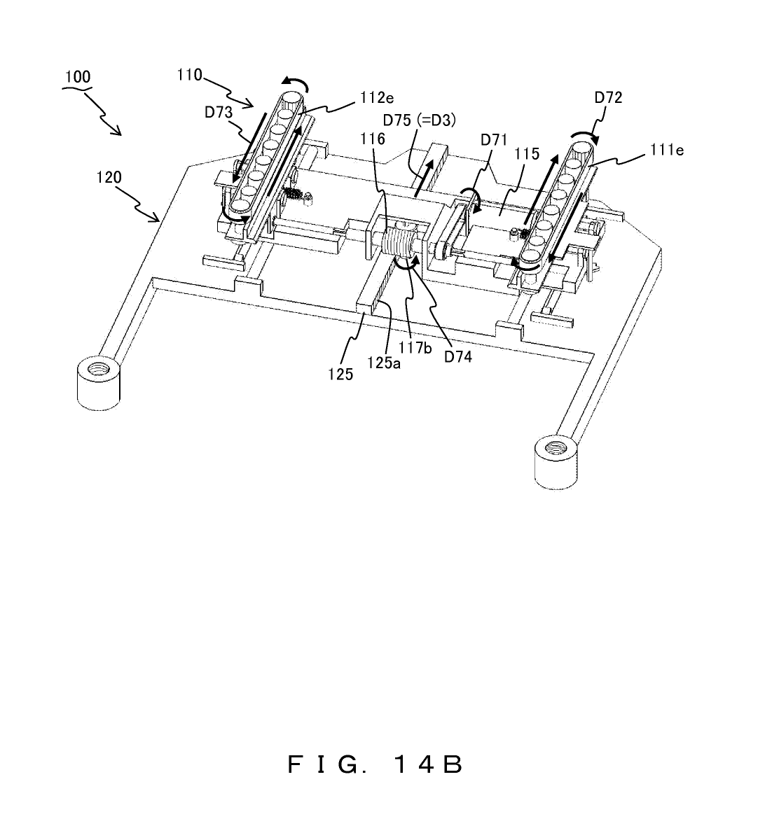

FIG. 14A and FIG. 14B are perspective views for explaining the shifting of the hand unit 110 in the third direction.

As described above, by the driving power (arrow D61) of the first driving source 115 illustrated in FIG. 14A, the first driving mechanism 116 makes the carrying belts 111e and 112e rotate (arrows D62, D63). Accordingly, the recording medium M is carried in the third direction (arrow D3, D65).

In addition, by the transmission of the driving power generated by the first driving source 115 to the second driving mechanism 117 through the first driving mechanism 116, the gear 117b of the second driving mechanism 117 is rotated (arrow D64). Accordingly, the hand unit 110 shifts in third direction (arrow D3, D65) along the rack tooth 125a that meshes with the gear 117b. Therefore, the recording medium M is transferred in the third direction (arrow D3, D65) by both the actions of the carrying belts 111e and 112e and the shifting of the hand unit 110.

A case in which the recording medium M is transferred in the opposite direction is similar, and as illustrated in FIG. 14B, the carrying belts 111e and 112e are rotated (arrows D72, D73) by the driving power (arrow D71) of the first driving source 115. Accordingly, the recording medium M is carried in the third direction (an D3, D75). In addition, the gear 117b of the second driving mechanism 117 is rotated (arrow D74), by the transmission of the driving power generated by the first driving source 115 to the second driving mechanism 117 through the first driving mechanism 116. Accordingly, the hand unit 110 shifts in a direction (arrow D3, D75) that is opposite to the third direction, along the rack tooth 125a that meshes with the gear 117b.

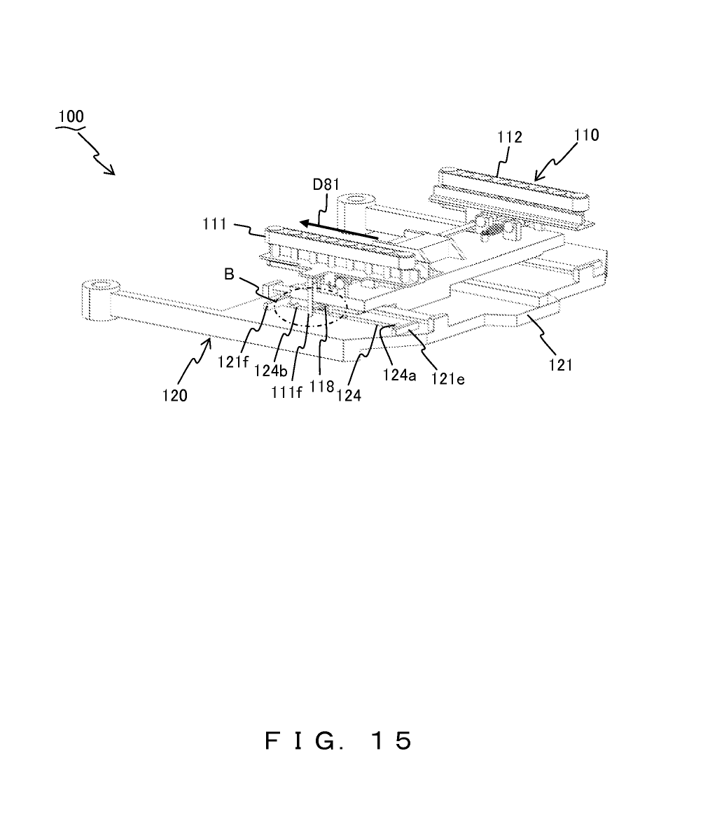

FIG. 15 is a perspective view illustrating the transferring unit 100 in which the hand unit 110 is in an initial state.

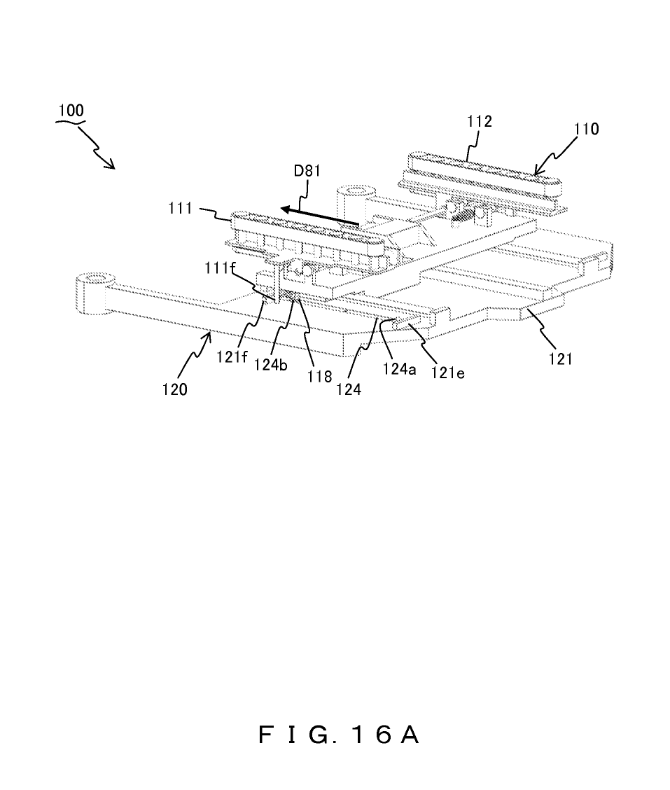

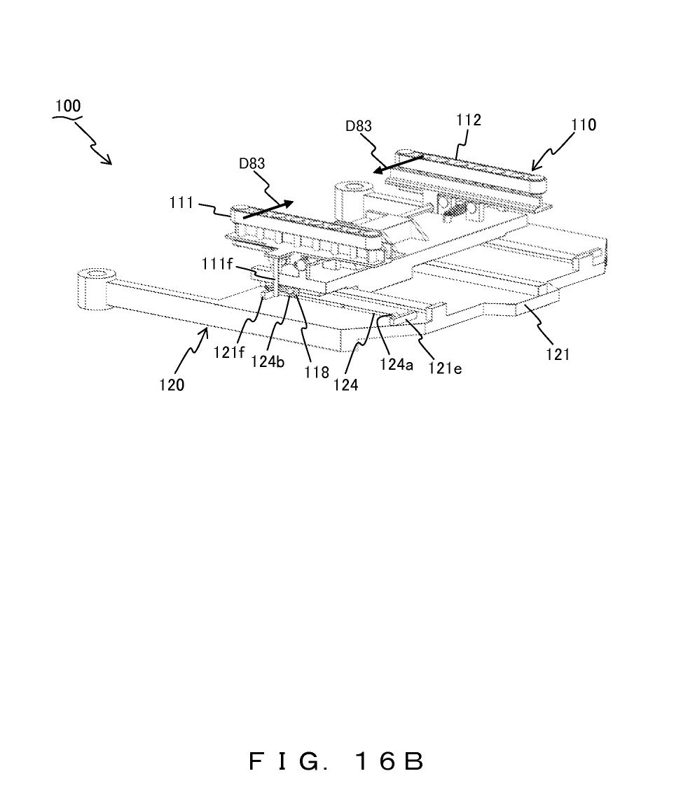

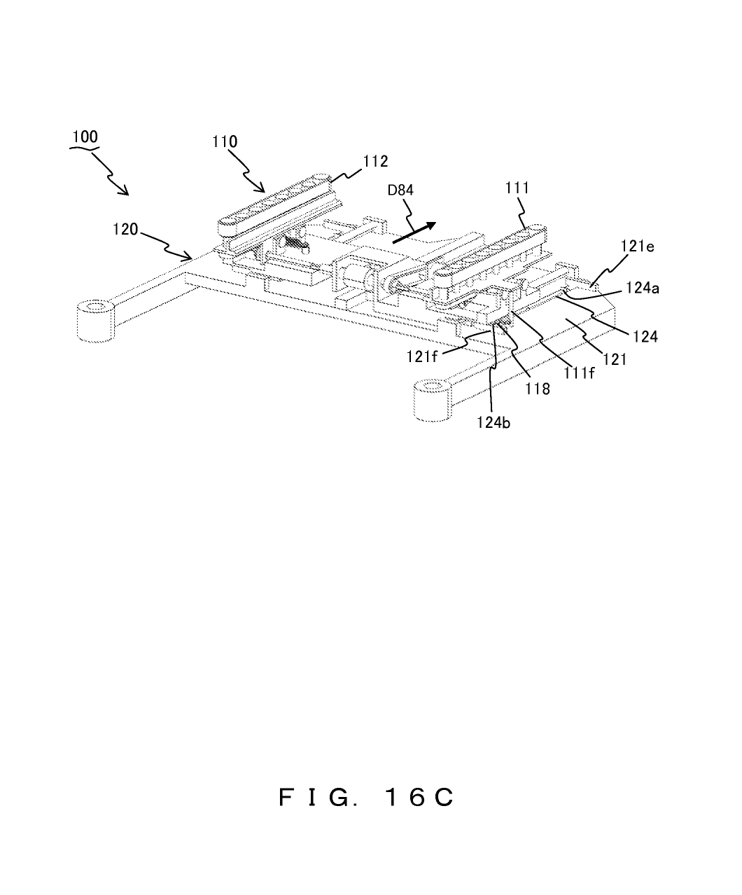

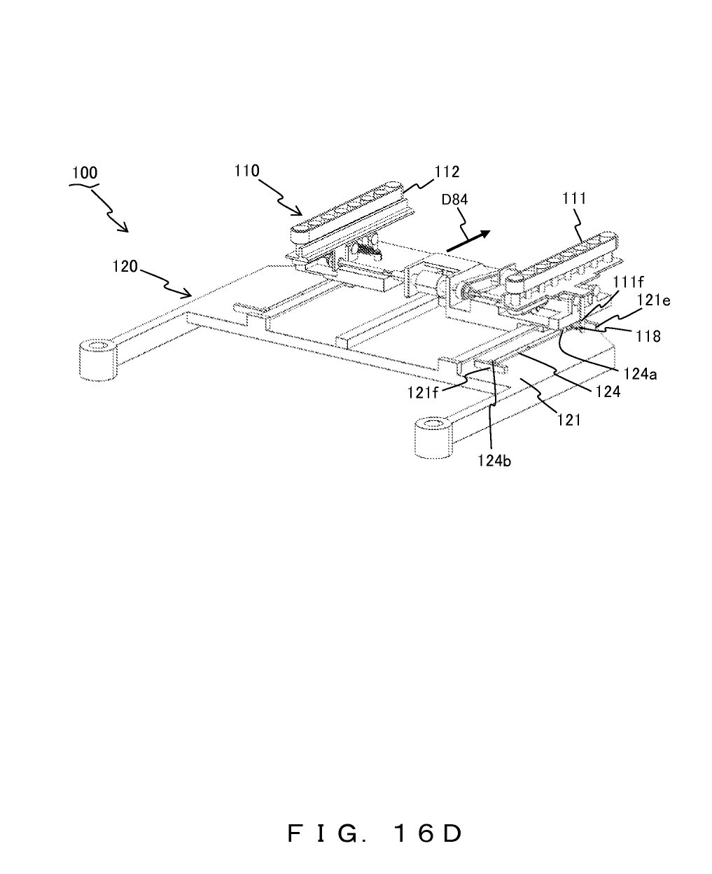

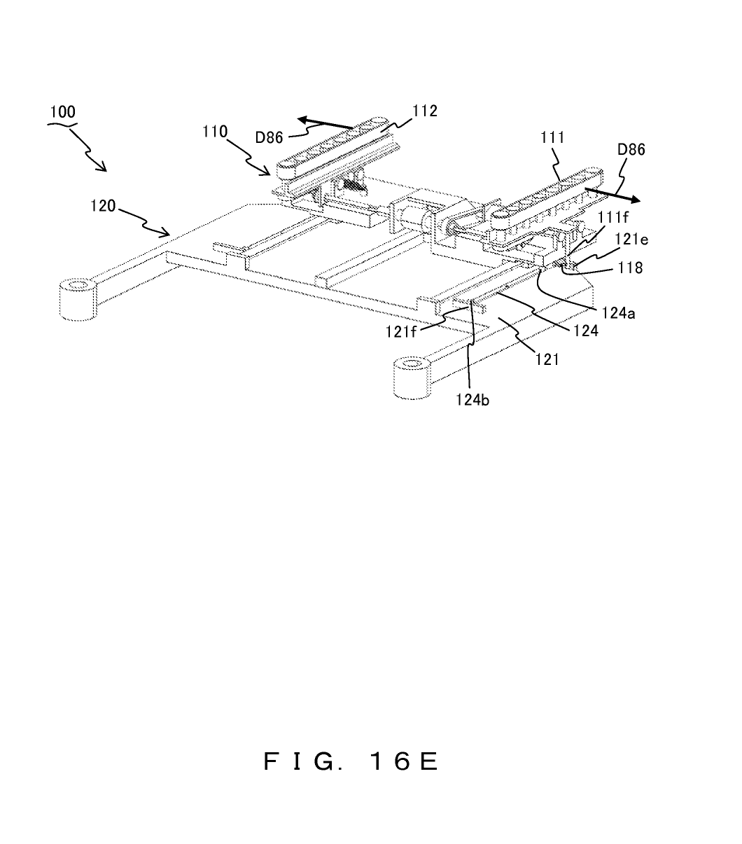

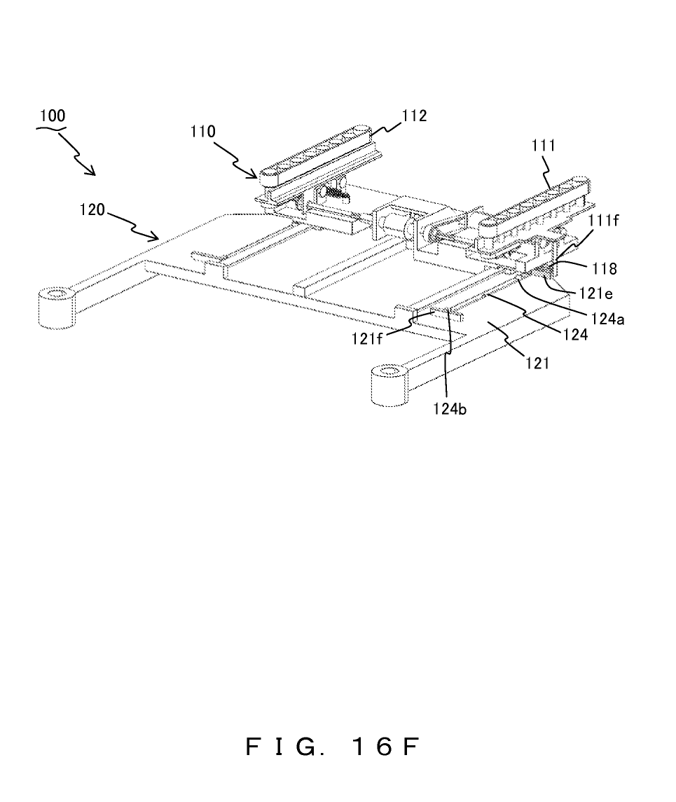

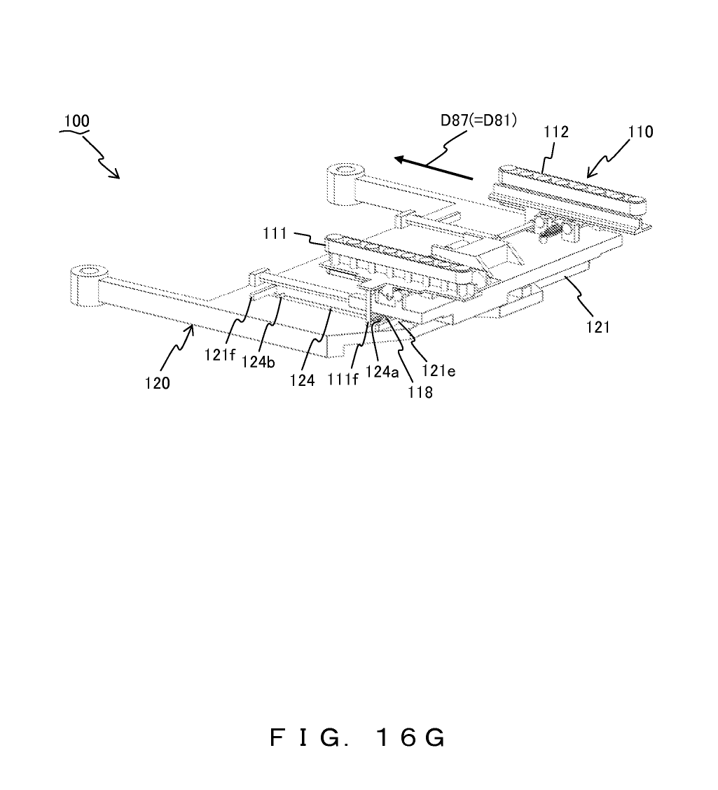

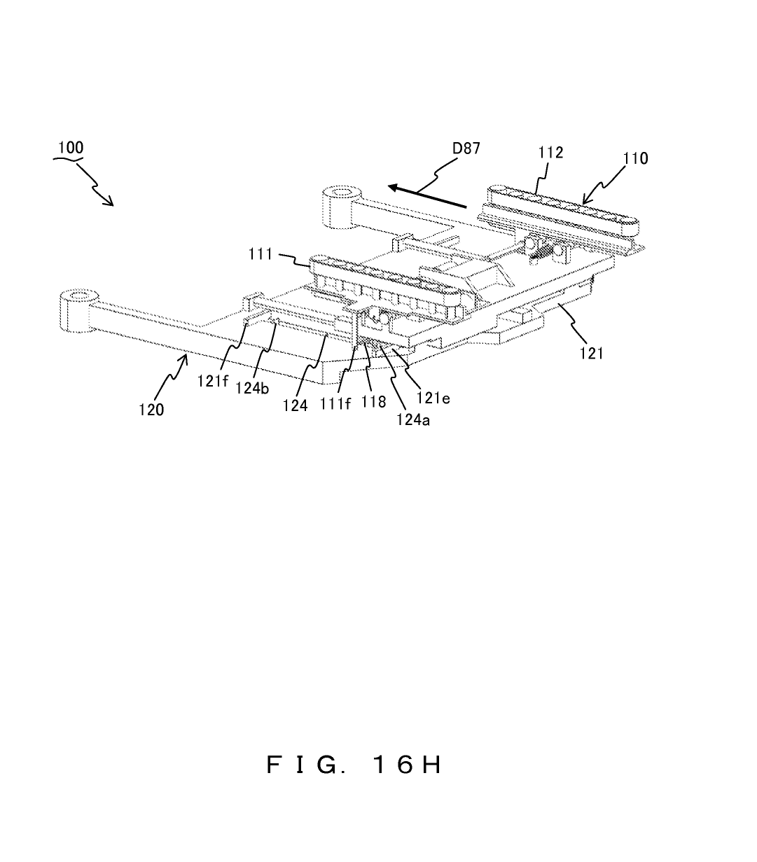

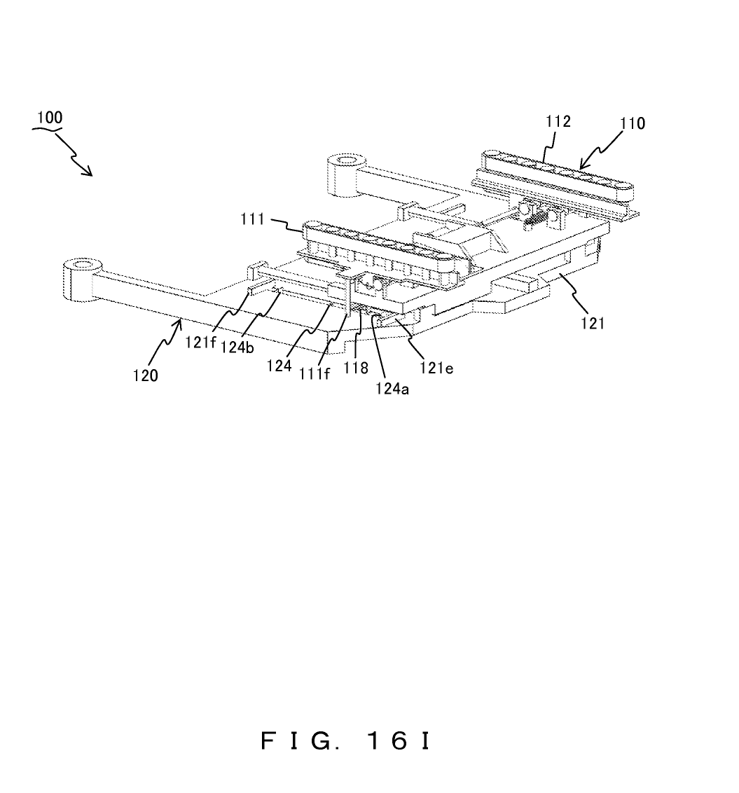

FIG. 16A through FIG. 16I are perspective views for explaining the movement of the hand unit 110.

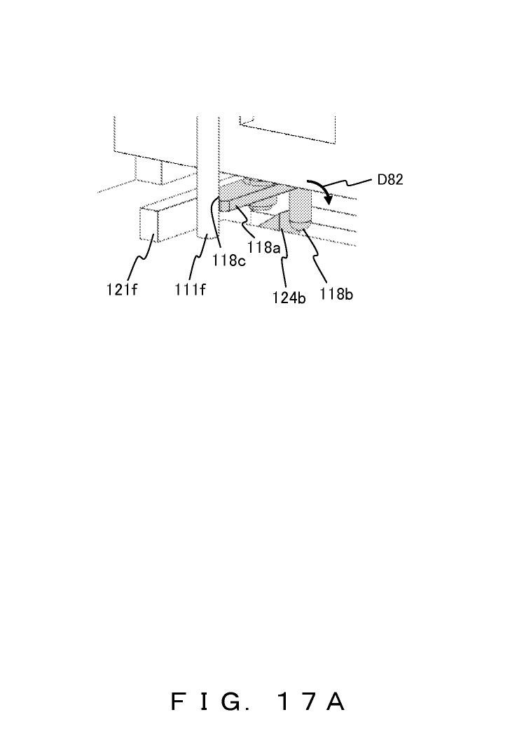

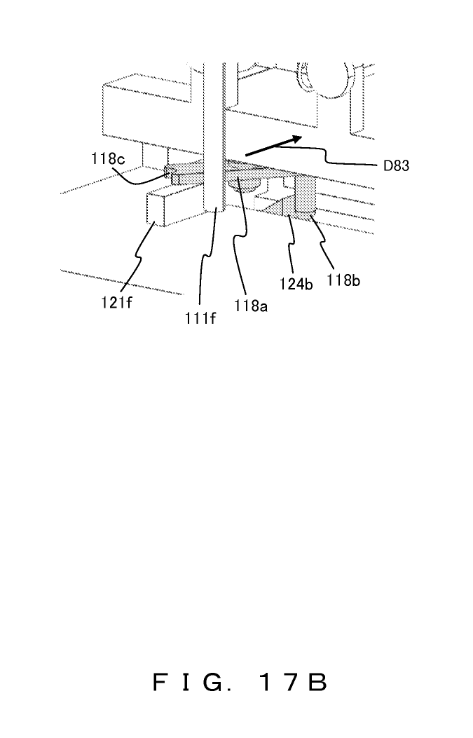

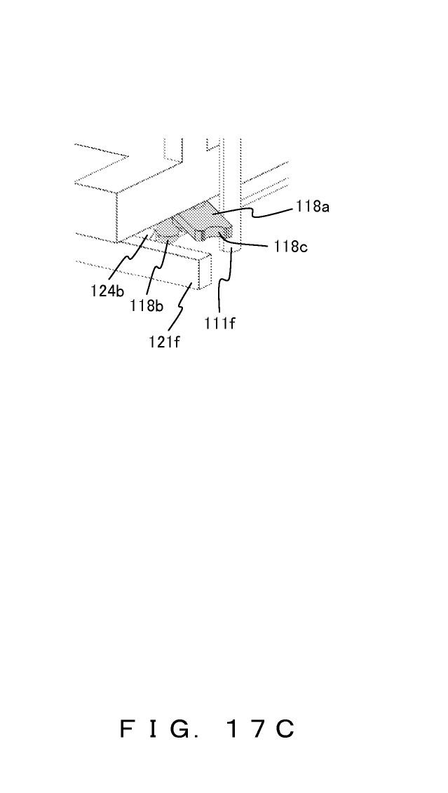

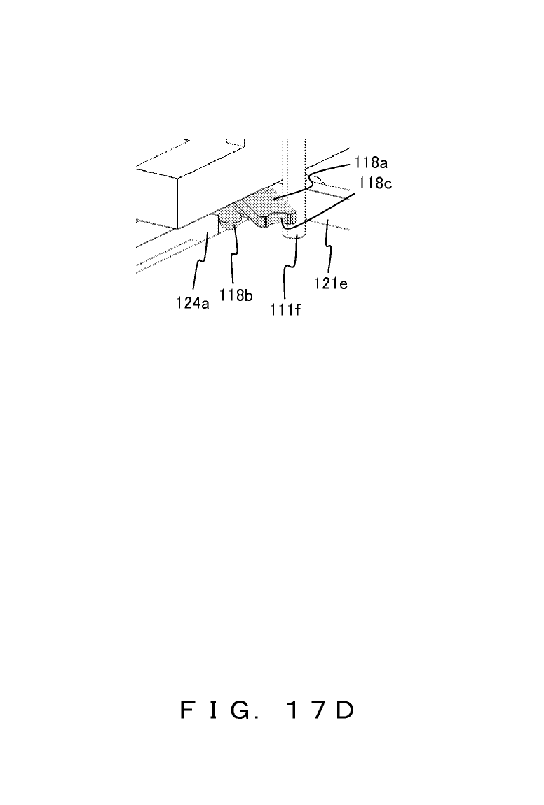

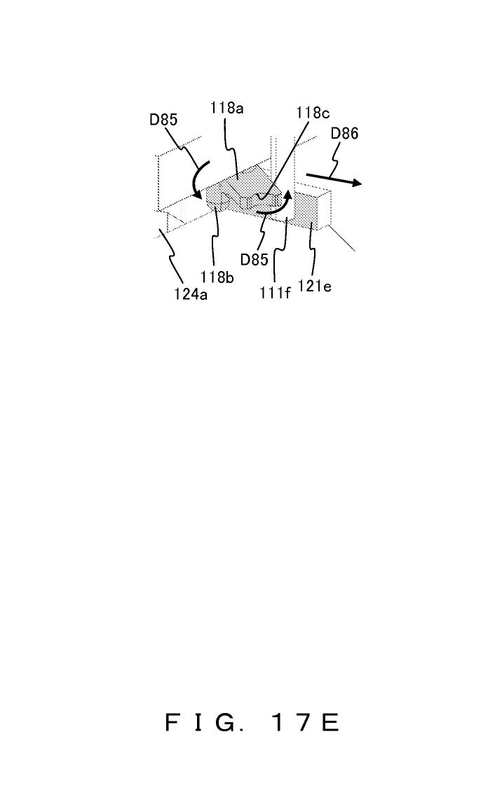

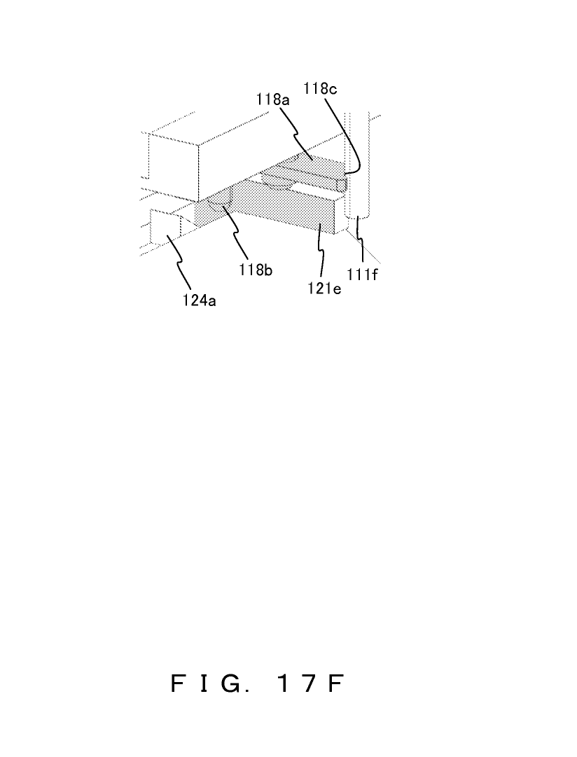

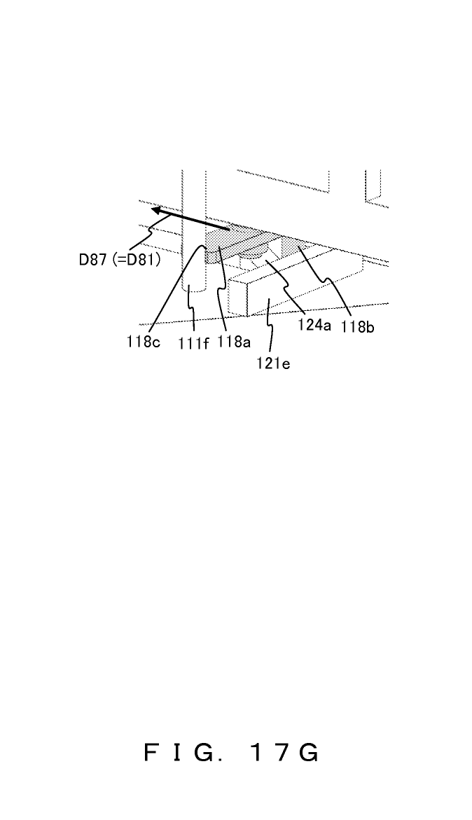

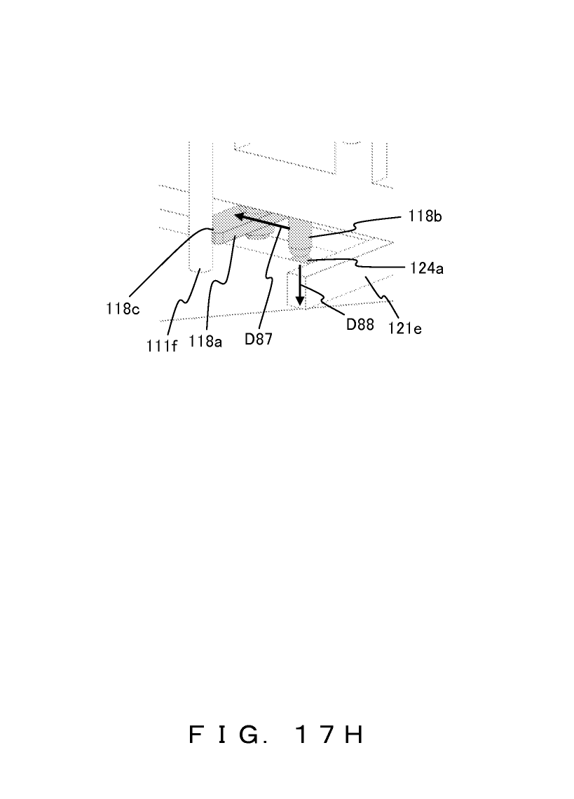

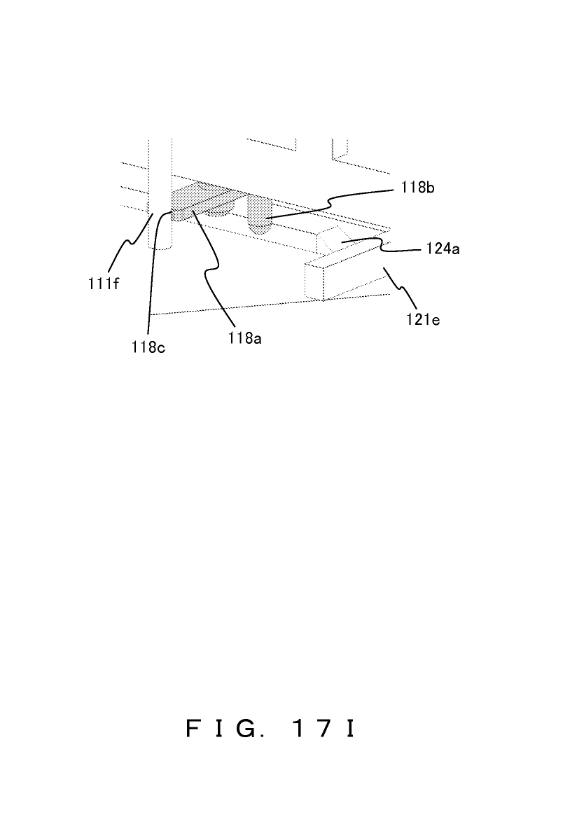

FIG. 17A through FIG. 17I are perspective views for explaining the movement in a portion B (the hand unit arm 118 and the guide pin 111f) in FIG. 15.

First, the hand unit 110 in an initial state illustrated in FIG. 15 shifts to the accommodating unit 200 (see FIG. 3A and FIG. 3B) side as illustrated in FIG. 16A (arrow D81). This shifting direction (arrow D81) is the third direction mentioned above, while this is not illustrated in the drawing. At this time, as illustrated in FIG. 17A, the hand unit arm 118 is in a state in which the guide pin 111f is inserted into the recessed part 118c (a state in which the relative positions of the first and the second conveyer mechanisms 111 and 112 are regulated, that is, a non-holding state in which they are apart from each other). The arm pin 118b abuts on the protruding part 124b of the stopper arm 124 and it is pressed by the protruding part 124b. Accordingly, the hand unit arm 118 is rotated (arrow D82).

When the guide pin 111f is disengaged from the recessed part 118c of the hand unit arm 118 as illustrated in FIG. 17B, the first and the second conveyer mechanisms 111 and 112 are moved to approach each other (arrow D83) as illustrated in FIG. 16B, by the tension springs 114 illustrated in FIG. 7A. While details are described later, at this time, the first conveyer mechanism 111 and the second conveyer mechanism 112 approach each other and hold the recording medium M in the accommodating unit 200 therebetween.

Next, as illustrated in FIG. 16C, the hand unit 110 shifts to the storing unit 2 (see FIG. 1) side that is in the opposite direction (arrow D84). This shifting direction (arrow D84) is also the third direction mentioned above, while this is not illustrated in the drawing. At this time, as illustrated in FIG. 17C, the arm base 118a abuts on the guide pin 111f.

As illustrated in FIG. 16D, while the hand unit 110 is shifting (arrow D84), the guide pin 111f is not inserted in the recessed part 118c (a state in which the regulation of the relative positions of the first and the second conveyer mechanisms 111 and 112 is canceled). In this state, as illustrated in FIG. 17D, the arm pin 118b passes through without abutting on the protruding part 124a of the stopper arm 124, because the arm pin 118b has rotated as described above (arrow D82).

After that, as illustrated in FIG. 17E, the arm pin 118b abuts on the tray stopper 121e, thereby making the hand unit arm 118 rotate (arrow D85). Accordingly, the arm base 118a presses the guide pin 111f. Accordingly, as illustrated in FIG. 16E, the first and the second conveyer mechanisms 111 and 112 move apart from each other (arrow D86).

Then, when the longitudinal direction of the arm base 118a becomes parallel to the moving-apart direction (arrow D86) mentioned above, the guide pin 111f is held in a state in which it is inserted into the recessed part 118c, as lustrated in FIG. 16F and FIG. 17F. This state is the state in which the relative positions of the first and the second conveyer mechanisms 111 and 112 are regulated (the non-holding state), as described above. While details are described later, at this time, the recording media Min the accommodating unit 200 is stored into the storing unit 2.

The hand unit 110 shifts again to the accommodating unit 200 side as illustrated in FIG. 16G and FIG. 17G (arrow D87=D81).

As illustrated in FIG. 16H and FIG. 17H, the hand unit arm 118 is in a state in which the relative positions are regulated (the non-holding state) in a manner similar to the manner illustrated in FIG. 17A, and it abuts on an abutting part 124a. However, a guide surface 124a−1 that is for example slanted is formed on the protruding part 124a as illustrated in FIG. 18A and FIG. 18B, so as to facilitate climbing over from an outer side of the stopper arm 124 (the right-hand side in (FIG. 18A and FIG. 18B). It is preferable that this guide surface 124a−1 is provided on the protruding part 124b on the other side as well.

The protruding part 124a bends downward (arrow D88) by abutting on the arm pin 118b. For this reason, the hand unit arm 118 does not rotate when it abuts on the protruding part 124a, and as illustrated in FIG. 16I and FIG. 17I, it is maintained in the state in which the relative positions are regulated (the non-holding state). Meanwhile, the state of the hand unit 110 illustrated in FIG. 16I and FIG. 17I is the initial state illustrated in FIG. 15. When the hand unit 110 shifts not to the accommodating unit 200 side but to the storing unit 2 side for the first time, movements are similar to the movements illustrated in FIG. 16A through FIG. 16I and FIG. 17A through FIG. 17I. In this case, the arm pin 118b first abuts not on the protruding part 124b but on the other protruding part 124a first.

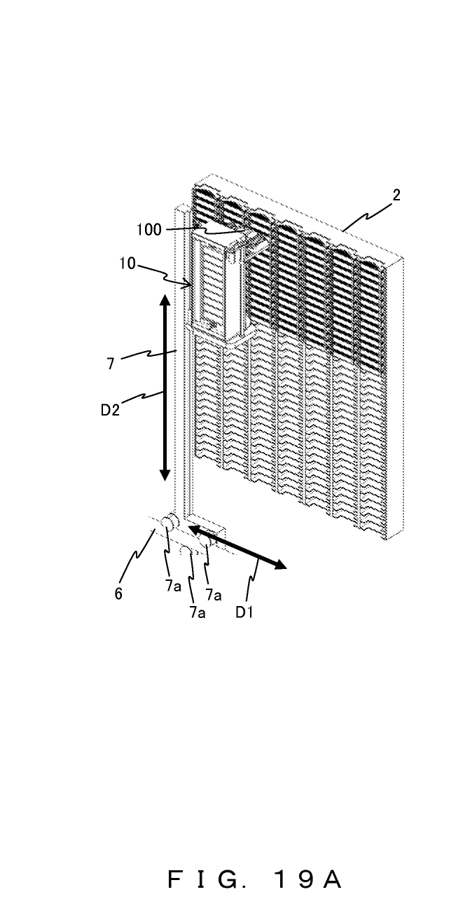

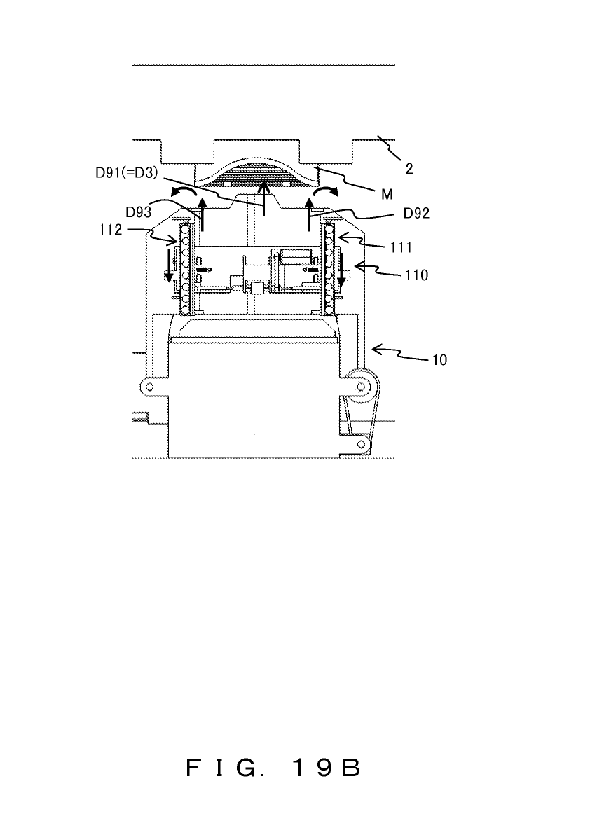

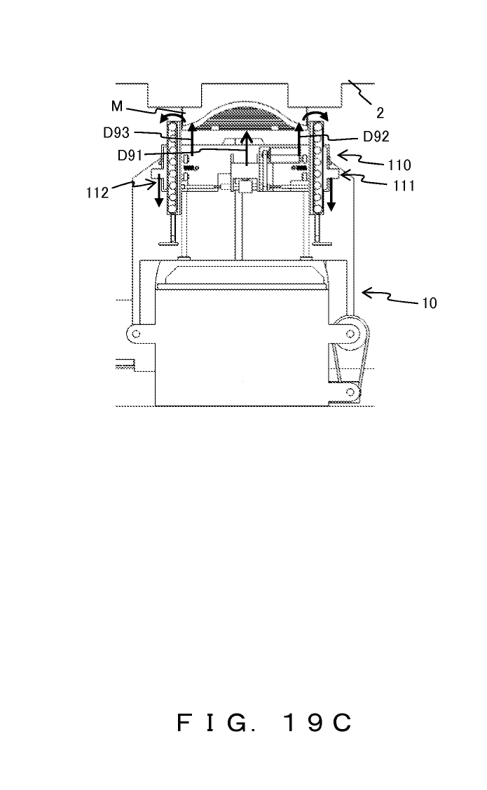

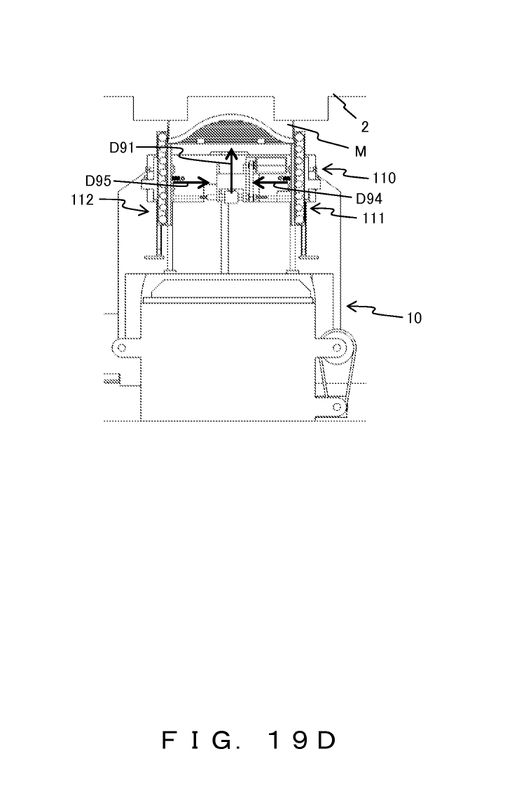

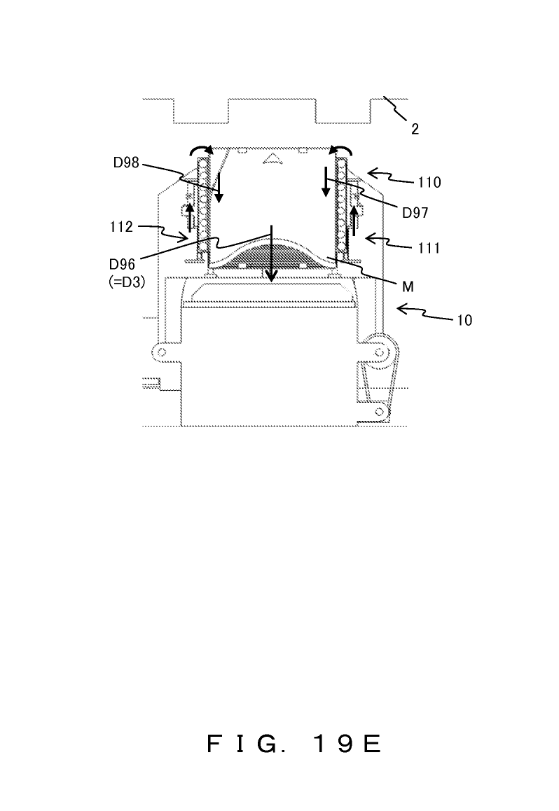

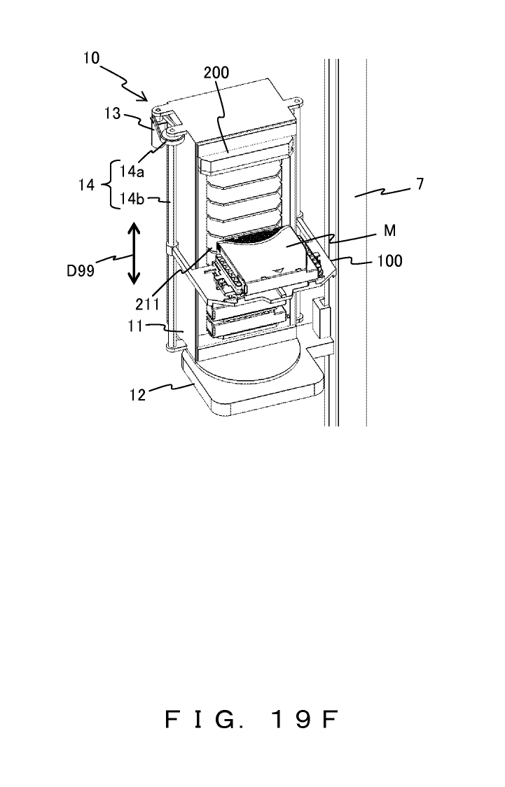

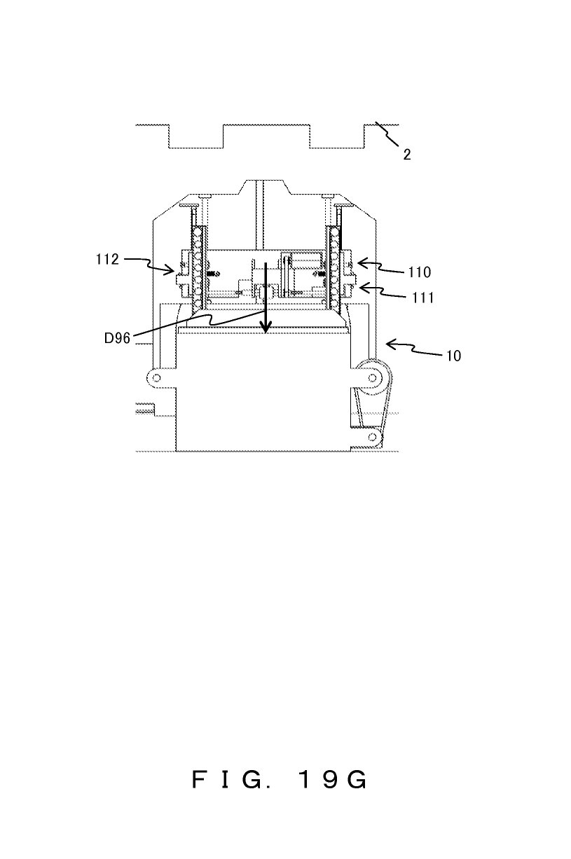

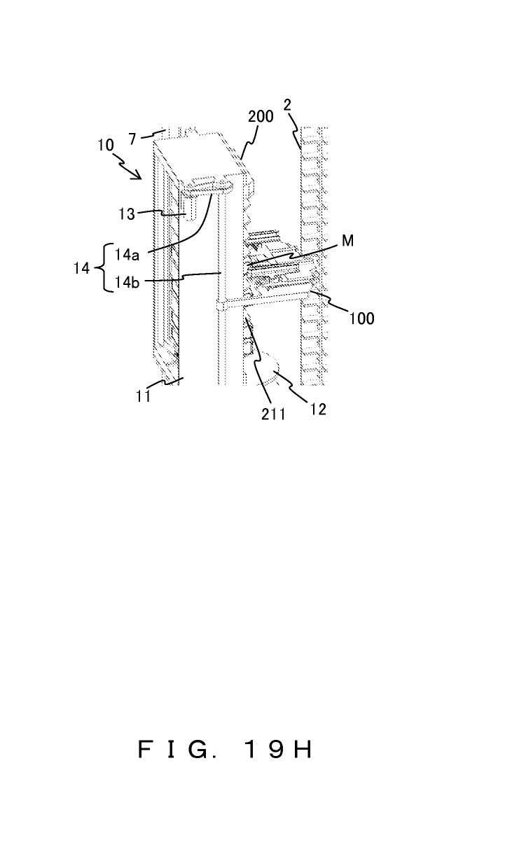

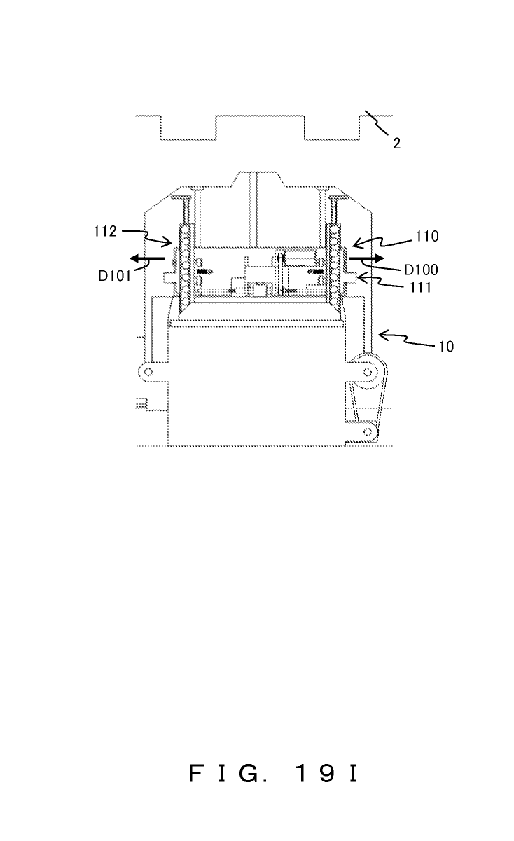

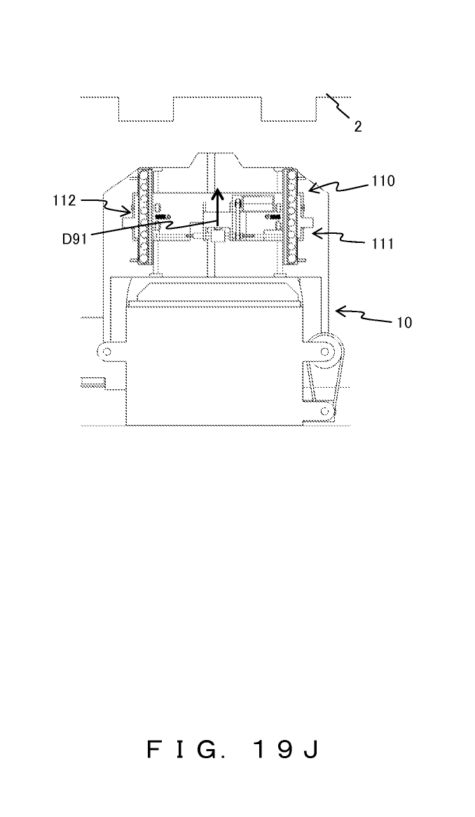

FIG. 19A through FIG. 19J are explanatory diagrams for explaining the transfer of the recording medium M from the storing unit 2 to the accommodating unit 200.

The transporting unit 10 illustrated in FIG. 19A shifts in the second direction (arrow D2) along the second-direction guide 7, as described above. In addition, by the shifting of the second-direction guide 7 in the first direction (arrow D1) along the first-direction guide 6, the transporting unit 10 is also shifted in the first direction (arrow D1). The transporting unit 10 is able to shift so as to face a specified storage position in the storing unit 2, by shifting in the first direction (arrow D1) and in the second direction (arrow D2).

As illustrated in FIG. 19B, the hand unit 110 shifts to the storing unit 2 side (arrow D91) that is the same direction as the third direction (arrow D3) mentioned above. At this time, the first and the second conveyer mechanisms 111 and 112 are in the non-holding state in which they are not holding any recording medium M therebetween (the state in which their relative positions are regulated). However, the first and the second conveyer mechanisms 111 and 112 operate as if they are carrying the recording medium M (arrows D92, D93) in the third direction (arrow D3), in tandem with the shifting action of the hand unit 110.

As illustrated in FIG. 19C, the first and the second conveyer mechanisms 111 and 112 shift to a position at which they are able to hold the recording medium M. At this position, the regulation of the relative positions of the first and the second conveyer mechanisms 111 and 112 is canceled as described above. Then, as illustrated in FIG. 19D, the first and the second conveyer mechanisms 111 and 112 approach each other and hold the recording medium M therebetween (arrows D94, D95).

After that, as illustrated in FIG. 19E, the first and the second conveyer mechanisms 111 and 112 shift to the accommodating unit 200 side (arrow D96) that is in the opposite direction. This shifting direction (arrow D96) is also the third direction mentioned above. The first and the second conveyer mechanisms 111 and 112 operate so as to carry the recording medium M to the accommodating unit 200 side (arrows D97, D98), simultaneously with the shifting action of the hand unit 110.

As illustrated in FIG. 19F, when the recording medium M is positioned at the center of the tray 120 (the tray main body 121), the carrying of the recording medium M stops, and the third driving mechanism 14 makes the transferring unit 100 shift upward and downward (arrow D99). The third driving mechanism 14 makes the transferring unit 100 shift so as to face a prescribed area (an area partitioned by the partition plates 211 for example) in the accommodating unit 200.

Then again, as illustrated in FIG. 19G, the first and the second conveyer mechanisms 111 and 112 shift to the accommodating unit 200 side, and they also carry the recording medium M (arrow D96). After that, as illustrated in FIG. 19H, the recording medium M is transferred to the accommodating unit 200 side, and the relative positions of the first and the second conveyer mechanisms 111 and 112 are regulated as described above.

Accordingly, as illustrated in FIG. 19I, the first and the second conveyer mechanisms 111 and 112 move apart from each other (arrows D100, D101). Therefore, the recording medium M is released from the holding by the first and the second conveyer mechanisms 111 and 112, and it is accommodated into the accommodating unit 200.

After that, as illustrated in FIG. 19J, the hand unit 110 shifts again to the storing unit 2 side (arrow D91), and it returns to the state illustrated in FIG. 19B.

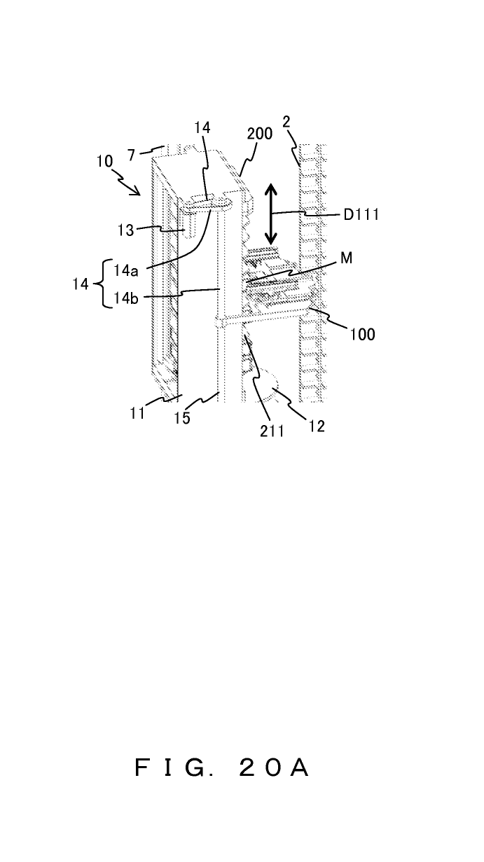

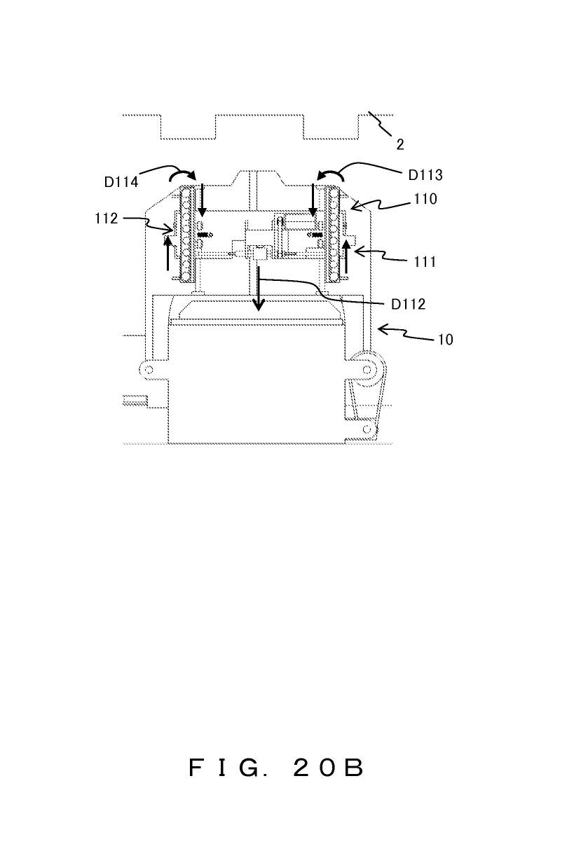

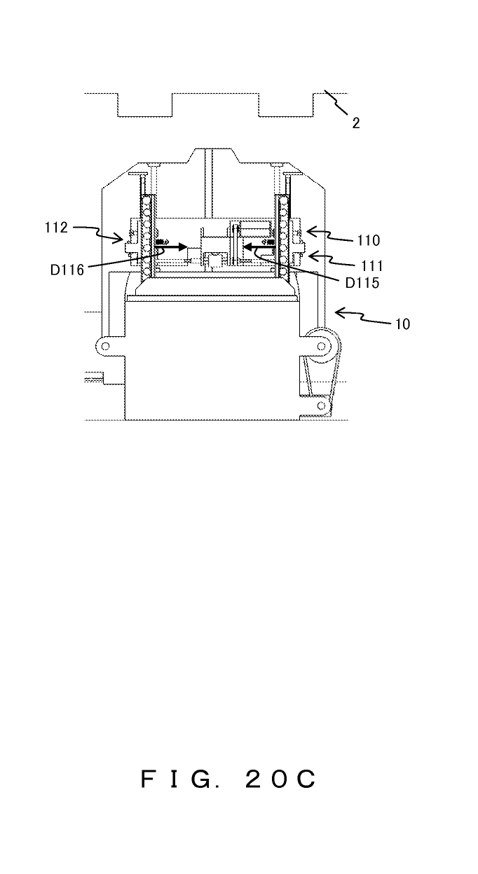

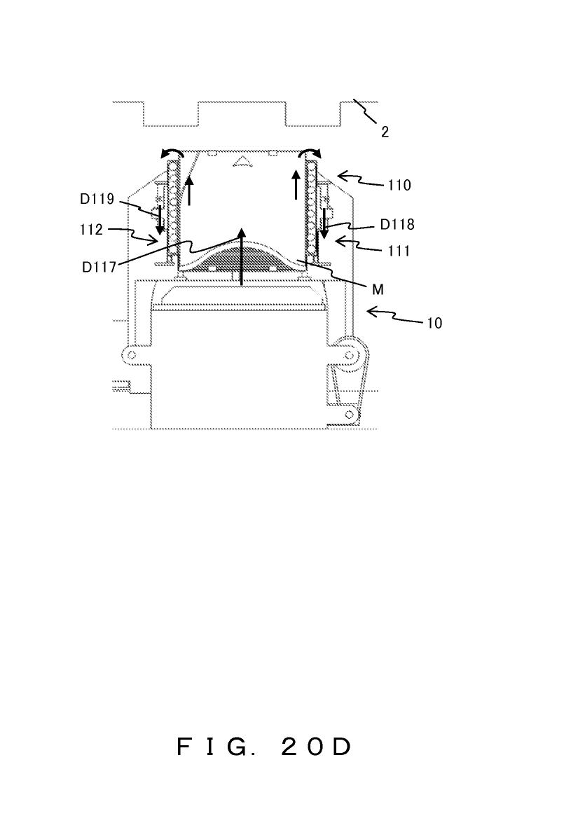

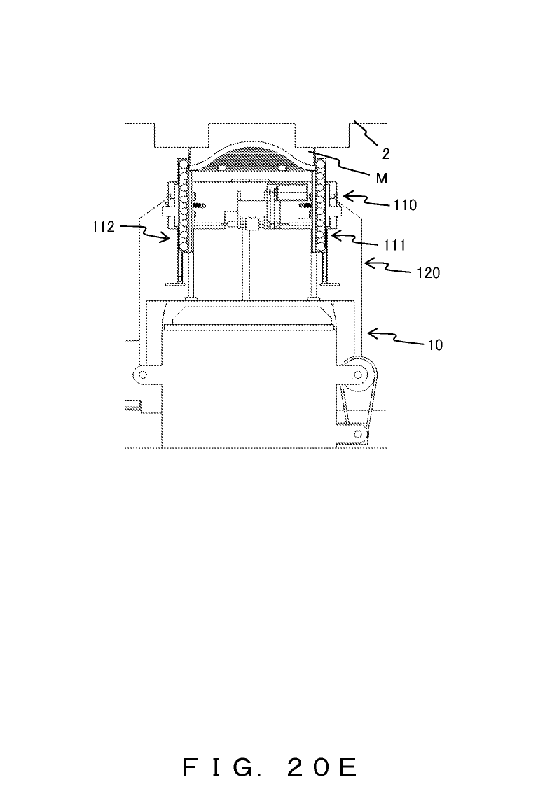

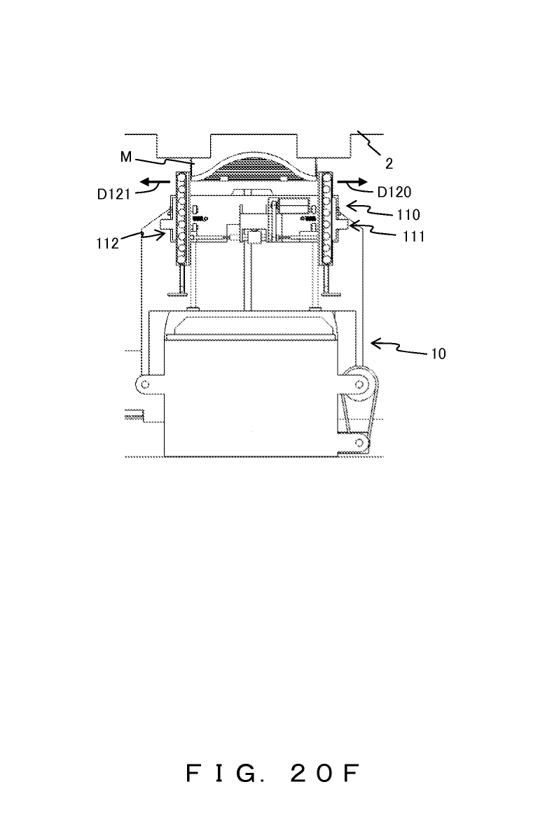

FIG. 20A through FIG. 20F are explanatory diagrams for explaining the transfer of the recording medium M from the accommodating unit 200 to the storing unit 2.

The transferring unit 100 illustrated in FIG. 20A is shifted upward and downward (arrow D111) by the driving power of the third driving mechanism 14. The third driving mechanism 14 makes the transferring unit 100 shift so as to face a prescribed slot in the accommodating unit 200.

Next, as illustrated in FIG. 20B, the hand unit 110 shifts to the accommodating unit 200 side (arrow D112). At this time, the first and the second conveyer mechanisms 111 and 112 are in the non-holding state in which they are not holding any recording medium M (the state in which their relative positions are regulated). However, the first and the second conveyer mechanisms 111 and 112 operate as if they are carrying the recording medium M (arrows D113, D114), in tandem with the shifting action of the hand unit 110.

As illustrated in FIG. 20C, the first and the second conveyer mechanisms 111 and 112 shift to a position at which they are able to hold the recording medium M. Then, the regulation of the relative positions of the first and the second conveyer mechanisms 111 and 112 is canceled as described above, and the first and the second conveyer mechanisms 111 and 112 approach each other to hold the recording medium M therebetween (arrows D115, D116).

After that, as illustrated in FIG. 20D, the first and the second conveyer mechanisms 111 and 112 shift to the storing unit 2 side (arrow D117) that is in the opposite direction. This shifting direction (arrow D117) is also the third direction mentioned above. The first and the second conveyer mechanisms 111 and 112 operate so as to carry the recording medium M to the storing unit 2 side (arrows D118, D119) simultaneously with the shifting action of the hand unit 110.

When the recording medium M is transferred to the storing unit 2 side as illustrated in FIG. 20E, the relative positions of the first and the second conveyer mechanisms 111 and 112 are regulated as described above.

Accordingly, as illustrated in FIG. 20F, the first and the second conveyer mechanisms 111 and 112 move apart from each other (arrows D120, D121). Then, the recording medium M is released from the holding by the first and the second conveyer mechanisms 111 and 112, and it is stored into the storing unit 2.

While the recording medium M is transferred from the accommodating unit 200 to the storing unit 2 in FIG. 20A through FIG. 20F, the recording medium M may also be transferred to a different storage position in the accommodating unit 200.

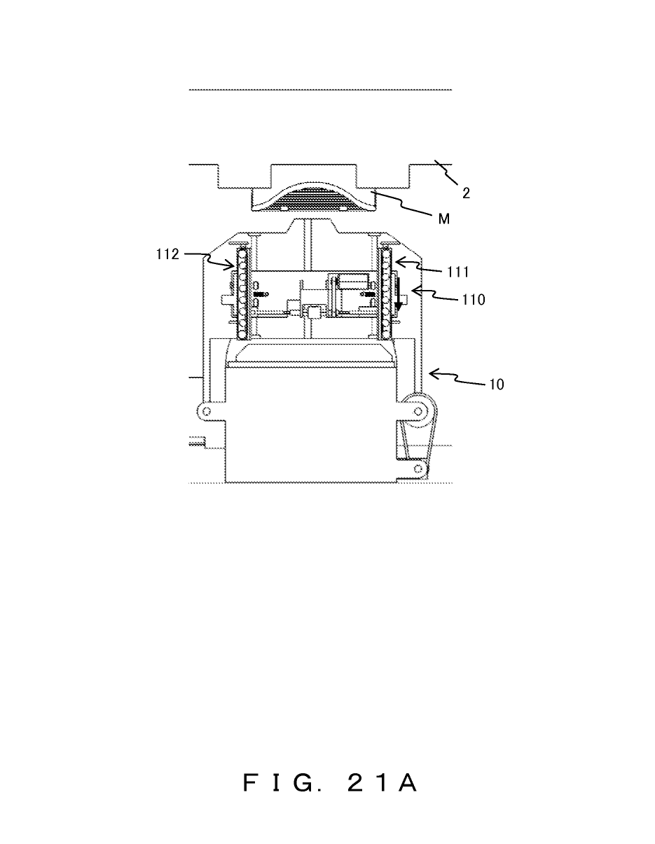

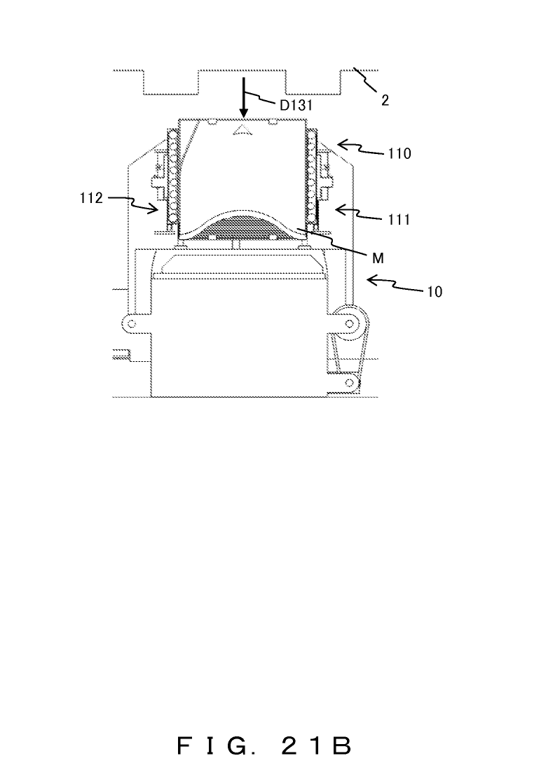

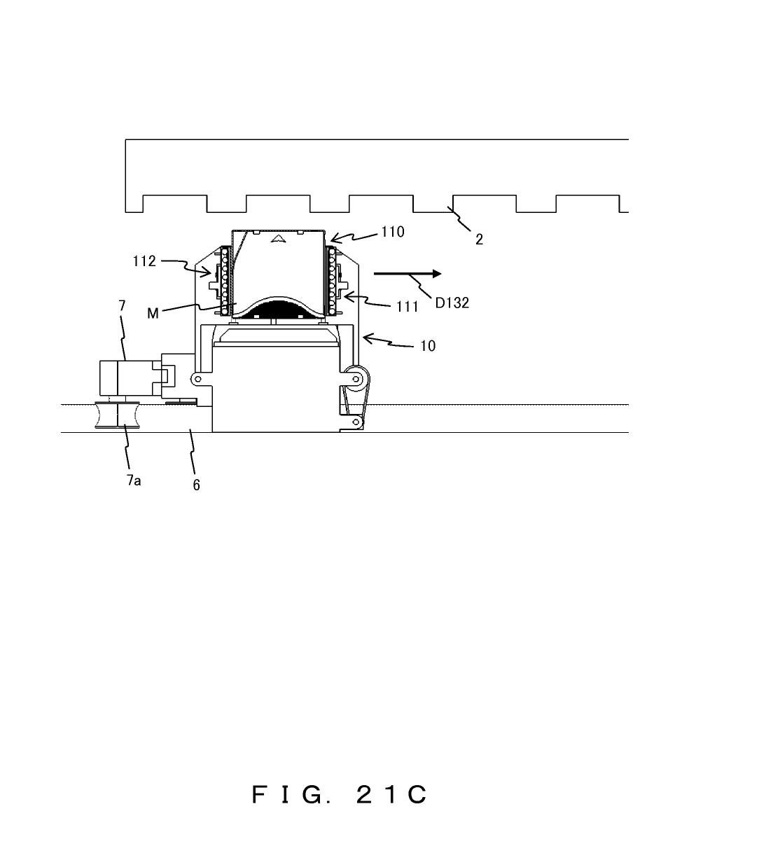

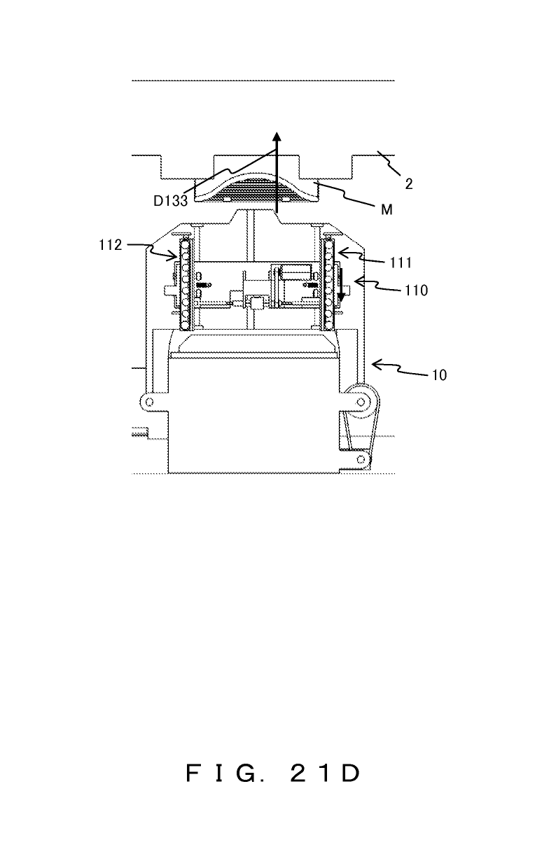

FIG. 21A through FIG. 21D are explanatory diagrams for explaining the transportation of only one recording medium.

As illustrated in FIG. 21A, the transporting unit 10 shifts so as to face a specified storage position in the storing unit 2.

Next, as illustrated in FIG. 21B, the first and the second conveyer mechanisms 111 and 112 transfer the recording medium M onto the tray 120 (arrow D131).

After that, as illustrated in FIG. 21C, the transporting unit 10 shifts to a specified storage position in the storing unit 2 (arrow D132). Then, as illustrated in FIG. 21D, the transporting unit 10 transfers the recording medium M to the storing unit 2 (arrow D133). While the transporting unit 10 transports the recording medium M to the storing unit 2 in FIG. 21D, it may also transport only one recording medium M to the drive 3.

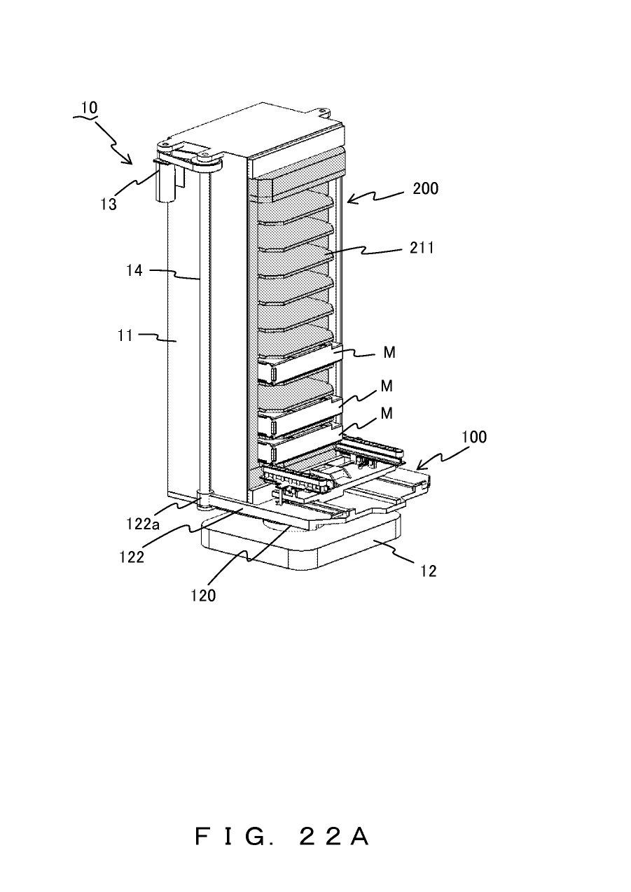

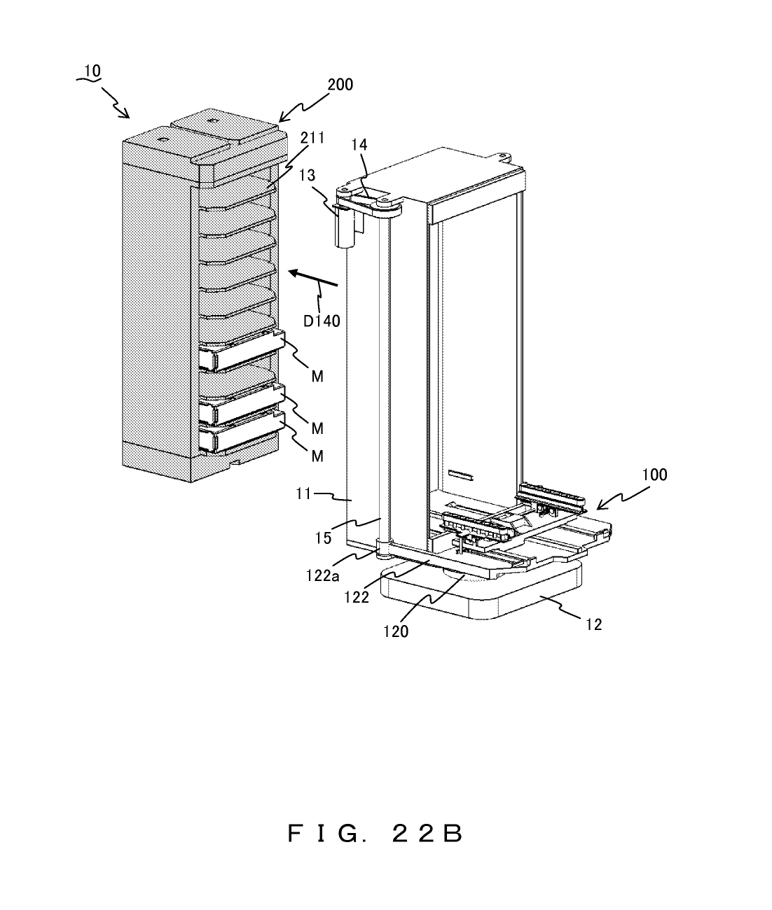

FIG. 22A is a perspective view illustrating the transporting unit 10.

FIG. 22B is a perspective view illustrating the transporting unit 10 from which the accommodating unit 200 is removed.

As illustrated in FIG. 22A and FIG. 22B, the accommodating unit 200 may be removed from the back face side of the frame 11 (arrow D140). In addition, in the opposite manner, the accommodating unit 200 may be attached to the frame 11 from its back face side. Thus, the accommodating unit 200 is detachable with respect to the transporting unit 10.

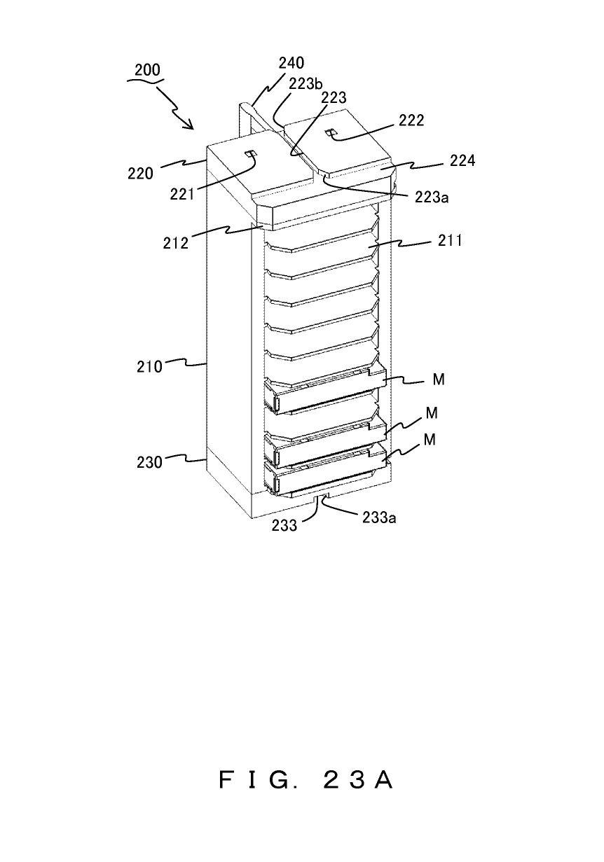

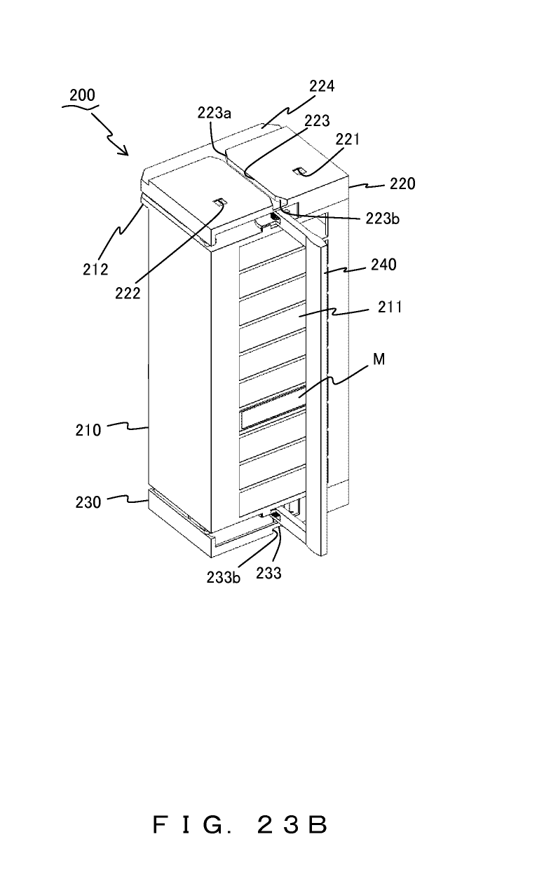

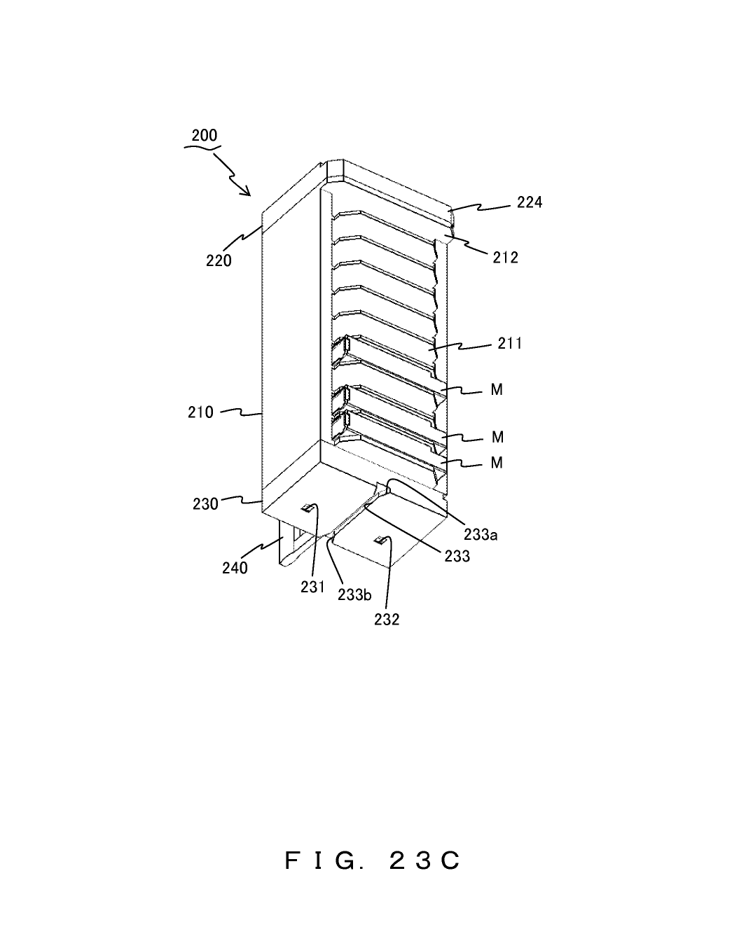

FIG. 23A through FIG. 23C are a front perspective view, a back perspective view, and a bottom perspective view illustrating the accommodating unit 200.

The accommodating unit 200 includes a main body 210, a top cover 220, a bottom cover 230, and a handle 240. While the accommodating unit 200 further includes a handle locking mechanism 250, the handle locking mechanism 250 is described later.

The recording medium M is accommodated on the partition plate 211 provided in the main body 210.

A main body protruding portion 212 that protrudes on the front side is formed at the front upper end of the main body 210 as described above.

Recessed parts 221 and 222, and a groove 223 that are positioned on the upper face for example, and a top cover protruding portion 224 positioned on the main body protruding portion 212 are provided in the top cover 220. Recessed parts 231 and 232, and a groove 233 that are positioned on the bottom face for example are provided in the bottom cover 230. The handle 240 is provided on the back face side of the main body 210. On the both ends of the grooves 223 and 233, expanding portions 223a, 223b, 233a, and 233b whose width becomes wider toward the both ends are formed.

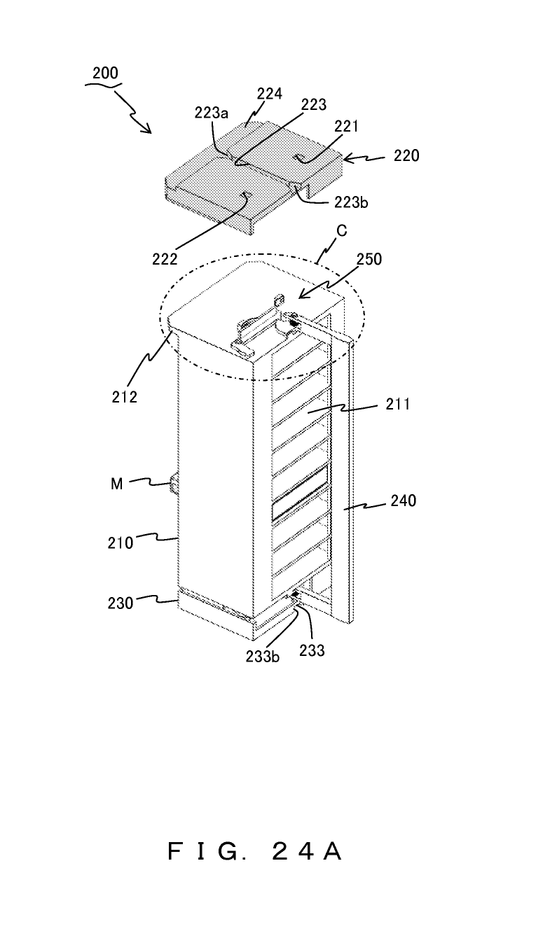

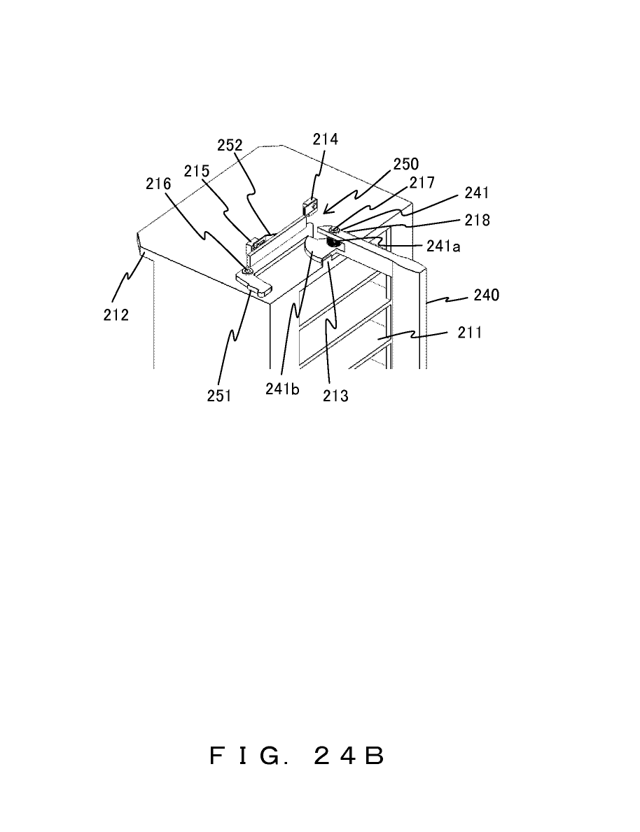

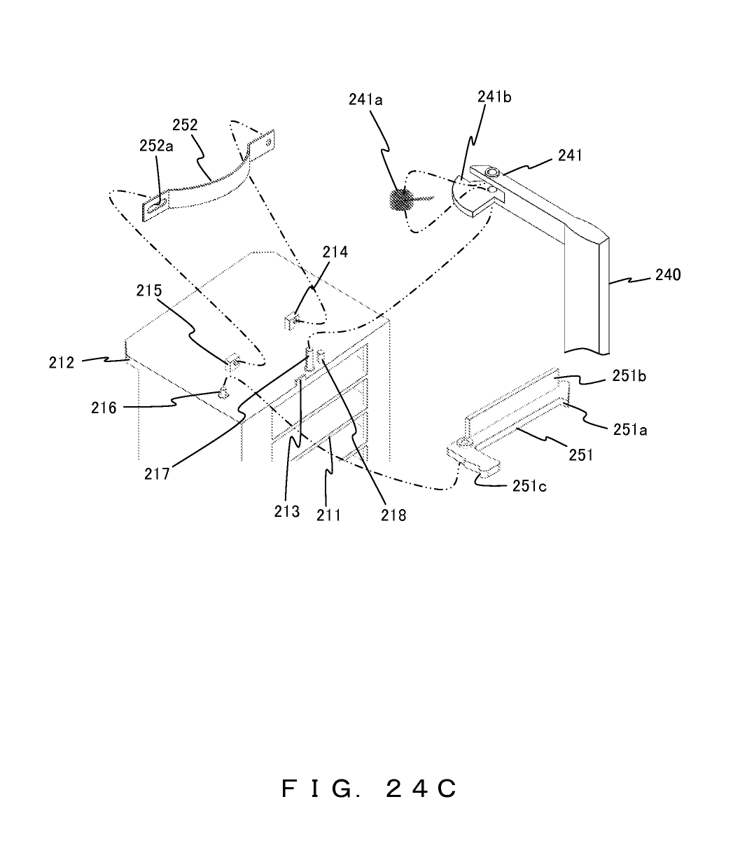

FIG. 24A is an exploded perspective view illustrating the accommodating unit 200 from which the top cover 220 is removed.

FIG. 24B is an enlarged view of a portion C in FIG. 24A.

FIG. 24C is an exploded perspective view illustrating the portion C in FIG. 24A.

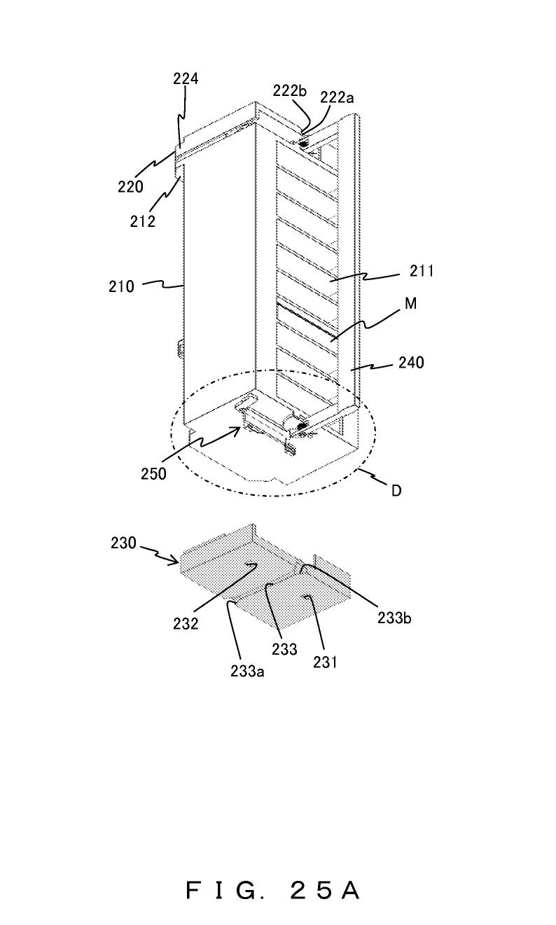

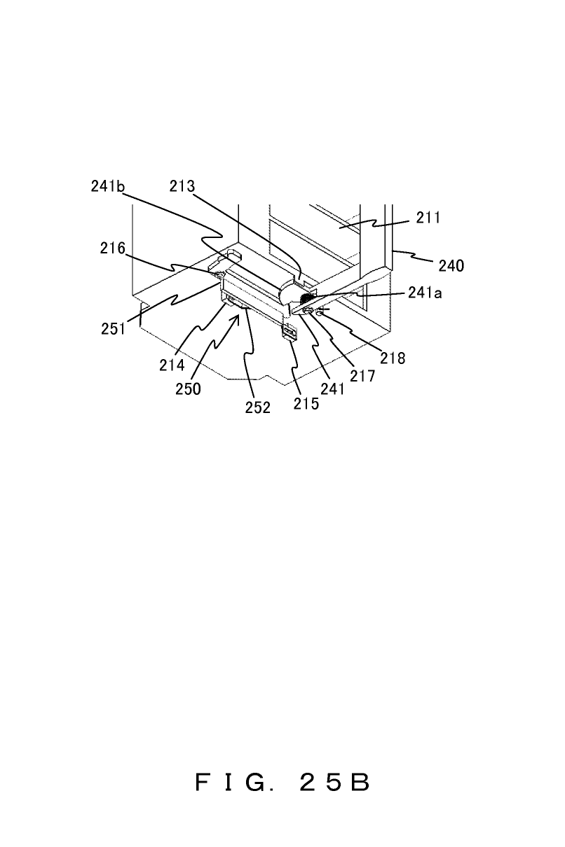

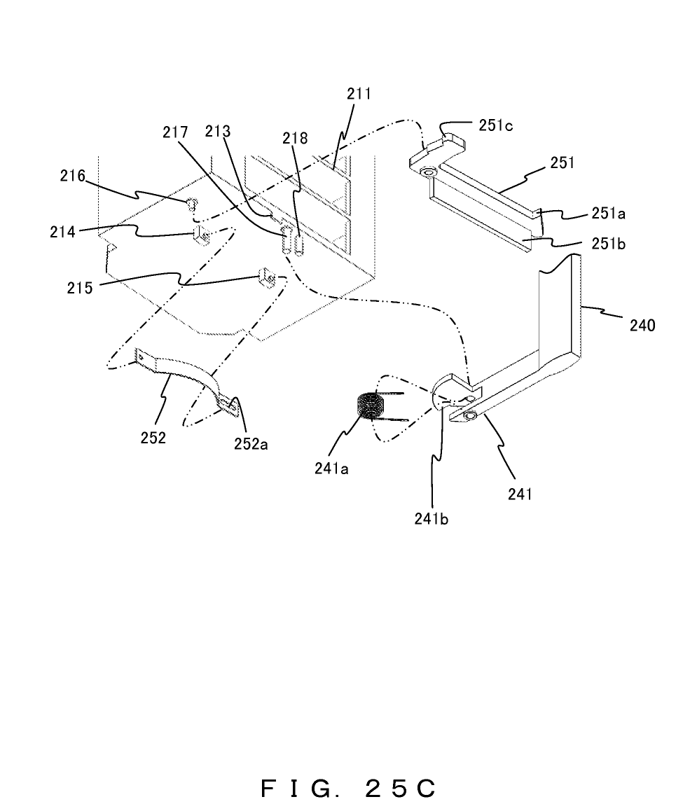

FIG. 25A is an exploded perspective view illustrating the accommodating unit 200 from which the bottom cover 230 is removed.

FIG. 25B is an exploded view of a portion D in FIG. 25A.

FIG. 25C is an exploded perspective view illustrating the portion D in FIG. 25A.

The portion C (see FIG. 24B) in FIG. 24A and the portion D (see FIG. 25B) in FIG. 25A may assume the same shape with each other, and therefore, the same numerals are assigned to the respective parts. Accordingly, an explanation is given only about the C portion in FIG. 24A.

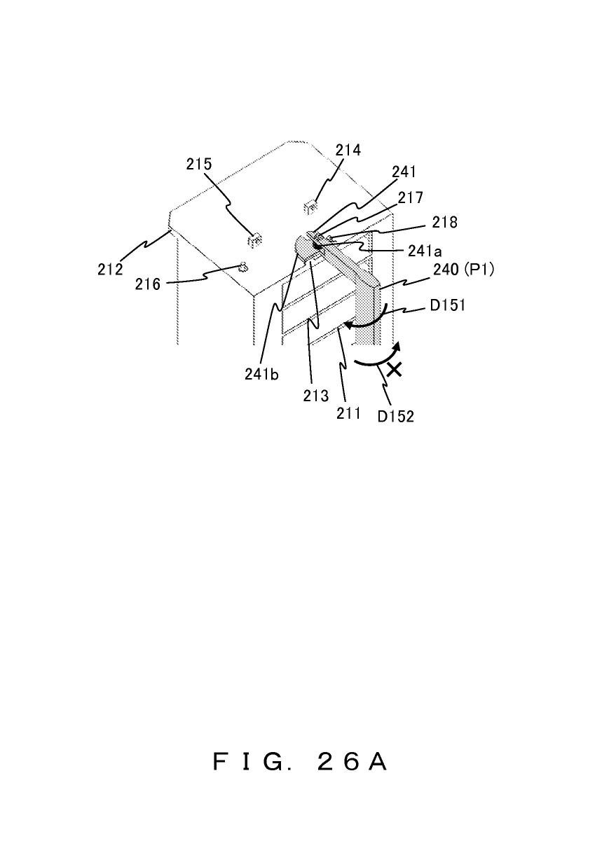

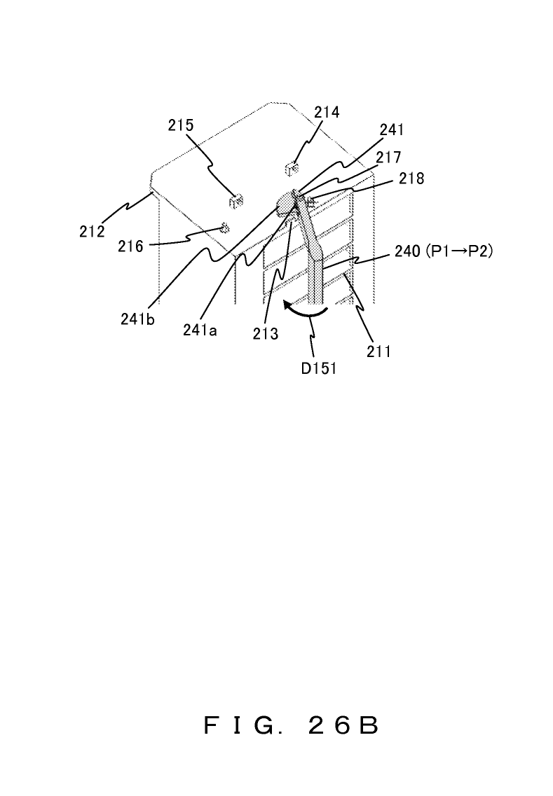

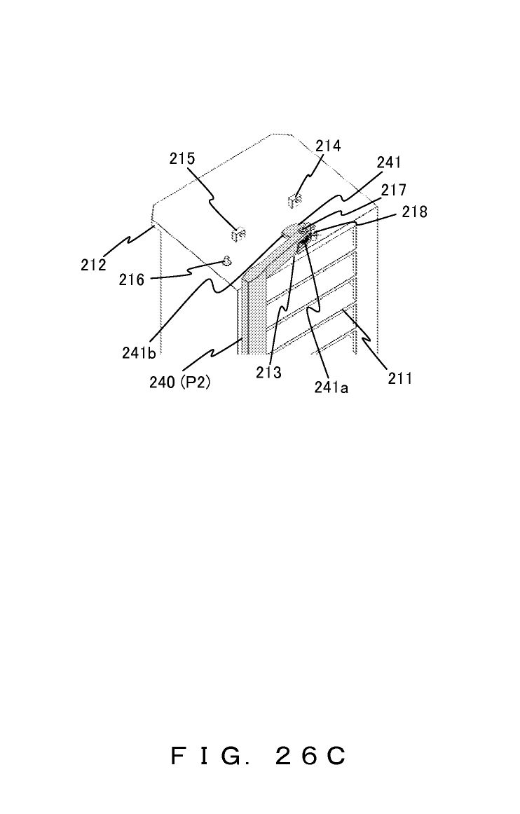

FIG. 26A through FIG. 26C are explanatory diagrams for explaining the shifting of the handle 240.

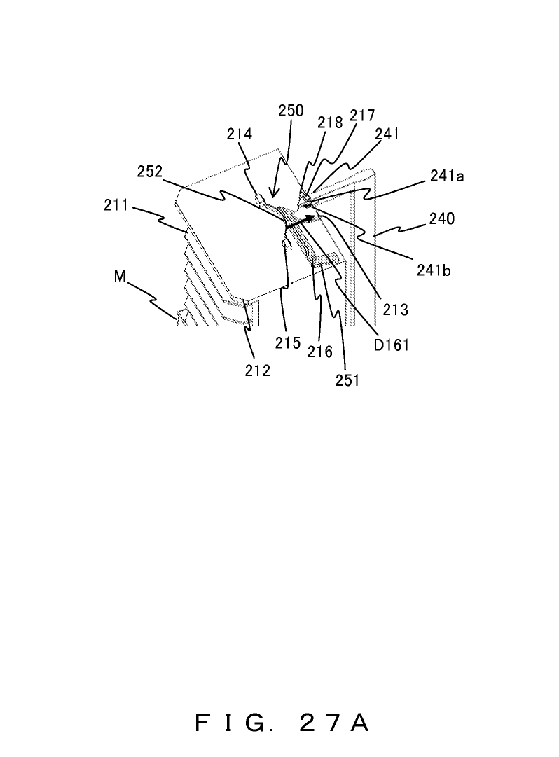

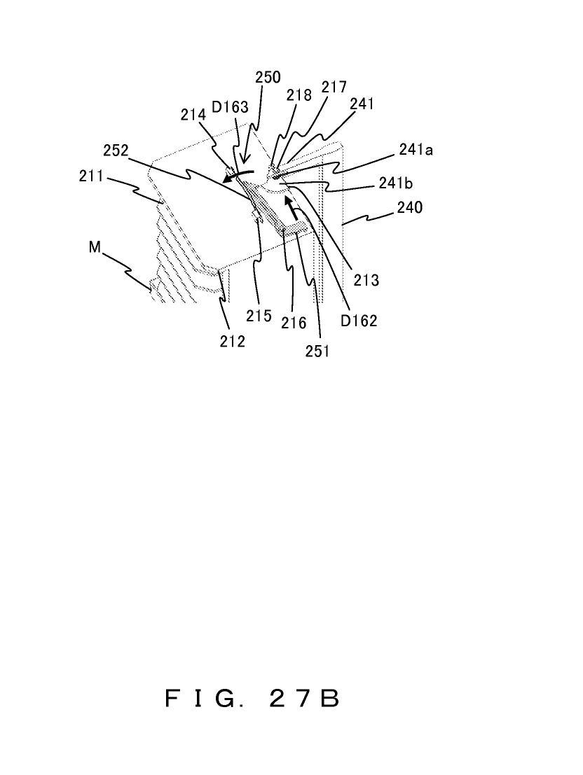

FIG. 27A and FIG. 27B are explanatory diagrams for explaining the locking of the handle 240.

As illustrated in FIG. 24A and FIG. 24B, a forked-end part 241 of the handle 240 and a handle locking mechanism 250 are placed on an upper face of the main body 210 from which the top cover 220 is removed.

A stopper 213, leaf spring supporting parts 214 and 215, a lock lever supporting part 216, a handle supporting part 217, and a torsion spring supporting part 218 are provided on an upper face of the main body 210 illustrated in FIG. 24B and FIG. 24C.

In the handle 240, in each of the fixing parts on the both ends, the forked-end part 241 split into two toward the end portion is formed. As illustrated in FIG. 26A through FIG. 26C, the handle 240 is provided on the back face side of the accommodating unit 200. The handle 240 shifts between a first position P1 illustrated in FIG. 26A at which it stands from the back face (an example of an outer face) of the accommodating unit 200, and a second position P2 illustrated in FIG. 26C at which it is laid down along the back face.

A torsion spring 241a is placed between the split portions of the forked-end part 241. In one of the split portions of the forked-end part 241, a hook part 241b to be hooked on a lock lever 251 described later is integrally formed.

The torsion spring 241a energizes the handle 240 toward the second position P2 mentioned above.

The handle locking mechanism 250 includes the lock lever 251 and the leaf spring 252.

The stopper 213, the leaf spring supporting parts 214 and 215, the lock lever supporting part 216, the handle supporting part 217 and the torsion spring supporting part 218 of the main body 210 are provided so as to protrude upward from the upper face of the main body 210.

The stopper 213 is provided on the rear end of the upper face of the main body 210, and it regulates the rotation of the hook part 241b. Accordingly, as illustrated in FIG. 26A, the handle 240 rotates from the first position P1 toward the second position P2 (arrow D151) but does not rotate in the opposite direction from the first position P1 (arrow D152).

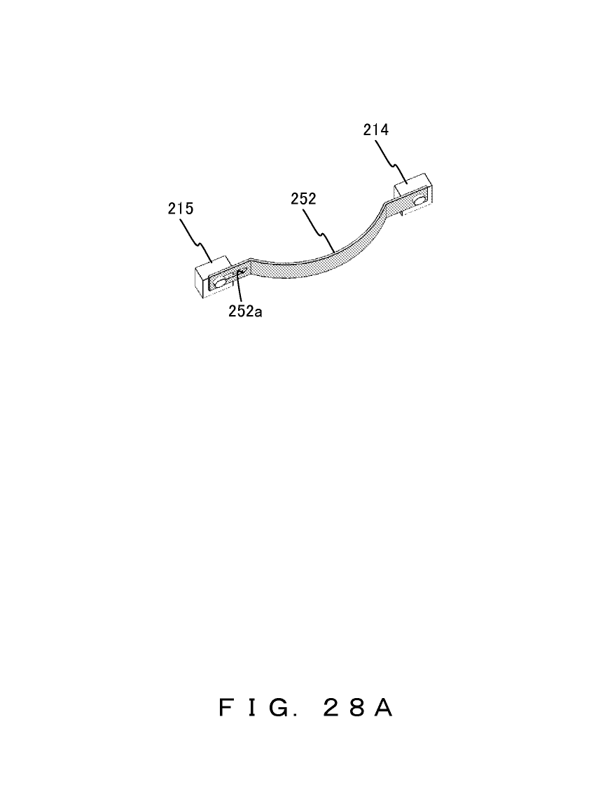

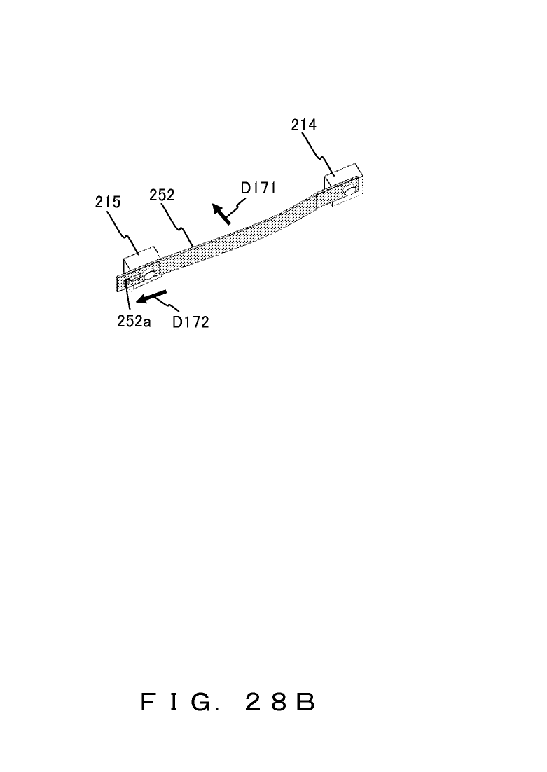

The leaf spring supporting parts 214 and 215 support each of the both ends of the leaf spring 252. As illustrated in FIG. 28A and FIG. 28B, the leaf spring supporting part 215 on one side movably supports the leaf spring 252 in a long hole 252a (arrow D172) so as to allow the elastic deformation (arrow D171) of the leaf spring 252.

The lock lever supporting part 216 rotatably supports lock lever 251.

The handle supporting part 217 rotatably supports the handle 240 at the forked-end part 241.

The torsion spring supporting part 218 supports one end of the torsion spring 241a.

A hook part 251a, a leaf spring abutting part 251b and a pressed part 251c are provided in the lock lever 251.

The hook part 251a is mutually hooked with the hook part 241b, so as to lock the handle 240 on the standing first position P1 mentioned above.

As illustrated in FIG. 27A, the leaf spring abutting part 251b abuts on the leaf spring 252, and it is energized by the leaf spring 252 in the direction in which the hook part 251a is hooked on the hook part 241b (arrow D161).

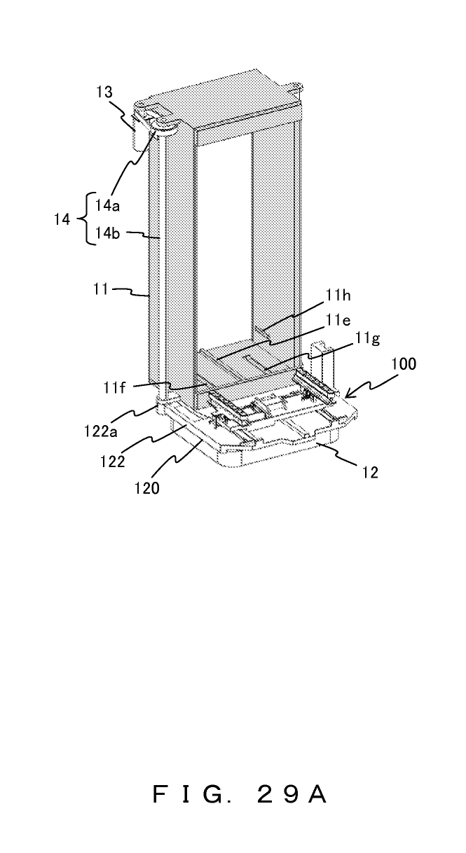

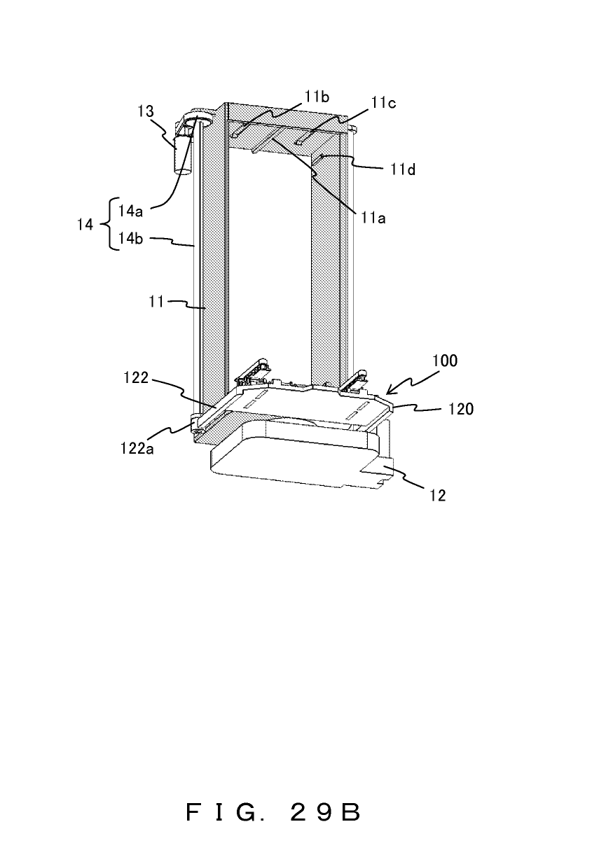

The pressed part 251c is pressed by pusher blocks 11d and 11h illustrated in FIG. 29A and FIG. 29B described later, and accordingly, it removes the lock lever 251 (hook part 251a) from the position at which it may be hooked on the hook part 241b (arrows D162, D163). At this time, as illustrated in FIG. 28B, the shape of the leaf spring 252 is changed by the pressing by the lock lever 251 (arrow D171), and as described above, the supporting position of the leaf spring supporting part 215 shifts in the long hole 252a (arrow D172).

FIG. 29A and FIG. 29B are a top perspective view and a bottom perspective view illustrating the portion of the transporting unit 10 excluding the accommodating unit 200.

As illustrated in FIG. 29B, on an upper face in an inner side of the frame 11, a guide rail 11a and two stoppers 11b and 11c are provided so as to extend in the front-back direction for example. In an upper portion of a lateral side in the inner side of the frame 11, a pusher block 11d is provided so as to extend in the front-back direction for example.

As illustrated in FIG. 29A, on a bottom face in the inner side of the frame 11, a guide rail 11e and two stoppers 11f and 11g are provided so as to extend in the front-back direction for example. In a lower portion of a lateral side in the inner side of the frame 11, a pusher block 11h is provided so as to extend in the front-back direction for example.

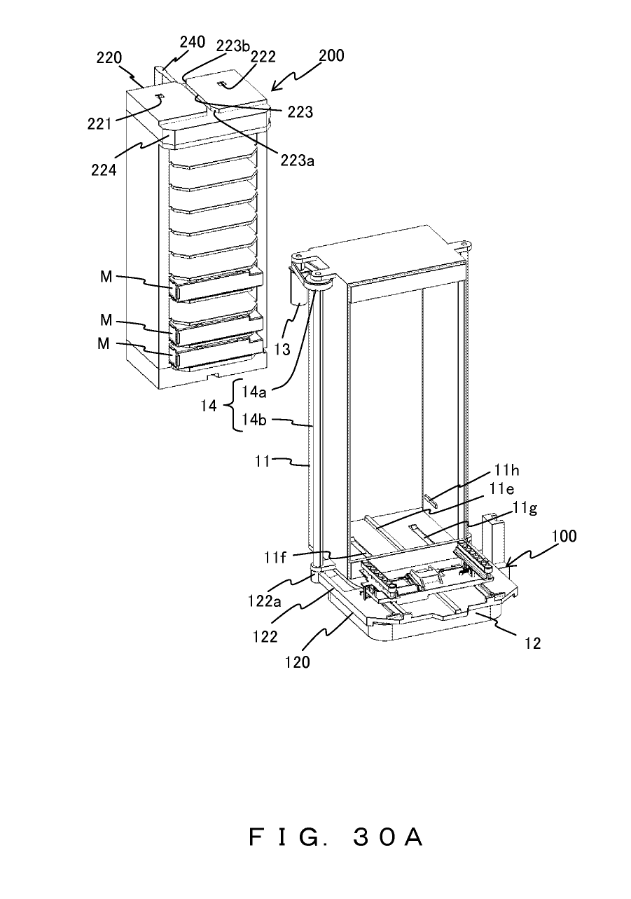

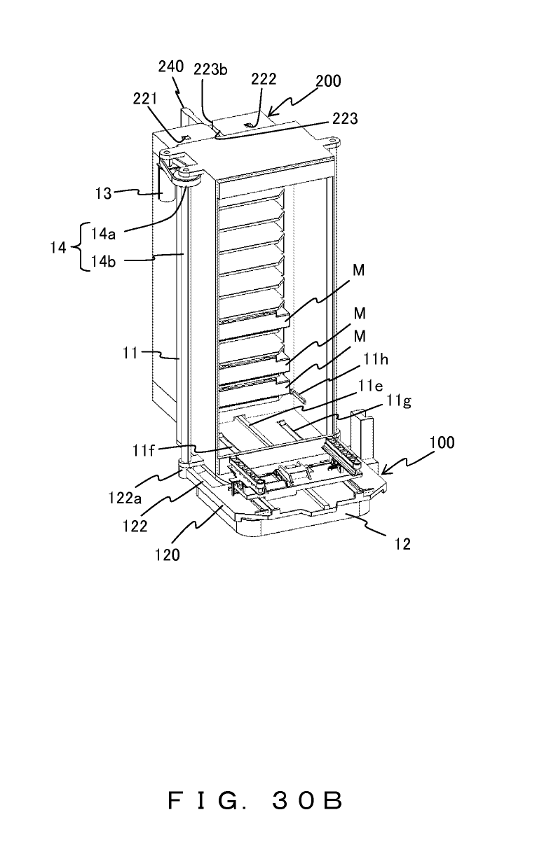

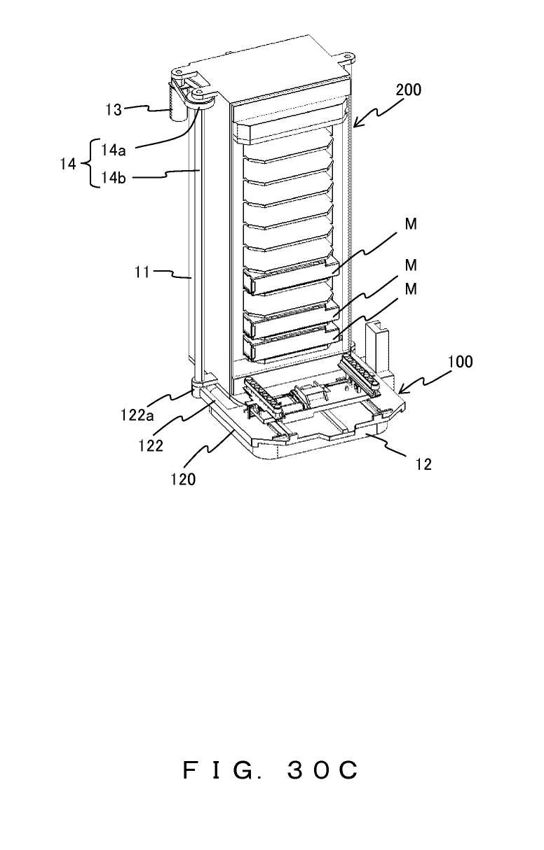

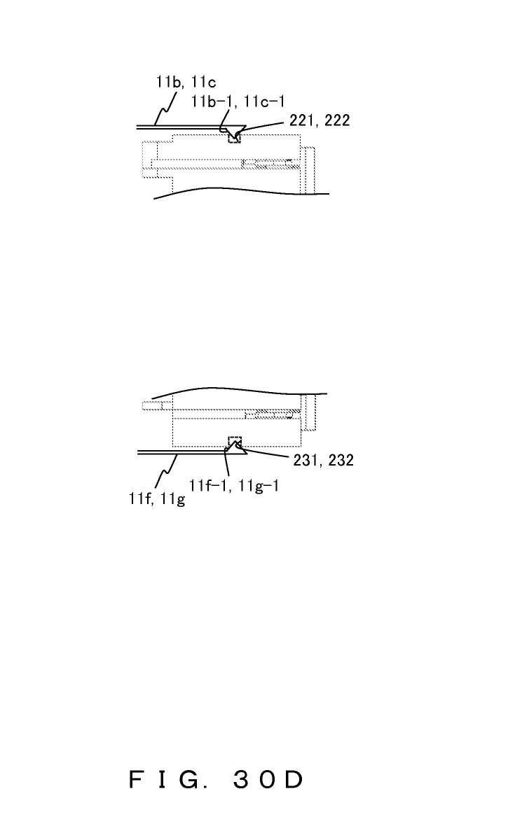

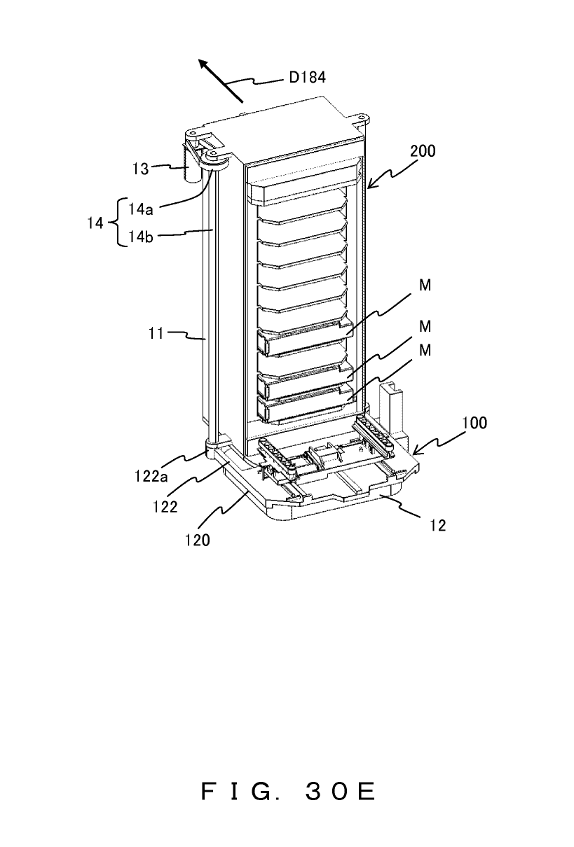

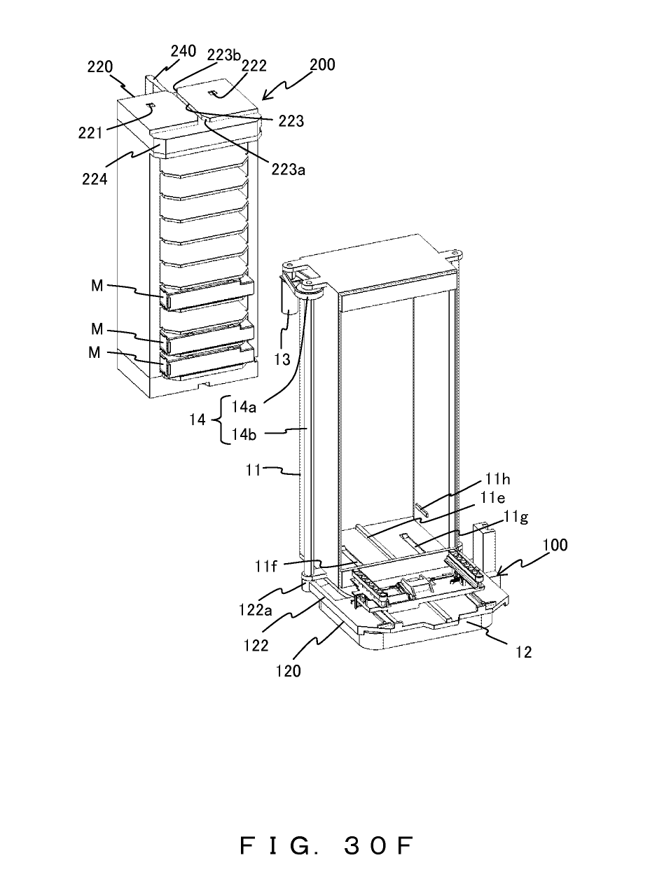

FIG. 30A through FIG. 30F are explanatory diagrams for explaining the attachment and detachment of the accommodating unit 200.

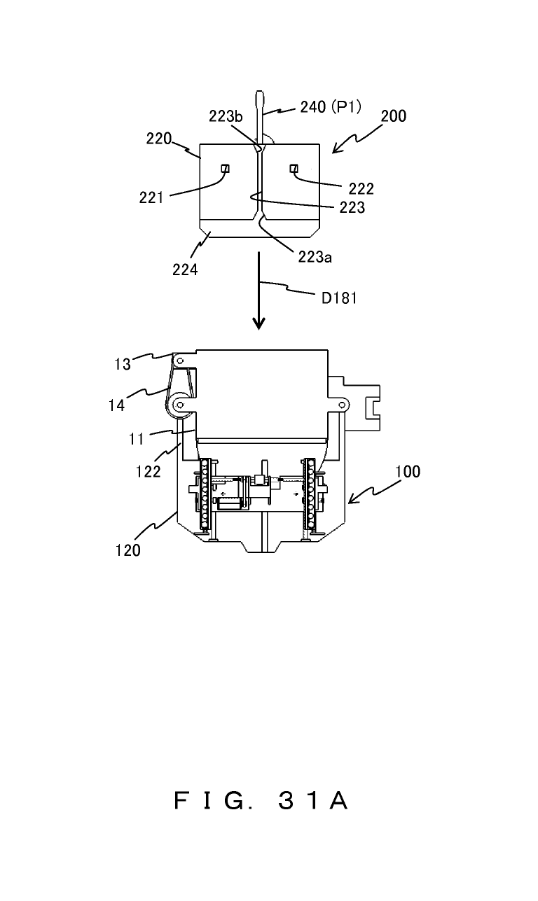

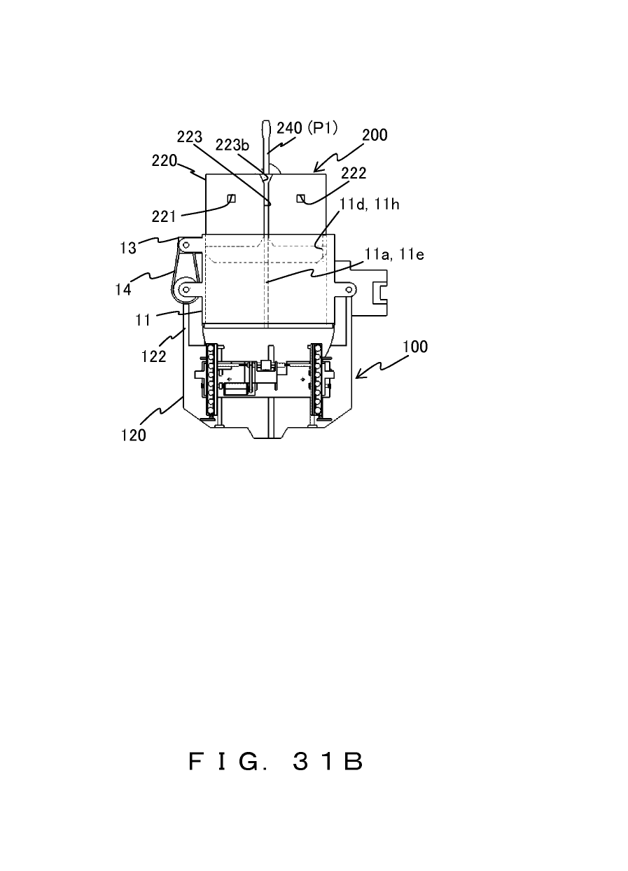

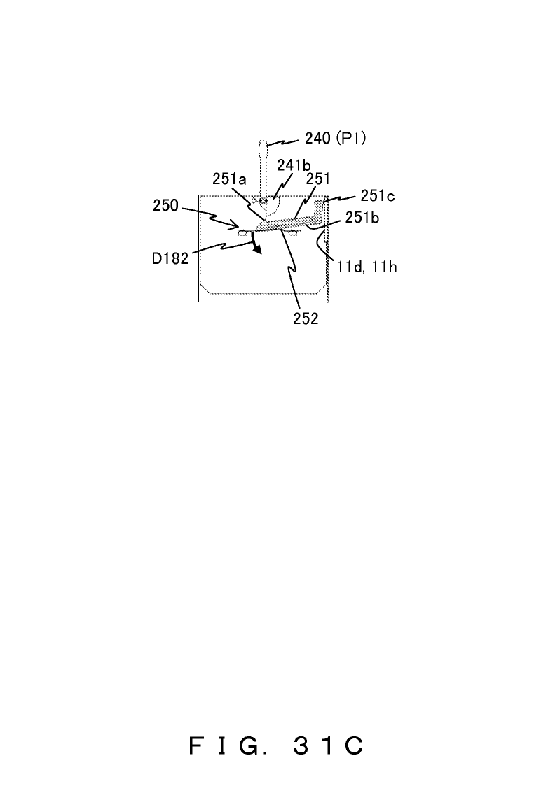

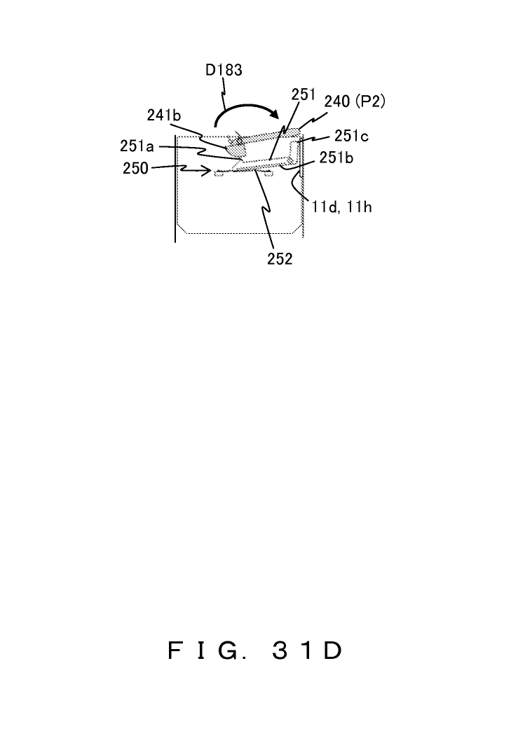

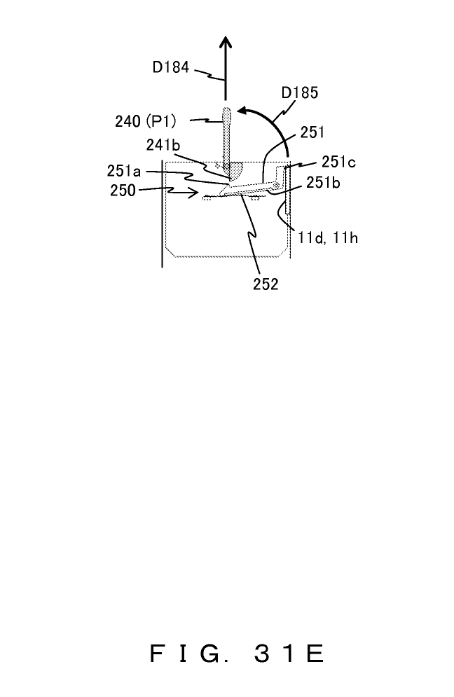

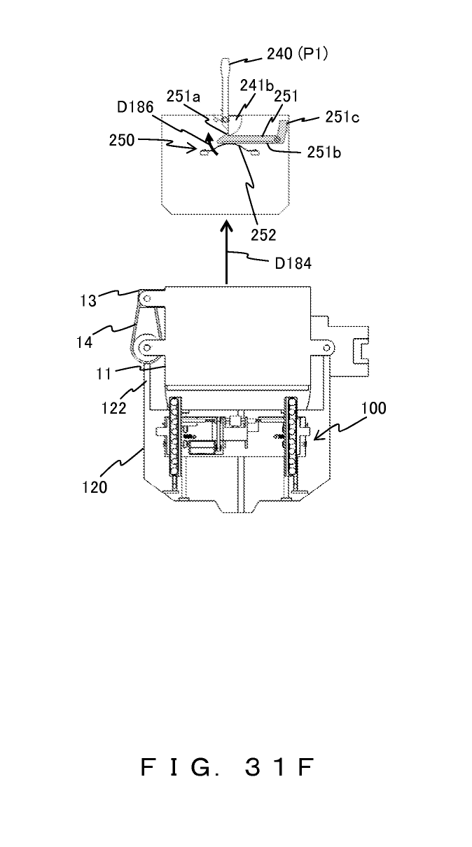

FIG. 31A through FIG. 31F are explanatory diagrams for explaining the shifting of the handle 240 at the time of the attachment and detachment of the accommodating unit 200.

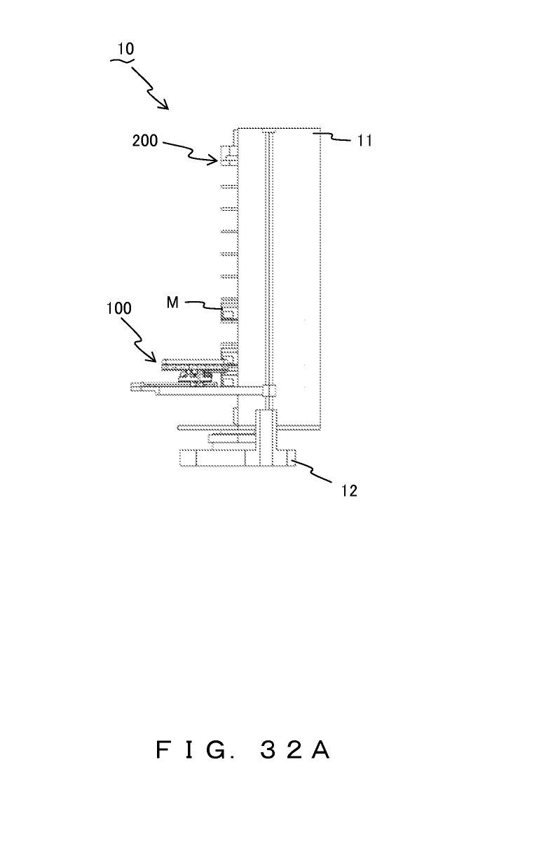

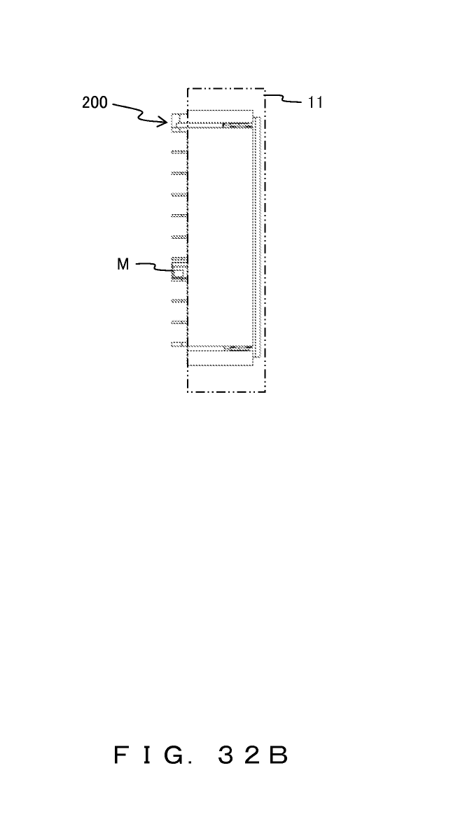

FIG. 32A and FIG. 32B are explanatory diagrams for explaining the position of the accommodating unit 200 in the transporting unit 10.

First, as illustrated in FIG. 30A and FIG. 31A, the accommodating unit 200 is attached to the transporting unit 10 from the back face side toward the front side (arrow D181 illustrated in FIG. 31A). At this time, as illustrated in FIG. 31A, the handle 240 is fixed on the standing first position P1.

As illustrated in FIG. 30B and FIG. 31B, when a part of the accommodating unit 200 enters the frame 11, the guide rails 11a and 11e guide the accommodating unit 200 in the grooves 223a and 233a of the top cover 220 and the bottom cover 230, as illustrated in FIG. 31B.

As illustrated in FIG. 30C and FIG. 31C, when the accommodating unit 200 continues to advance inside the frame 11, the pusher blocks 11d and 11h in the upper and lower portions of the frame 11 respectively press the pressed part 251c of the lock lever 251 in the upper and lower portions.

Accordingly, the lock lever 251 changes the shape of the leaf spring 252 against the energizing force of the leaf spring 252, and the hook part 251a is removed from the position at which it is hooked on the hook part 241b (arrow D182). As described above, the pusher blocks 11d and 11h function as an example of a locking releasing mechanism that releases the locking by the lock lever 251 by pressing the lock lever 251 (an example of a handle locking mechanism) in a state in which the accommodating unit 200 is placed in the transporting unit 10.

Accordingly, as illustrated in FIG. 31D, the handle 240 is rotated to shift to the second position P2 (arrow D183) by the energizing force of the torsion spring 241a described above. The accommodating unit 200 advances to a prescribed position in the frame 11 as illustrated in FIG. 32A and FIG. 32B. Accordingly, as illustrated in FIG. 30D, protruding parts 11b−1, 11c−1, 11f−1, and 11g−1 described above are inserted into the recessed part 221, 222, 231, and 232. Accordingly, the accommodating unit 200 is prevented from dropping off from the transporting unit 10.

Meanwhile, the protruding parts 11b−1, 11c−1, 11f−1, and 11g−1 are formed on one end of the stoppers 11b, 11c, 11f, and 11g provided in an inner side of the frame 11. The recessed parts 221, 222, 231, and 232 are formed in the top cover 220 and the bottom cover 230, as described above.

As illustrated in FIG. 30E and FIG. 31E, when removing the accommodating unit 200 from the transporting unit 10 (arrow D184), a human grasps the handle 240. Accordingly, the handle 240 stands (the position P1) when it is raised (arrow D185) by a power that is greater than the energizing force of the torsion spring 241a toward the second position P2 mentioned above.

As illustrated in FIG. 30F and FIG. 31F, when the accommodating unit 200 continues to be removed completely from the transporting unit 10 (arrow D184), the pressed part 251c of the lock lever 251 is no longer pressed. Accordingly, the leaf spring 252 makes the lock lever 251 shift in the direction in which it is hooked on the hook part 241b (arrow D186).

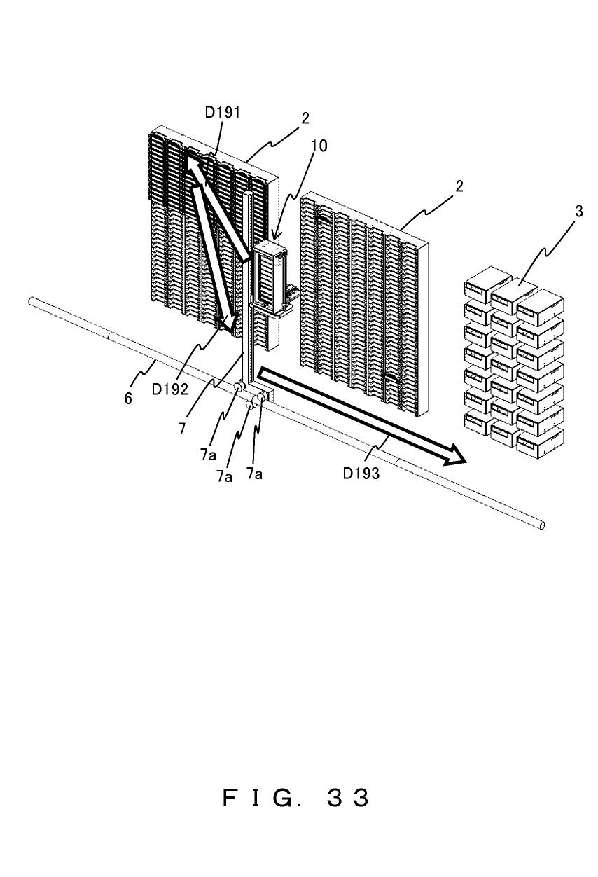

FIG. 33 is a perspective view illustrating a transporting route of a plurality of recording media M from the storing unit 2 to the drive 3.

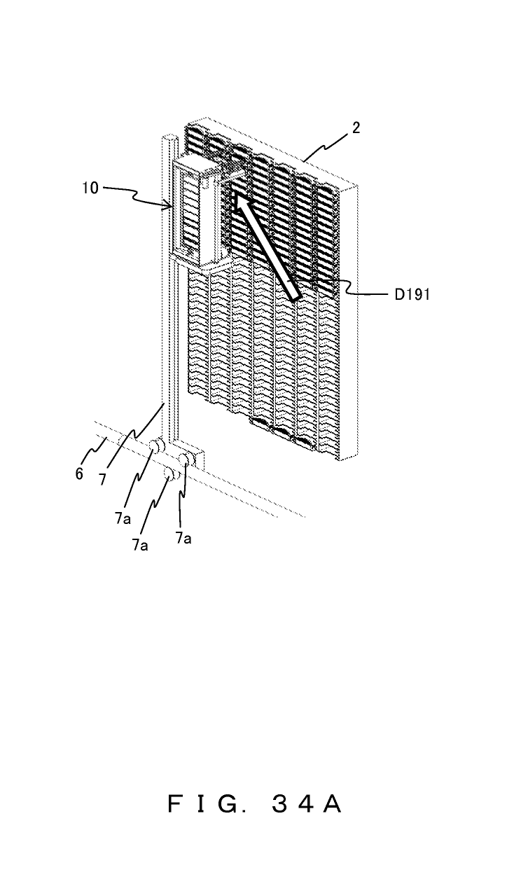

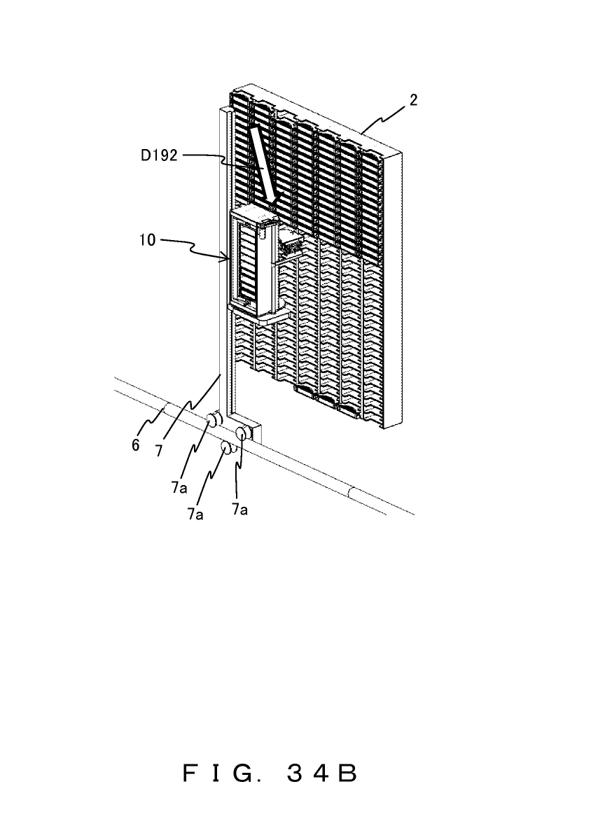

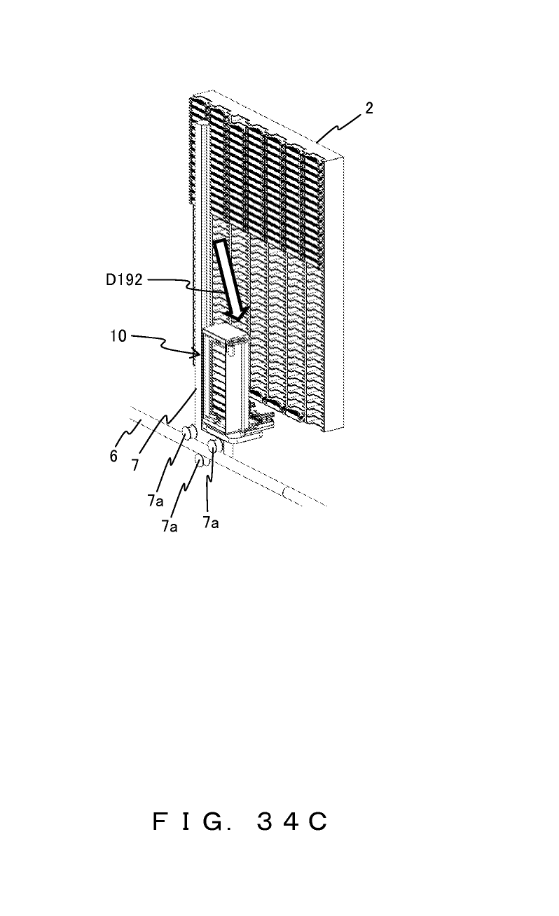

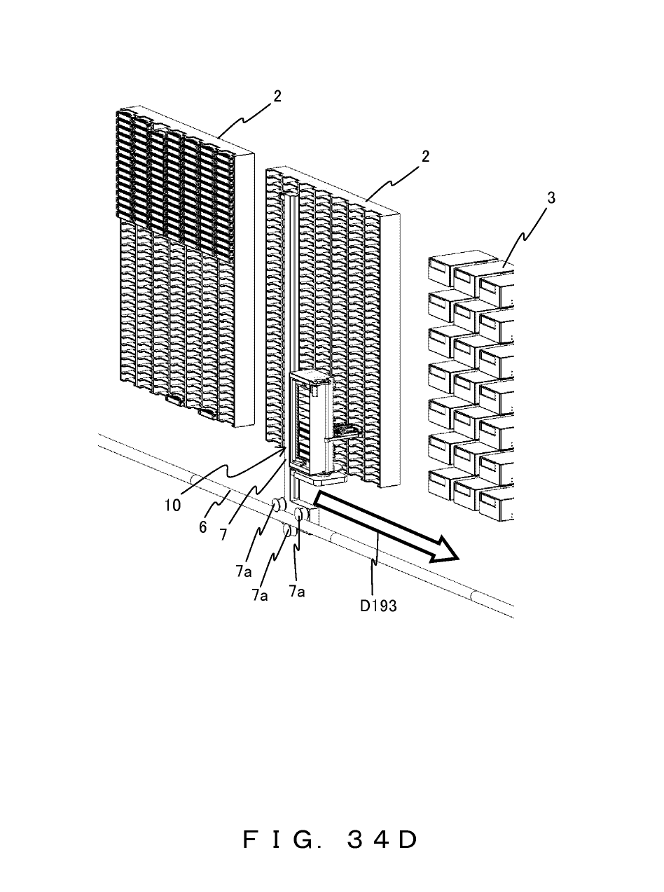

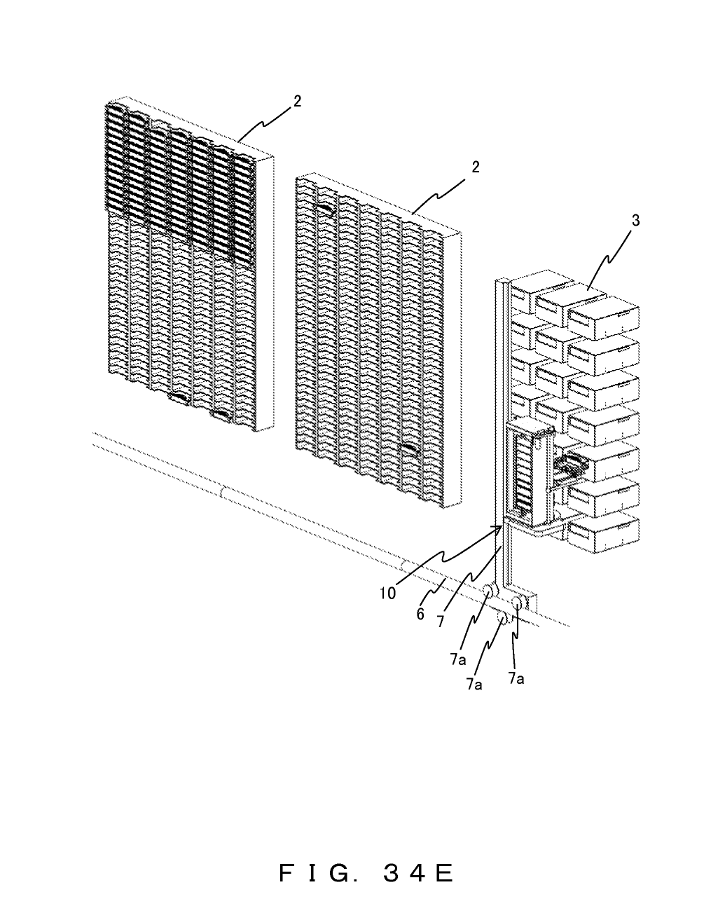

FIG. 34A through FIG. 34E are perspective views for explaining the transportation of a plurality of the recording media M from the storing unit 2 to the drive 3.

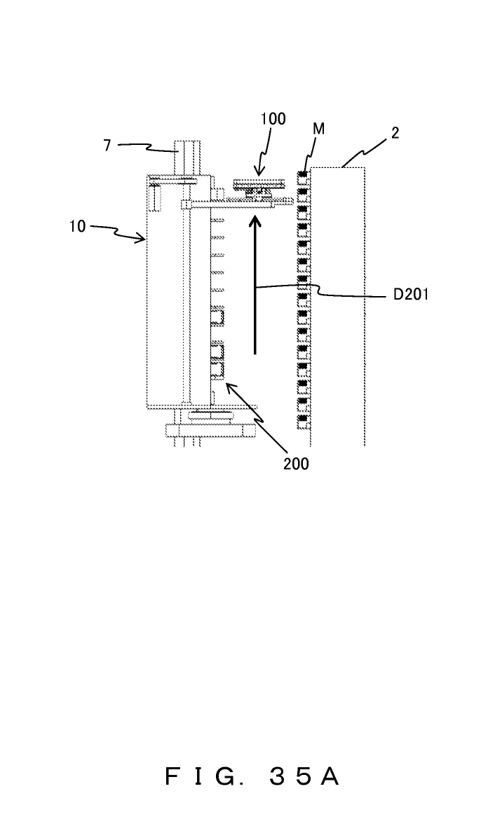

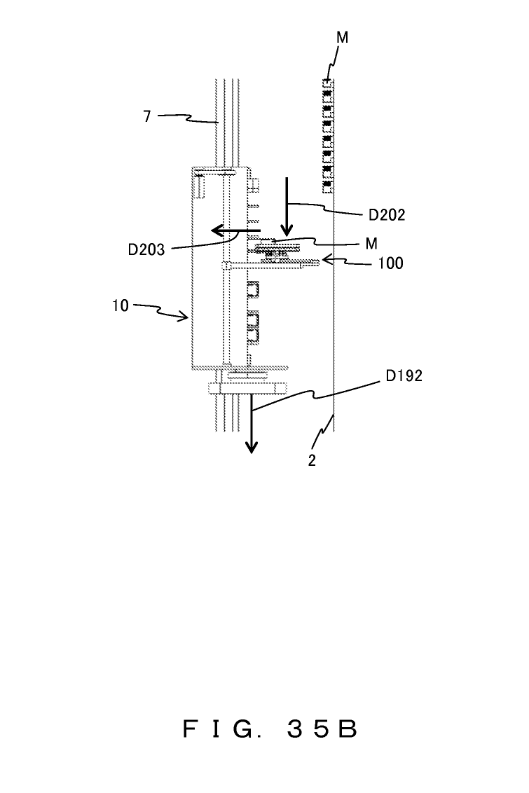

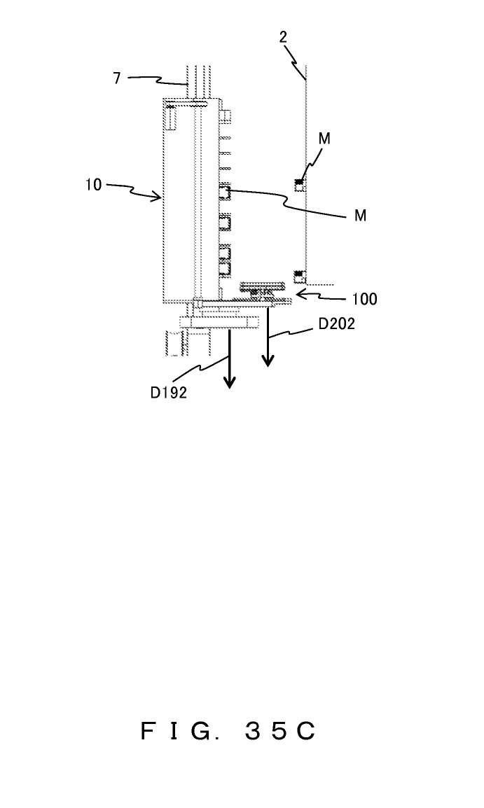

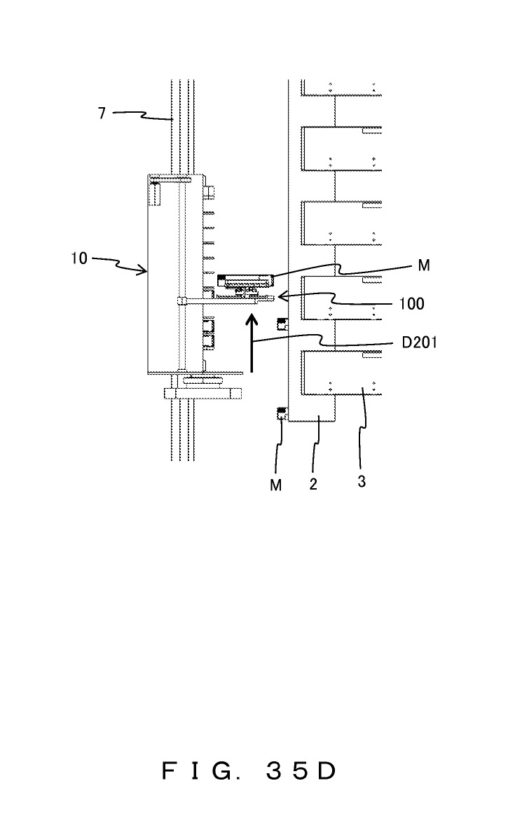

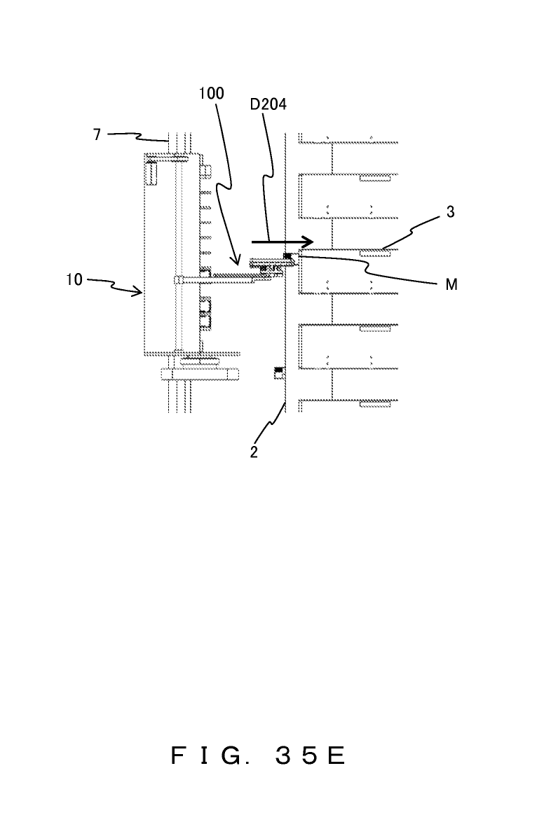

FIG. 35A through FIG. 35E are side views for explaining the transportation of a plurality of the recording media M from the storing unit 2 to the drive 3.

In the explanation of the transportation of a plurality of the recording media M from the storing unit 2 to the drive 3 given below, as illustrated in FIG. 33, the transporting unit 10 shifts to a plurality of positions in the storing unit 2 to take out the recording media M (arrows D191, D192), and it transports the recording media M to the drive 3 (arrow D193).

First, as illustrated in FIG. 34A, the transporting unit 10 is shifted to so as to face the recording medium M in the storing unit 2 that is to be taken out first (arrow D191), by the first-direction guide 6 and the second-direction guide 7 described above. When the recording medium M that is to be taken out first is positioned on the upper end of the storing unit 2 for example, the transferring unit 100 shifts to the upper end in the transporting unit 10 (arrow D201), as illustrated in FIG. 35A. This action of the transferring unit 100 may be regarded as an action to reduce the shifting space, because the more the transporting unit 10 shifts upward, the more the shifting space of the transporting unit 10 expands.

Next, as illustrated in FIG. 34B, the transporting unit 10 shifts to a position that faces the recording medium M in the storing unit 2 that is to be taken out second (arrow D192). On the way, the transferring unit 100 transfers the recording medium M into the transporting unit 10 (arrows D202, D203).

After that, as illustrated in FIG. 34C, the transporting unit 10 shifts again so as to face the recording medium M in the storing unit 2 to be taken out second (arrow D192), as illustrated in FIG. 34C. When the recording medium M to be taken out second is positioned on the lower end of the storing unit 2, the transferring unit 100 shifts to the lower end in the transporting unit 10 (arrow D202), as illustrated in FIG. 35C. This action of the transferring unit 100 may also be regarded as an action to reduce the shifting space, because the more the transporting unit 10 shifts downward, the more the shifting space of the transporting unit 10 expands, in a manner similar to the manner explained above.

As illustrated in FIG. 34D, when the transporting unit 10 shift towards the drive 3 (arrow D193), it is preferable that the transferring unit 100 keeps holding the recording medium M that is taken out last while it is transported. Accordingly, the action to accommodate the recording medium M that is taken out last into the accommodating unit 200 may be omitted. Meanwhile, as illustrated in FIG. 35D, it is preferable that the transferring unit 100 shifts upward again in the transporting unit 10 to a height at which it faces the drive 3, before reaching the prescribed drive 3 (arrow D201).

As illustrated in FIG. 34E and FIG. 35E, in the transporting unit 10, the recording medium M held by the transferring unit 100 is transferred to the drive 3 in a similar manner as the manner in the transferring action described above. After that, the recording media accommodated in the accommodating unit 200 are sequentially transferred to the drive 3.

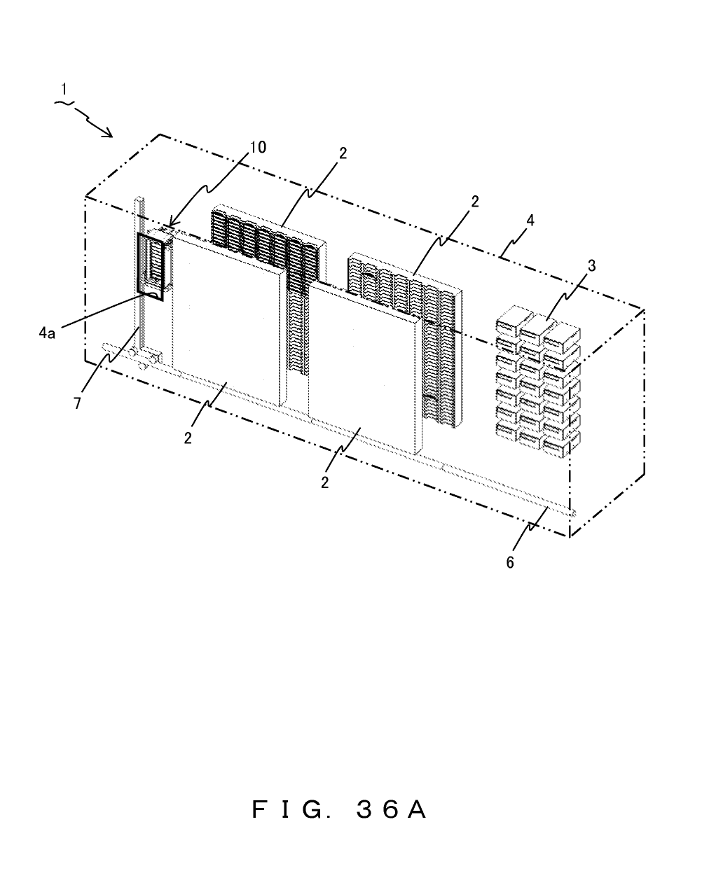

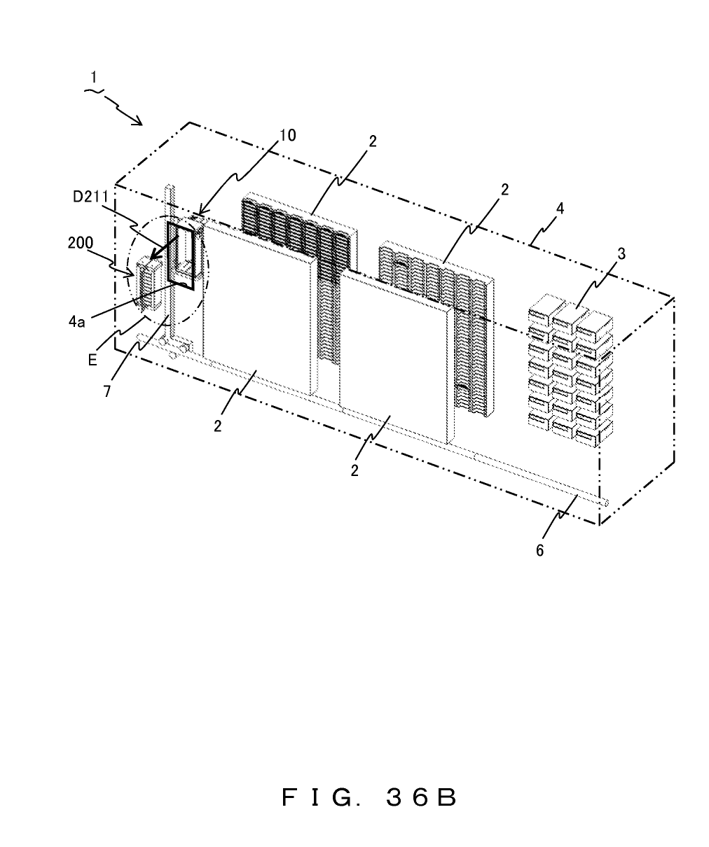

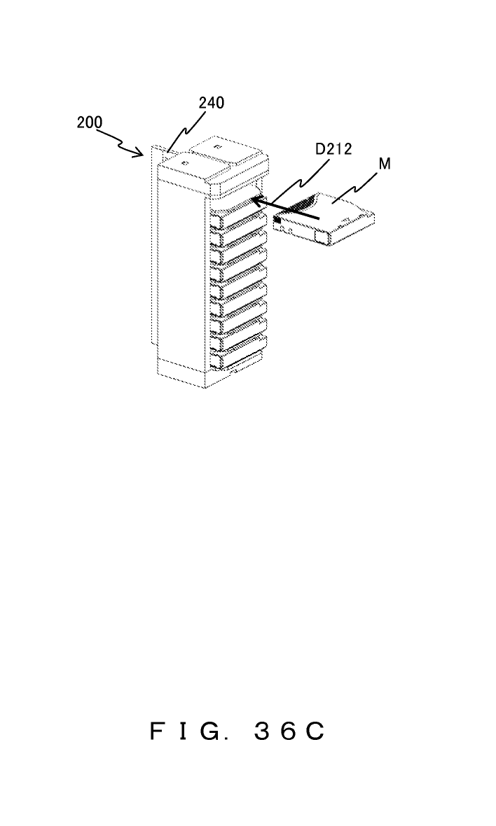

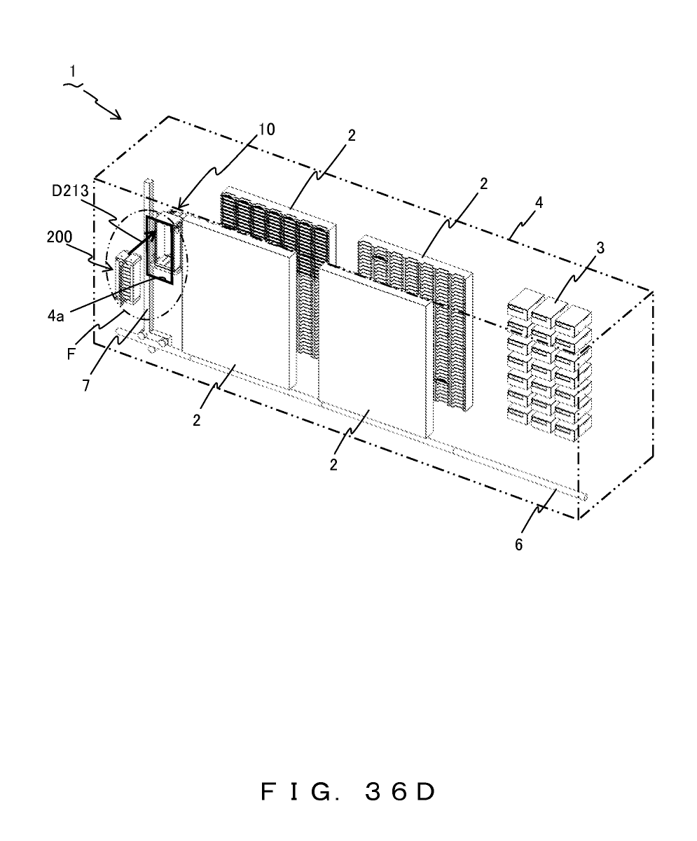

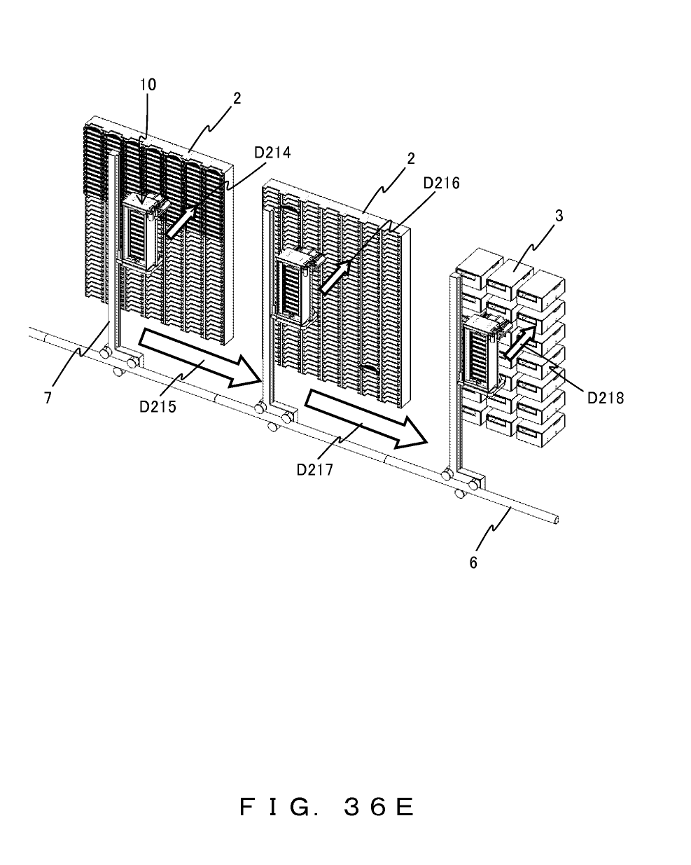

FIG. 36A through FIG. 36E are explanatory diagrams for explaining the loading and ejection of the accommodating unit 200 into and from the library apparatus 1.

First, when an instruction to load or eject the accommodating unit 200 is issued to the library apparatus 1, the transporting unit 10 shifts to the loading and ejecting opening 4a of the casing 4, as illustrated in FIG. 36A.

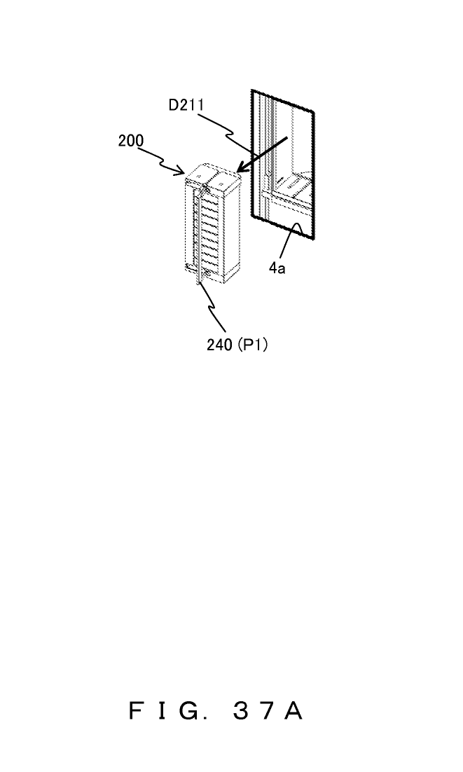

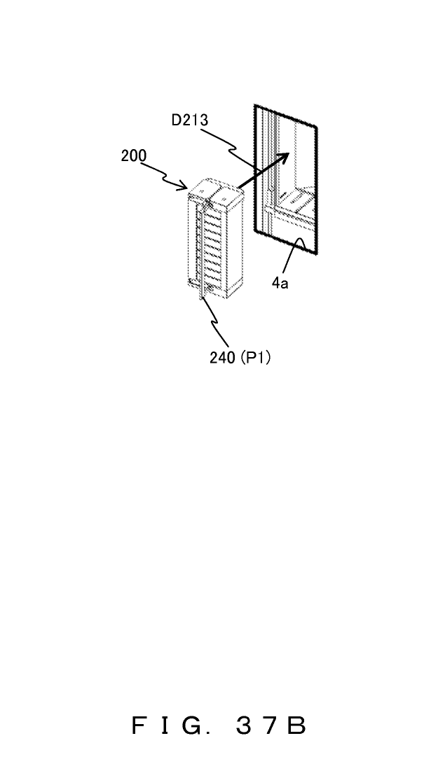

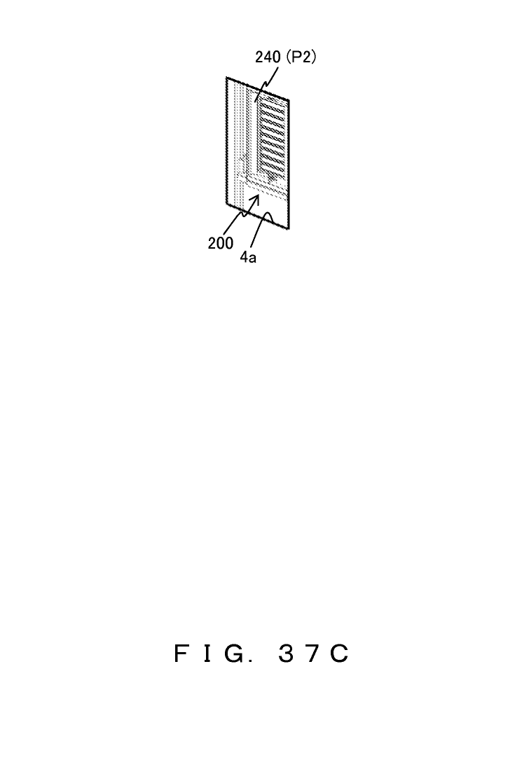

As illustrated in FIG. 36B and FIG. 37A, the accommodating unit 200 is taken out from the transporting unit 10 (arrow D211) by the grasping of the handle 240 that has been laid down. Accordingly, the handle 240 is locked on the standing position P1.

After that, as illustrated in FIG. 36C, the recording media M is accommodated into the accommodating unit 200 for example by a human hand (arrow D212).

After the accommodation of the recording media M into the accommodating unit 200 is completed, as illustrated in FIG. 36D and FIG. 37B, the accommodating unit 200 is loaded into the transporting unit 10 through the loading and ejecting opening 4a of the casing 4 (arrow D213). Accordingly, the handle 240 shifts to the laid-down position P2 illustrated in FIG. 37C as described above.

After that, as illustrated in FIG. 36E, the transporting unit 10 transports the recording media M to the storing unit 2 (arrow D214 through D216), as illustrated in FIG. 36E. Alternatively, the transporting unit 10 transports the recording media M directly to the drive 3 (arrows D217, D218).

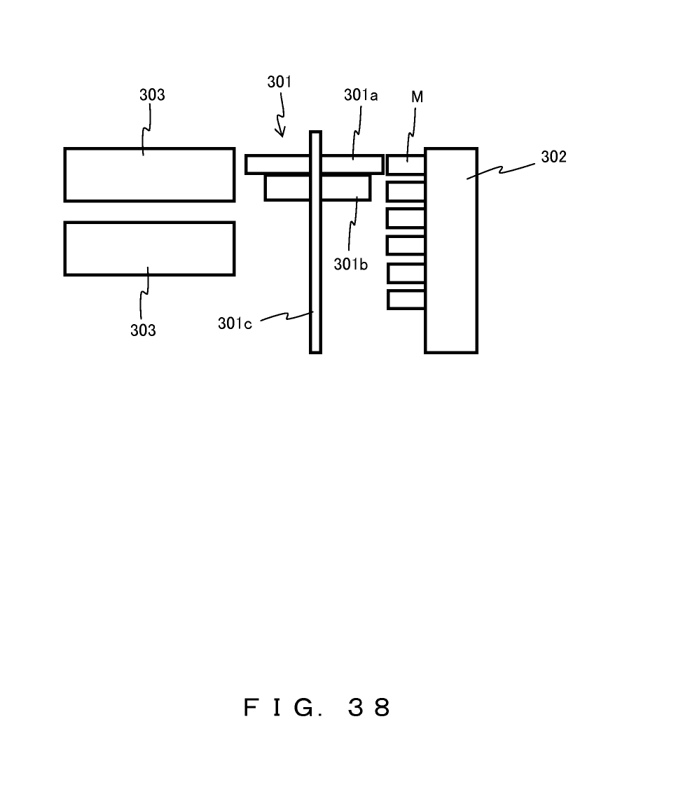

FIG. 38 is a side view illustrating a transferring unit 301 in a comparison example.

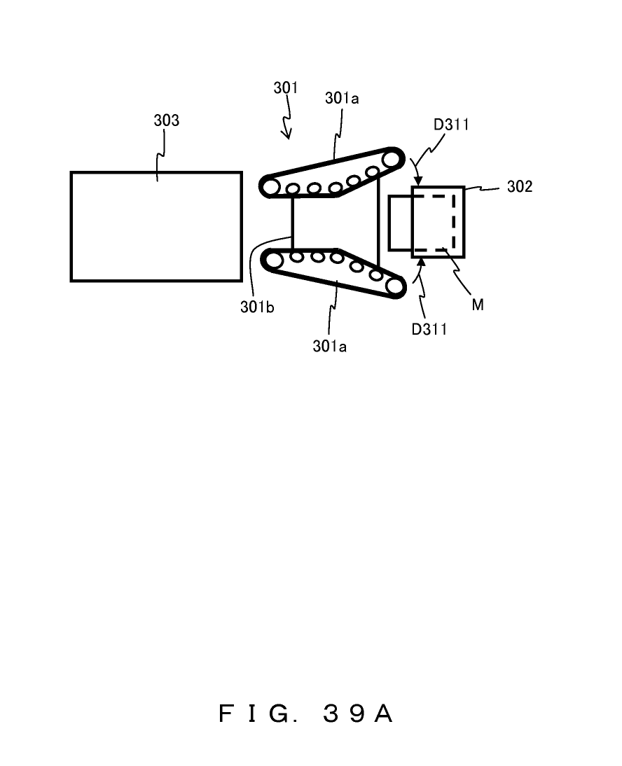

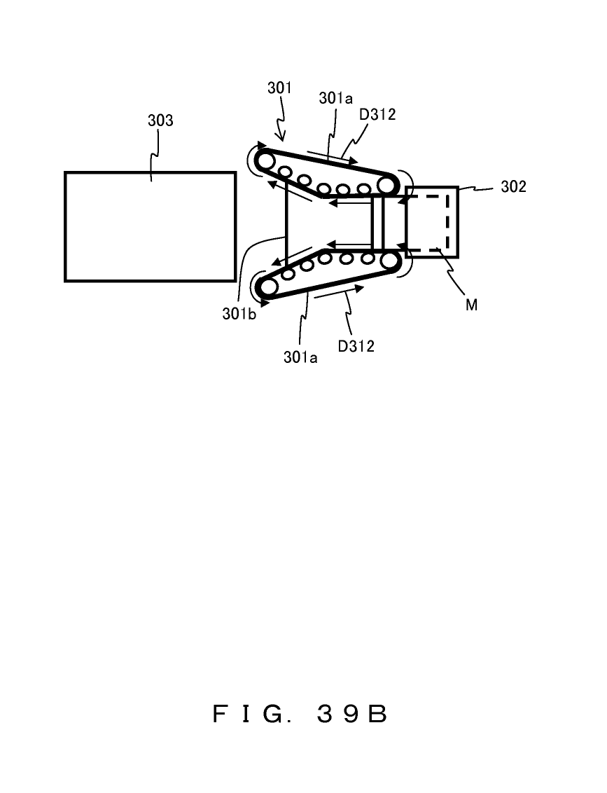

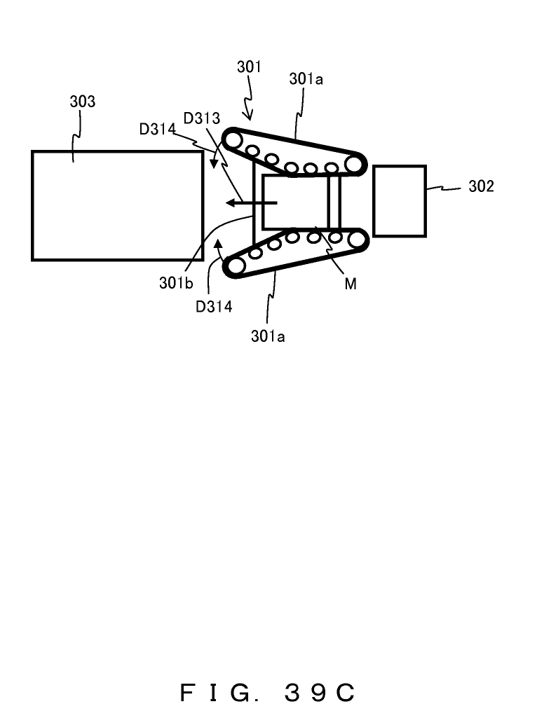

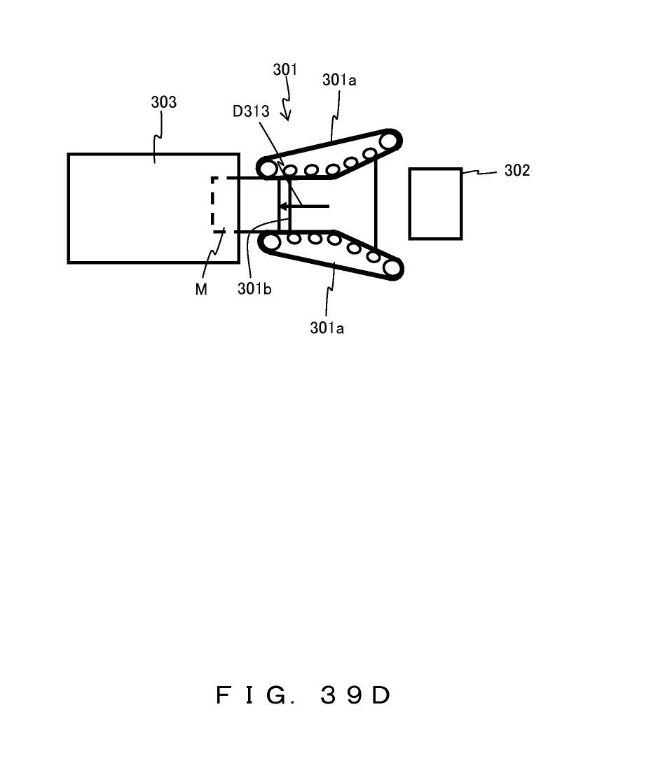

FIG. 39A through FIG. 39D are plan views for explaining the transfer by the transferring unit 301 in the comparison example.

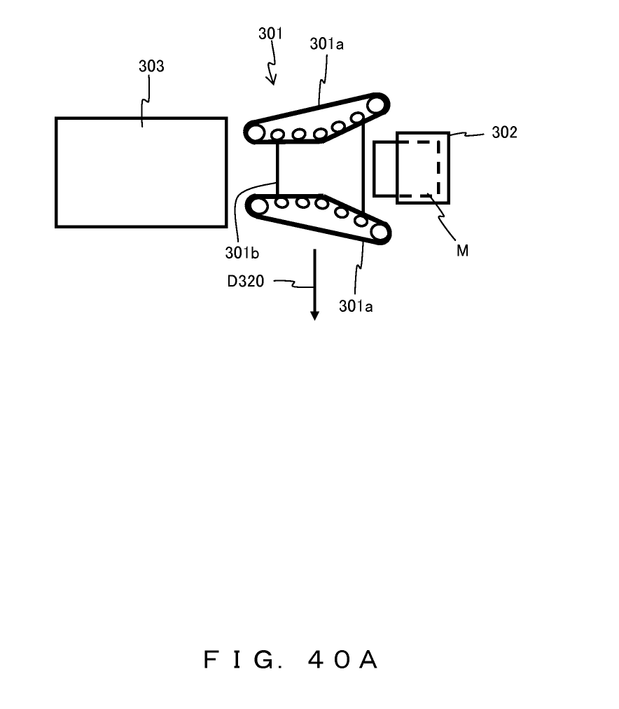

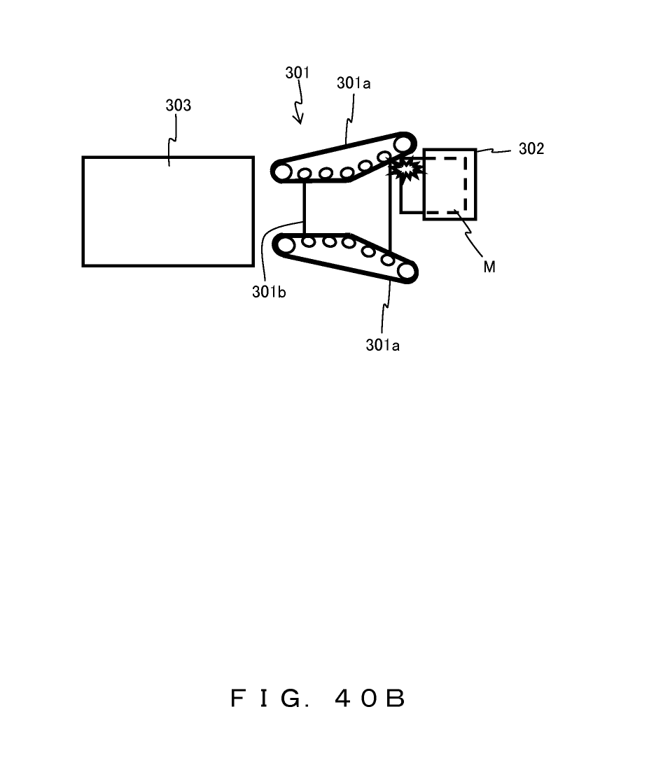

FIG. 40A and FIG. 40B are plan views explaining the contact condition at the time of the shifting of the transferring unit 301 in the comparison example.

As illustrated in FIG. 38, the transferring unit 301 includes a pair of carrying belts 301a (see FIG. 39A through FIG. 39D), a base 301b, and an up-down direction guide 301c.

The pair of carrying belts 301a are placed on an upper face of the base 301b.

The pair of carrying belts 301a and the base 301b move upward and downward along the up-down direction guide 301c.

A accommodating unit 302 accommodates a plurality of recording media M arranged in an up-down direction.

A plurality of drives 303 are provided.

As illustrated in FIG. 39A, the pair of carrying belts 301a rotate so that their right ends approach each other and their left ends move apart from each other (arrow D311). Accordingly, as illustrated in FIG. 39B, the pair of carrying belts 301a hold the recording medium M between their right ends. Then, the pair of carrying belts 301a are actuated so as to carry the recording media M (arrow D312), and they carry the recording medium M toward the drive 303 (arrow D313), as illustrated in FIG. 39D.

After the recording medium M is carried onto the transferring unit 301, the pair of carrying belts 311a rotate so that their right ends move apart from each other and their left ends approach each other (arrow D313), in a manner that is opposite to the manner illustrated in FIG. 39A. After that, as illustrated in FIG. 39D, the carrying belts 301a carry the recording medium M into the drive 303 (arrow D313).

As illustrated in FIG. 40A, when the transferring unit 301 shifts in a lateral direction (the up-down direction in FIG. 40A) (arrow D320), the carrying belts 301a contact the accommodated recording medium M as illustrated in FIG. 40B. For this reason, in order to avoid interference between the transferring unit 301 and the accommodating unit 302, the accommodating unit 302 is to be shifted to the rightward direction in FIG. 40B, or the transferring unit 301 is to be shifted.

Two driving sources for actuation, one driving source for the holding action, and one driving source for upward and downward actions are provided for the carrying belts 301a. Thus, four driving sources are provided in the transferring unit 301.

In the present embodiment described above, the transporting unit 10 shifts in the first direction (arrow D1) and in the second direction (arrow D2) that intersect each other, and it transports the recording media M. The transporting unit 10 includes the accommodating unit 200 and the transferring unit 100. The accommodating unit 200 is capable of accommodating a plurality of recording media M. The transferring unit 100 transfers the recording media M one by one between the storing unit 2 and the accommodating unit 200.

Therefore, by transferring the recording media M between the transferring unit 100 and the accommodating unit 200 in the transporting unit 10, the time to be taken to put the recording media M in and out the accommodating unit 200 may be shortened. In addition, a plurality of recording media M stored separately from each other in the storing unit 2 may be collectively transported, because the transporting unit 10 is able to shift in a state in which the accommodating unit 200 accommodates a plurality of recording media M. Furthermore, even in a case such as when a plurality of recording media M are arranged and stored in a depth direction of the storing unit 2, the plurality of recording media M may be sequentially transferred to the accommodating unit 200.

Therefore, according to the present embodiment, efficiency in transportation may be enhanced.

In the present embodiment, the transferring unit 100 includes the first and the second conveyer mechanisms 111 and 112 (an example of the carrying unit). The first and the second conveyer mechanisms 111 and 112 carry the recording medium M in the third direction (arrow D3) that intersects a plane defined by the first direction (arrow D1) and the second direction (arrow D2). Therefore, the recording medium M may be transferred in a short time with a simple configuration.

In the present embodiment, an example of the carrying unit is the pair of conveyer mechanisms 111 and 112 that hold the recording medium M therebetween. In addition, the transferring unit 100 includes the tension springs 114 (an example of the conveyer energizing mechanism) and the hand unit arms 118 (an example of the regulating unit), the tray stoppers 121e through 121h, and the protruding parts 124a and 124b (an example of the canceling unit) of the stopper arms 124. The tension springs 114 energize the pair of conveyer mechanisms 111 and 112 in the direction in which they approach each other. The hand unit arms 118 regulate the relative positions of the pair of conveyer mechanisms 111 and 112 against the energizing force given by the tension springs 114 to the pair of conveyer mechanisms 111 and 112. The tray stoppers 121e through 121h and the protruding parts 124a and 124b of the stopper arms 124 cancel the regulation of the relative positions. Therefore, the recording medium M may be held and the holding may be released with a simple configuration.

In the present embodiment, the transferring unit 100 further includes the first driving mechanism 116 and the second driving mechanism 117. The first driving mechanism 116 actuates the conveyer mechanisms 111 and 112, so as to make them carry the recording medium M in the third direction (arrow D3). The second driving mechanism 117 makes the conveyer mechanisms 111 and 112 shift in the third direction (arrow D3). Therefore, efficiency in transportation may be enhanced, because the recording medium M may be transferred by both the actions and the shifting of the conveyer mechanisms 111 and 112. Furthermore, compared with a case such as the case in the comparison example described above (FIG. 38A through FIG. 40B) in which the carrying belts 301a do not shift, the interference between the recording medium M in the storing unit 2 or in the accommodating unit 200 and the transferring unit 100 may be suppressed.

In the present embodiment, the transferring unit 100 further includes a single driving source (the first driving source 115) that generates both the driving power for the first driving mechanism 116 and the driving power for the second driving mechanism 117. Therefore, the transferring unit 100 may be configured in a simple manner, compared with a case in which a driving source is separately provided for the first driving mechanism 116 and for the second driving mechanism 117, or compared with a case such as the case in the comparison example described above (FIG. 38A through FIG. 40B) in which a driving source is provided for each pair of carrying belts 301a.

In the present embodiment, the accommodating unit 200 accommodates the recording media M so that they are arranged in the fourth direction (arrow D4) that is different from the third direction (arrow D3) that is the carrying direction of the recording medium M. The transporting unit 10 further includes the third driving mechanism 14 that makes the transferring unit 100 shift in the fourth direction (arrow D4). Therefore, transporting unit 10 may be configured in a simple manner.

In the present embodiment, the accommodating unit 200 is detachable with respect to the transporting unit 10. Therefore, the recording media M may be easily put in and out the accommodating unit 200.

In the present embodiment, the accommodating unit 200 includes the handle 240. The handle 240 shifts between the first position P1 at which it stands from an outer face and the second position P2 at which it is laid down along the outer face. Therefore, the accommodating unit 200 may be grasped with a simple configuration.

In the present embodiment, the accommodating unit 200 includes the handle locking mechanism 250 and the torsion spring 241a (an example of a handle energizing mechanism). The handle locking mechanism 250 locks the handle 240 on the first position P1. The torsion spring 241a energizes the handle 240 toward the second position P2. The transporting unit 10 includes the pusher blocks 11d and 11h (an example of the locking releasing mechanism). The pusher blocks 11d and 11h release the locking by pressing the handle locking mechanism 250 in a state in which the accommodating unit 200 is placed in the transporting unit 10. Therefore, the accommodating unit 200 may be grasped with a simple configuration.

In the present embodiment, the storing unit 2 and the transporting unit 10 are provided inside the casing 4. The casing 4 includes the loading and ejecting opening 4a through which the accommodating unit 200 is loaded and ejected. Therefore, the accommodating unit 200 may be loaded and ejected from the casing 4 with a simple configuration.

According to the library apparatus and the article transporting apparatus disclosed herein, efficiency in transportation may be enhanced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A library apparatus comprising:
a storing unit configured to store a plurality of recording media; and
a transporting unit configured to shift in a first direction and in a second direction that intersect each other and to transport the recording media, wherein
the transporting unit includes:
an accommodating unit configured to be able to accommodate a plurality of the recording media; and
a transferring unit configured to transfer the recording media one by one between the storing unit and the accommodating unit.

2. The library apparatus according to claim 1, wherein
the transferring unit includes
a carrying unit configured to carry the recording media in a third direction that intersects a plane defined by the first direction and the second direction.

3. The library apparatus according to claim 2, wherein
the carrying unit is a pair of conveyer mechanisms configured to hold one recording medium of a plurality of recording media therebetween; and
the transferring unit further includes
a conveyer energizing mechanism configured to energize the pair of conveyer mechanisms in a direction in which the pair of conveyer mechanisms approach each other,
a regulating unit configured to regulate relative positions of the pair of conveyer mechanisms against an energizing force given by the conveyer energizing mechanism to the pair of conveyer mechanisms, and
a canceling unit configured to cancel a regulation of the relative positions by the regulating unit.

4. The library apparatus according to claim 2, wherein
the transferring unit further includes
a first driving mechanism configured to actuate the carrying unit to make the carrying unit carry the recording medium in the third direction, and
a second driving mechanism configured to make the carrying unit shift in the third direction.

5. The library apparatus according to claim 4, wherein
the transferring unit further includes
a single driving source configured to generate both a driving power for the first driving mechanism and a driving power for the second driving mechanism.

6. The library apparatus according to claim 1, wherein
the accommodating unit accommodates the plurality of recording media so that the recording media are arranged in a fourth direction that is different from the third direction; and
the transporting unit further includes
a third driving mechanism configured to make the transferring unit shift in the fourth direction.

7. The library apparatus according to claim 1, wherein
the accommodating unit is detachable with respect to the transporting unit.

8. The library apparatus according to claim 7, wherein
the accommodating unit includes
a handle provided on an outer face of the accommodating unit; and
the handle shifts between a first position at which the handle stands from the outer face and a second position at which the handle is laid down along the outer face.

9. The library apparatus according to claim 8, wherein
the accommodating unit includes
a handle locking mechanism configured to lock the handle on the first position, and
a handle energizing mechanism configured to energize the handle toward the second position; and
the transporting unit further includes
a locking releasing mechanism configured to release a locking of the handle by the handle locking mechanism by pressing the handle locking mechanism in a state in which the accommodating unit is placed in the transporting unit.

10. The library apparatus according to claim 7, further comprising
a casing in which the storing unit and the transporting unit are placed, wherein
the casing includes a loading and ejecting opening through which the accommodating unit is loaded and ejected.

11. An article transporting apparatus comprising
a transporting unit configured to shift in a first direction and in a second direction that intersect each other and to transport an article, wherein
the transporting unit includes:
an accommodating unit configured to be able to accommodate a plurality of articles; and
a transferring unit configured to transfer the articles one by one between the accommodating unit and a storing unit configured to store a plurality of the articles.
